(19) United States
(12) Patent Application Publication
(10) Pub. No.: US 2011/0043741 A1
(43) Pub. Date: Feb. 24, 2011

(54) LIQUID CRYSTAL DISPLAY DEVICE

(75) Inventor: Shinichi Hirato, Osaka (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka-shi, Osaka (JP)

(21) Appl. No.: 12/989,585

(22) PCT Filed: Apr. 23, 2009
(86) PCT No.: PCT/JP2009/001864

§ 371 Date: Oct. 25, 2010

(30) Foreign Application Priority Data
Apr. 25, 2008 (JP) 2008-116067

(51) Int. Cl. G02F 1/1343

(52) U.S. Cl. 349/143

(57) ABSTRACT

In the liquid crystal display device (100A) of the present invention, the pixel electrode (121) has a notch (122a2) provided for a portion of a line. If the azimuthal component of liquid crystal molecules (182), located approximately at the middle of the thickness of a liquid crystal layer (180) in an area where the respective alignment regions of first and second alignment films (130) and (170) overlap with each other to a viewer's eye, is called a “reference alignment azimuth”, an oblique electric field, generated by a counter electrode (160) and the notch (122a2) of the pixel electrode (121) upon the application of a voltage, causes the azimuthal component of the liquid crystal molecules (182) in a region of the liquid crystal layer (180) associated with at least a portion of the notch (122a2) of the pixel electrode (121), to intersect with the reference alignment azimuth at an angle of 90 degrees or less.

### TECHNICAL FIELD

The present invention relates to a liquid crystal display device.

### BACKGROUND ART

A liquid crystal display (LCD) is a display device with significantly reduced thickness and power dissipation, and has found a broad variety of applications in various fields. Among other things, an active-matrix-addressed LCD, including a switching element such as a thin-film transistor (TFT) for each pixel, has such high contrast ratio, excellent response characteristic and high performance as to be applied to TVs, monitors, laptops, and so on. And the LCD market has been expanding faster and faster year after year.

An active-matrix-addressed LCD includes an active-matrix substrate, on which a number of switching elements are arranged, and a counter substrate, which faces the active-matrix substrate, and conducts a display operation by controlling the optical transmittance of a liquid crystal layer interposed between those two substrates. The active-matrix substrate is fabricated by repeatedly performing the process steps of depositing a semiconductor film, an insulating film or a conductor film on an insulating substrate and the process steps of patterning those films. In an actual active-matrix substrate, however, lines to supply signals may sometimes be disconnected or leakage current may flow between two conductive members that should be electrically insulated from each other. An LCD that has been fabricated using such an active-matrix substrate could not be supplied with a normal voltage and might produce a point defect, a line defect and other defects, thus resulting in a lower yield eventually. To avoid such a situation, techniques for increasing the yield by repairing such defects of an LCD have been proposed in Patent Documents Nos. 1 and 2, for example.

Hereinafter, a method for repairing a defect in an LCD 800 as disclosed in Patent Document No. 1 will be described with reference to FIG. 40, which illustrates a single pixel of the LCD 800.

A gate line G and a storage capacitor line CS run in the x direction, while a source line S runs in the y direction. This pixel includes a thin-film transistor (TFT), of which the gate electrode is extended in the y direction from the gate line G that runs in the x direction, the source electrode is extended in the x direction from the source line S that runs in the y direction, and the drain electrode is connected to a pixel electrode 821 through a drain extension line 827. A storage capacitor electrode 825 overlaps with the storage capacitor line CS and is connected to the pixel electrode 821 through a contact hole. As a result, a storage capacitor is formed where the storage capacitor electrode 825 and the storage capacitor line CS overlap with each other. The LCD 800 further includes a contact line 828 that overlaps with the storage capacitor electrode 825 and the source line S.

Patent Document No. 1 discloses how to repair defects in a situation where leakage current is generated between the gate electrode and the drain electrode and between the storage capacitor line CS and the storage capacitor electrode 825. When such leakage current is generated, either a black point or a bright spot is produced. According to the defect repairing method of Patent Document No. 1, if leakage current has been generated between the gate electrode and the drain electrode, the drain extension line 827 is cut off by irradiating the line 827 with a laser beam as indicated by the lower dotted line in FIG. 40. On the other hand, if leakage current has been generated between the storage capacitor line CS and the storage capacitor electrode 825, a portion of the storage capacitor electrode 825 that is not overlapped with the pixel electrode 821 is cut off by irradiating that portion with a laser beam as indicated by the upper dotted line in FIG. 40. Furthermore, the intersection between the storage capacitor electrode 825 and the contact line 828 and the intersection between the source line S and the contact line 828 are irradiated with a laser beam and electrically connected together. As a result, a source signal voltage is always applied to the pixel electrode 821. For example, if multiple surrounding pixels represent a similar color, this pixel will look the same as other normal pixels. In this manner, the defect can be repaired when the leakage current is generated.

On the other hand, Patent Document No. 2 discloses how to repair a defect that has been produced as a result of disconnection. Hereinafter, it will be described with reference to FIG. 41 how the LCD 900 disclosed in Patent Document No. 2 repairs such a defect. In the LCD 900, if a line defect has been produced due to a disconnection of the source line S, contact holes 928 and 929 are cut through both ends of the disconnected part of the source line S and then filled them with a conductive material by forming a conductor film 930 over the source line S with an insulating film interposed between them. In this manner, the disconnected source line S is electrically connected and the line defect can be repaired. The yield of LCDs can be increased by such a defect repairing method.

As a TN (twisted nematic) mode LCD, which used to be used very often in the past, realizes only a narrow viewing angle, LCDs that will achieve wider viewing angles such as IPS (in-plane switching) mode LCD and VA (vertical alignment) mode LCD have been developed recently. Among those wide viewing angle LCDs, the VA mode will also achieve a high contrast ratio, and therefore, is adopted in more and more LCDs these days.

A VA-mode LCD often adopts an MVA mode as an alignment division structure in which multiple liquid crystal domains are defined within a single pixel region in order to improve the viewing angle characteristic. In an MVA-mode LCD, an alignment control structure is arranged on at least one of the two substrates, which face each other with a vertical alignment liquid crystal layer interposed between them, so that the alignment control structure faces the liquid crystal layer. In this manner, multiple liquid crystal domains with multiple different alignment directions (typically four liquid crystal domains) are defined. As the alignment control structure, a linear slit (opening) or a rib (projection) of an electrode is used, thereby applying alignment control force to the liquid crystal layer from one or both sides thereof.

Unlike a TN-mode LCD in which the pretilt direction of liquid crystal molecules is defined by alignment films, those linear slits and/or ribs apply alignment control force to the liquid crystal molecules of an MVA-mode LCD. That is why the alignment control force applied to the liquid crystal molecules within a pixel region varies according to the distance from a slit or a rib, thus making the response speeds of those liquid crystal molecules different within the single pixel region. On top of that, in the MVA-mode LCD, a region with a slit or a rib has a decreased transmittance, and it is difficult to achieve a high luminance.

To overcome these problems, it has been proposed that a mode that forms an alignment division structure using alignment films that define pretilt azimuths be applied to even such a VA-mode LCD (see Patent Documents Nos. 3 and 4). The LCDs disclosed in Patent Documents Nos. 3 and 4 include first and second alignment films that face each other with a liquid crystal layer interposed between them, and each of the first and second alignment films has two sets of alignment regions that define two different pretilt azimuths for the liquid crystal molecules. In the liquid crystal layer, four different types of liquid crystal domains are produced according to the combination of the two sets of alignment regions of the first alignment film and those of the second alignment film, thereby widening the viewing angle.

The VA-mode LCD with such alignment films that define the pretilt directions will sometimes produce peculiar misalignment. As a result, there is a region, of which the luminance is lower than the one associated with a grayscale tone to be displayed when the screen is viewed straight, thus producing dark lines (see Patent Document No. 5, for example). Those dark lines will be produced not only at the center of the pixel electrode where the liquid crystal domains are adjacent to each other but also along at least some of the edges of the pixel electrode as well.

In the LCD disclosed in Patent Document No. 5, if in any of the edge portions of the pixel electrode associated with the liquid crystal domains, the azimuthal component that intersects with that edge portion at right angles and that points toward the inside of the pixel electrode forms an angle of greater than 90 degrees with respect to any of the reference alignment azimuths of the liquid crystal domains, then a dark line will be produced inside of, and substantially parallel to, that edge portion of the pixel electrode. Such a dark line will be referred to herein as a “domain line”. They say that those domain lines are produced because the reference alignment directions of the liquid crystal domains and the directions of the alignment control forces produced by an oblique electric field generated at the edges of the pixel electrode have mutually opposing components, thus disturbing the alignment of the liquid crystal molecules there. Dark lines are produced around the center of the pixel electrode because the liquid crystal molecules have mutually different alignment directions and do not transmit light at the boundaries between the liquid crystal domains. Such dark lines around the center of the pixel electrode are sometimes called “disclination lines”.

The LCD disclosed in Patent Document No. 5 includes a shielding member that shields such regions where dark lines are produced. Such domain lines produced at the edge portions will look moving according to the viewing angle. And unless those edge portions are shielded from incoming light, the grayscale will be inverted. For that reason, the edge portions are shielded from incoming light, thereby minimizing the decline in viewing angle characteristic. Also, if a storage capacitor line is arranged so as to overlap with the center portion of the pixel electrode, for example, the center portion of the pixel electrode is shielded with the storage capacitor line, thereby minimizing the decrease in aperture ratio.

### CITATION LIST

### Patent Literature

Patent Document No. 1: Japanese Patent Application Laid-Open Publication No. 2003-29280
Patent Document No. 2: Japanese Patent Application Laid-Open Publication No. 2002-182246
Patent Document No. 3: Japanese Patent Application Laid-Open Publication No. 11-133429
Patent Document No. 4: Japanese Patent Application Laid-Open Publication No. 11-352486
Patent Document No. 5: Pamphlet of PCT International Application Publication No. 2006/132369

### SUMMARY OF INVENTION

### Technical Problem

The present inventors discovered that if the LCDs disclosed in Patent Documents Nos. 3 to 5 were designed so as to repair the defects easily, the optical transmittance sometimes decreased significantly.

It is therefore an object of the present invention to provide a liquid crystal display device that can repair defects easily with such a decrease in optical transmittance minimized.

### Solution to Problem

A liquid crystal display device according to the present invention includes: an active-matrix substrate including multiple lines, a pixel electrode and a first alignment film; a counter substrate including a counter electrode and a second alignment film; and a vertical alignment liquid crystal layer, which is arranged between the active-matrix substrate and the counter substrate. The first alignment film at least partially has an alignment region that defines liquid crystal molecules of the liquid crystal layer in a first pretilt azimuth. The second alignment film at least partially has an alignment region that defines the liquid crystal molecules of the liquid crystal layer in another pretilt azimuth that is different from the first pretilt azimuth. The pixel electrode has at least one notch or opening, which is provided for a portion of at least one of the multiple lines. If the azimuthal component of the alignment direction of liquid crystal molecules, which are located approximately at the middle of the thickness of the liquid crystal layer in an area where the respective alignment regions of the first and second alignment films overlap with each other to a viewer's eye and of which the director points from the active-matrix substrate toward the counter substrate, is called a reference alignment azimuth, an oblique electric field, which is generated by the counter electrode and the at least one notch or opening of the pixel electrode upon the application of a voltage, causes the azimuthal component of the alignment direction of the liquid crystal molecules, of which the director points from the active-matrix substrate toward the counter substrate in a region of the liquid crystal layer associated with at least a portion of the at least one notch or opening of the pixel electrode, to intersect with the reference alignment azimuth at an angle of 90 degrees or less.

In one embodiment, an oblique electric field, which is generated by the counter electrode and the at least one notch or opening of the pixel electrode upon the application of a voltage, makes the azimuthal component of the alignment direction of the liquid crystal molecules, of which the director points from the active-matrix substrate toward the counter substrate in a region of the liquid crystal layer associated with at least a portion of the at least one notch or opening of the pixel electrode, substantially parallel to the reference alignment azimuth.

In one embodiment, the first alignment film has first and second alignment regions that define the liquid crystal molecules of the liquid crystal layer in the first and second pretilt azimuths, respectively. The second alignment film has third and fourth alignment regions that define the liquid crystal molecules of the liquid crystal layer in third and fourth pretilt azimuths, respectively. And the liquid crystal layer has multiple liquid crystal domains.

In one embodiment, the liquid crystal domains include first, second, third and fourth liquid crystal domains.

In one embodiment, each of the first and second pretilt azimuths intersects with the third and fourth pretilt azimuths substantially at right angles.

In one embodiment, when a voltage is applied thereto, a dark line is produced, to the viewer's eye, at the boundary between at least two adjacent ones of the multiple liquid crystal domains.

In one embodiment, respective parts of the pixel electrode that are associated with the multiple liquid crystal domains and that overlap with neither the lines nor the dark line have approximately equal areas.

In one embodiment, as viewed along a normal to the principal surface of the active-matrix substrate, the pixel electrode has an asymmetric shape.

In one embodiment, the at least one notch of the pixel electrode is located at a corner of the pixel electrode.

In one embodiment, the at least one notch of the pixel electrode is located in at least one intersection where the boundary between two adjacent ones of the liquid crystal domains intersects with an edge of the pixel electrode.

In one embodiment, the pixel electrode has the opening, and the dark line is produced, to the viewer's eye, at least partially over at least a portion of the opening.

In one embodiment, the lines include a gate line and a source line.

In one embodiment, the lines further include a drain extension line and a storage capacitor line.

In one embodiment, the liquid crystal layer has multiple liquid crystal domains, and the lines include a drain extension line, which overlaps with at least a part of the boundary between two adjacent ones of the liquid crystal domains.

In one embodiment, at least one of the first and second alignment films has been irradiated with light.

In one embodiment, at least one of the first and second alignment films has been subjected to a rubbing treatment.

In one embodiment, the second alignment film has a projection, which is associated with the at least one notch or opening of the pixel electrode.

In one embodiment, the counter electrode has a slit, which is associated with the at least one notch or opening of the pixel electrode.

In one embodiment, the pixel electrode includes first and second subpixel electrodes.

In one embodiment, the pixel electrode has one more notch. An oblique electric field, which is generated by the counter electrode and the one more notch of the pixel electrode upon the application of a voltage, causes the azimuthal component of the alignment direction of the liquid crystal molecules, of which the director points from the active-matrix substrate toward the counter substrate in a region of the liquid crystal layer associated with the one more notch of the pixel electrode, to intersect with the reference alignment azimuth at an angle of greater than 90 degrees.

In one embodiment, the one more notch of the pixel electrode is provided for a portion of at least one of the lines.

In one embodiment, the one more notch of the pixel electrode overlaps at least partially with another one of the lines.

### ADVANTAGEOUS EFFECTS OF INVENTION

The present invention provides a liquid crystal display device that can not only repair defects more easily but also minimize the decrease in optical transmittance.

### BRIEF DESCRIPTION OF DRAWINGS

FIG. 1 is a schematic representation illustrating a liquid crystal display device as a first embodiment of the present invention.

FIG. 2 is an equivalent circuit diagram representing two pixels of the liquid crystal display device of the first embodiment.

FIG. 3(a) is a schematic plan view illustrating the configuration of an active-matrix substrate according to the first embodiment of the present invention. FIG. 3(b) is a cross-sectional view thereof as viewed on the plane A-A′ shown in FIG. 3(a). FIG. 3(c) is a schematic plan view illustrating how dark lines are produced in the liquid crystal display device of the first embodiment. And FIG. 3(d) is a schematic plan view illustrating the liquid crystal display device of the first embodiment.

FIGS. 4(a) and 4(b) are schematic representations illustrating liquid crystal molecules aligned by first and second alignment films, respectively, in the liquid crystal display device of the first embodiment. And FIG. 4(c) is a schematic representation illustrating liquid crystal molecules at the respective centers of the liquid crystal domains.

FIG. 5 illustrates schematic plan views showing a method of repairing a defect in the liquid crystal display device of the first embodiment.

FIG. 6 illustrates schematic plan views showing another method of repairing a defect in the liquid crystal display device of the first embodiment.

FIG. 7 illustrates schematic plan views showing still another method of repairing a defect in the liquid crystal display device of the first embodiment.

FIG. 8 illustrates schematic plan views showing yet another method of repairing a defect in the liquid crystal display device of the first embodiment.

FIG. 9 illustrates schematic plan views showing yet another method of repairing a defect in the liquid crystal display device of the first embodiment.

FIG. 10 illustrates schematic plan views showing yet another method of repairing a defect in the liquid crystal display device of the first embodiment.

FIG. 11 is a schematic perspective view illustrating how to control alignment of liquid crystal molecules according to the shape of a subpixel electrode.

FIGS. 12(a) and 12(b) are schematic representations illustrating liquid crystal molecules aligned by first and second alignment films, respectively, in a liquid crystal display device as a modified example of the first embodiment. And FIG. 12(c) is a schematic representation illustrating liquid crystal molecules at the respective centers of the liquid crystal domains.

FIG. 13(a) is a schematic plan view illustrating the configuration of an active-matrix substrate according a second embodiment of the present invention. FIG. 13(b) is a schematic plan view illustrating how dark lines are produced in the liquid crystal display device of the second embodiment of the present invention. And FIG. 13(c) is a schematic plan view illustrating the liquid crystal display device of the second embodiment.

FIGS. 14(a) and 14(b) are schematic representations illustrating liquid crystal molecules aligned by first and second alignment films, respectively, in a liquid crystal display device as the second embodiment. And FIG. 14(c) is a schematic representation illustrating liquid crystal molecules at the respective centers of the liquid crystal domains.

FIGS. 15(a) and 15(b) are schematic plan views showing how the alignment directions of liquid crystal molecules change depending on whether notches are provided or not.

FIG. 16 illustrates schematic plan views showing a method of repairing a defect in the liquid crystal display device of the second embodiment.

FIG. 17 illustrates schematic plan views showing another method of repairing a defect in the liquid crystal display device of the second embodiment.

FIG. 18 illustrates schematic plan views showing still another method of repairing a defect in the liquid crystal display device of the second embodiment.

FIG. 19 illustrates schematic plan views showing yet another method of repairing a defect in the liquid crystal display device of the second embodiment.

FIG. 20 illustrates schematic plan views showing yet another method of repairing a defect in the liquid crystal display device of the second embodiment.

FIGS. 21(a) and 21(b) are schematic representations illustrating liquid crystal molecules aligned by first and second alignment films, respectively, in a modified example of the liquid crystal display device of the second embodiment. And FIG. 21(c) is a schematic representation illustrating liquid crystal molecules at the respective centers of the liquid crystal domains.

FIG. 22(a) is a schematic plan view illustrating the configuration of an active-matrix substrate according to a third embodiment of the present invention. FIG. 22(b) is a schematic plan view illustrating how dark lines are produced in the liquid crystal display device of the third embodiment of the present invention. And FIGS. 22(c) and 22(d) are schematic plan views illustrating the liquid crystal display device of the third embodiment.

FIG. 23 illustrates schematic plan views showing a method of repairing a defect in the liquid crystal display device of the third embodiment.

FIG. 24 illustrates schematic plan views showing another method of repairing a defect in the liquid crystal display device of the third embodiment.

FIG. 25 illustrates schematic plan views showing still another method of repairing a defect in the liquid crystal display device of the third embodiment.

FIG. 26 illustrates schematic plan views showing yet another method of repairing a defect in the liquid crystal display device of the third embodiment.

FIG. 27 illustrates schematic plan views showing yet another method of repairing a defect in the liquid crystal display device of the third embodiment.

FIG. 28 illustrates schematic plan views showing yet another method of repairing a defect in the liquid crystal display device of the third embodiment.

FIG. 29 illustrates schematic plan views showing yet another method of repairing a defect in the liquid crystal display device of the third embodiment.

FIG. 30(a) is a schematic plan view illustrating the configuration of an active-matrix substrate according to a fourth embodiment of the present invention. FIG. 30(b) is a schematic plan view illustrating how dark lines are produced in the liquid crystal display device of the fourth embodiment of the present invention. And FIG. 30(c) is a schematic plan view illustrating the liquid crystal display device of the fourth embodiment.

FIG. 31 illustrates schematic plan views showing a method of repairing a defect in the liquid crystal display device of the fourth embodiment.

FIG. 32 illustrates schematic plan views showing another method of repairing a defect in the liquid crystal display device of the fourth embodiment.

FIG. 33 illustrates schematic plan views showing still another method of repairing a defect in the liquid crystal display device of the fourth embodiment.

FIG. 34 illustrates schematic plan views showing yet another method of repairing a defect in the liquid crystal display device of the fourth embodiment.

FIG. 35 illustrates schematic plan views showing yet another method of repairing a defect in the liquid crystal display device of the fourth embodiment.

FIGS. 36(a) to 36(d) are schematic plan views illustrating modified examples of the active-matrix substrates of the first through fourth embodiments of the present invention, respectively.

FIG. 37(a) is a schematic plan view illustrating the configuration of an active-matrix substrate according to a fifth embodiment of the present invention. FIG. 37(b) is a schematic plan view illustrating how dark lines are produced in the liquid crystal display device of the fifth embodiment of the present invention. And FIG. 37(c) is a schematic plan view illustrating the liquid crystal display device of the fifth embodiment.

FIG. 38 illustrates schematic plan views showing a method of repairing a defect in the liquid crystal display device of the fifth embodiment.

FIG. 39 is a schematic plan view illustrating a modified example of the active-matrix substrate of the fifth embodiment.

FIG. 40 is a schematic plan view illustrating the configuration of a conventional liquid crystal display device and how to repair a defect in it.

FIG. 41 is a schematic plan view illustrating the configuration of another conventional liquid crystal display device and how to repair a defect in it.

### DESCRIPTION OF EMBODIMENTS

Hereinafter, embodiments of a liquid crystal display device according to the present invention will be described with reference to the accompanying drawings. It should be noted, however, the present invention is in no way limited to the embodiments to be described below. For example, in the following description, the active-matrix substrate of the liquid crystal display device is supposed to include TFTs. However, the present invention is not limited to it and the active-matrix substrate has only to include some kind of switching elements.

### Embodiment 1

Hereinafter, a First Embodiment of a Liquid Crystal display device according to the present invention will be described.

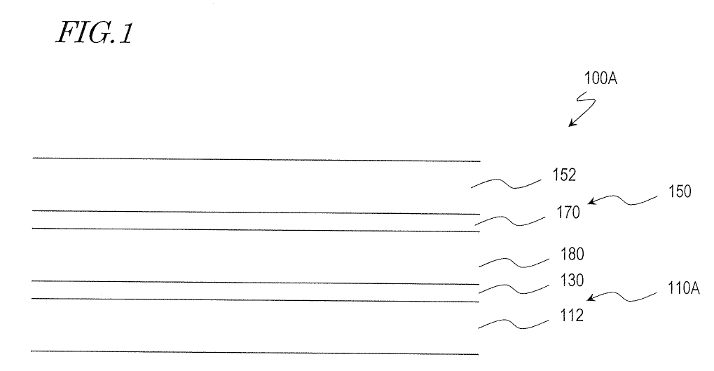

FIG. 1 is a schematic representation illustrating a liquid crystal display device 100A in this embodiment. The liquid crystal display device 100A includes an active-matrix substrate 110A, a counter substrate 150 and a liquid crystal layer 180. The active-matrix substrate 110A includes a first alignment film 130 that is supported on an insulating substrate 112. On the other hand, the counter substrate 150 includes a second alignment film 170 supported on a transparent insulating substrate 152. A liquid crystal layer 180 is arranged between the first and second alignment films 130 and 170 of the active-matrix substrate 110A and the counter substrate 150. Although not shown in FIG. 1, multiple lines and pixel electrodes are arranged between the insulating substrate 112 of the active-matrix substrate 110A and the first alignment film 130. And a counter electrode is arranged between the insulating substrate 152 of the counter substrate 150 and the second alignment film 170.

A number of pixels are arranged in columns and rows on the active-matrix substrate 110A to form a matrix pattern there, and each of those pixels has at least one switching element, which may be a TFT, for example. Such an active-matrix substrate 110A including TFTs as switching elements is sometimes called a “TFT substrate”.

As used herein, the “pixel” refers to a minimum unit of display that represents a particular grayscale. In a color display, each pixel is a unit that represents the grayscale of R, G or B and is also called a “dot”. And a combination of R, G and B pixels forms a single color display pixel. Also, a “pixel region” refers herein to a region of the liquid crystal display device corresponding to a “pixel” of the display.

The liquid crystal layer 180 is a vertical alignment type and has a nematic liquid crystal material with negative dielectric anisotropy. By combining such a liquid crystal layer 180 with a pair of polarizers that are arranged as crossed Nicols, the liquid crystal display device 100A conducts a display operation in normally black mode.

Also, although not shown in FIG. 1, a polarizer is provided for each of the active-matrix substrate 110A and the counter substrate 150. Therefore, the two polarizers are arranged so as to face each other with the liquid crystal layer 180 interposed between themselves. Also, the two polarizers are arranged so that their transmission axes (or polarization axes) cross each other at right angles (i.e., so that one of the two axes is parallel to the horizontal direction (i.e., row direction) and the other is parallel to the vertical direction (i.e., column direction)). Furthermore, although not shown, the liquid crystal display device 100A may have a backlight, if necessary.

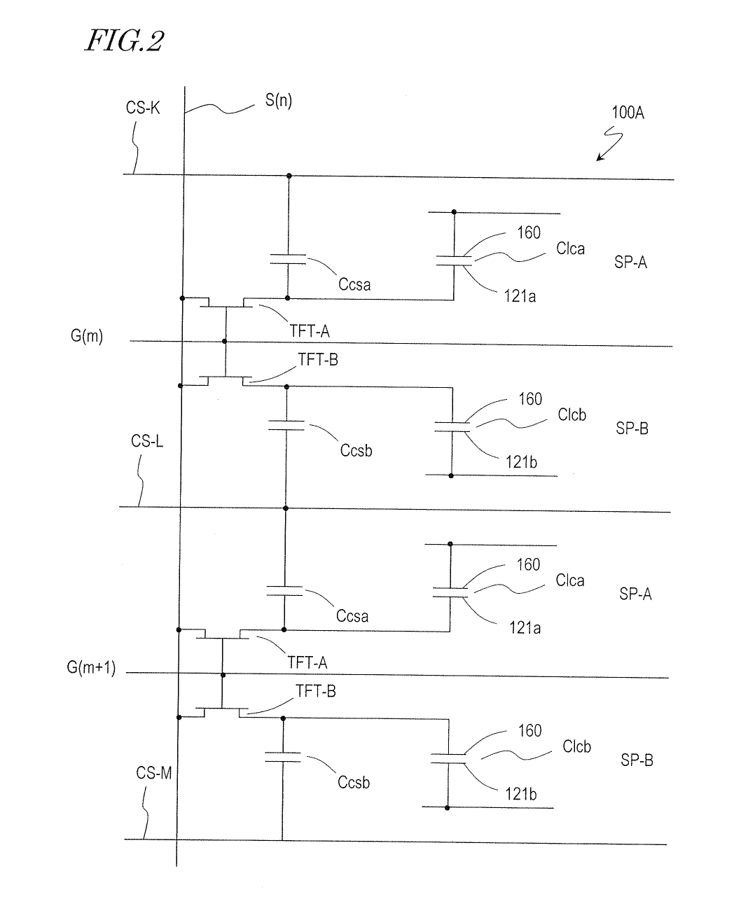

FIG. 2 is an equivalent circuit diagram representing two pixels of the liquid crystal display device 100A. Specifically, one pixel located at the intersection between the m^{th} row and the n^{th} column and another pixel located at the intersection between the (m+1)^{th} row and the n^{th} column are shown in FIG. 2. Each pixel is split into two subpixels SP-A and SP-B, which have TFT-A and TFT-B, respectively. In FIG. 2, gate lines associated with the m^{th} row and the (m+1)^{th} row are identified by G(m) and G(m+1), respectively, and a source line associated with the n^{th} column is identified by S(n). The respective gate electrodes of TFT-As and TFT-Bs of the first and second subpixels SP-A and SP-B on the same row are connected in common to the same gate line G. Also, the respective source electrodes of TFT-As and TFT-Bs of the pixels on the same column are connected in common to the same source line S.

The subpixel SP-A includes a liquid crystal capacitor Clca and a storage capacitor Ccsa. One electrode of the liquid crystal capacitor Clca and one electrode of the storage capacitor Ccsa of the subpixel SP-A are connected to the drain electrode of TFT-A, the other electrode of the liquid crystal capacitor Clca is the counter electrode 160, and the other electrode of the storage capacitor Ccsa is connected to a storage capacitor line CS-K. Likewise, the subpixel SP-B also includes a liquid crystal capacitor Clcb and a storage capacitor Ccsb. One electrode of the liquid crystal capacitor Clcb and one electrode of the storage capacitor Ccsb of the subpixel SP-B are connected to the drain electrode of TFT-B, the other electrode of the liquid crystal capacitor Clcb is the counter electrode 160, and the other electrode of the storage capacitor Ccsb is connected to a storage capacitor line CS-L.

Each liquid crystal capacitor Clca, Clcb is formed by a portion of the liquid crystal layer 180 shown in FIG. 1 that is associated with the subpixels SP-A and SP-B, the counter electrode 160 and the subpixel electrodes 121a and 121b. Look at the pixel at the intersection between the m^{th} row and the n^{th} column, for example, and it can be seen that each storage capacitor Ccsa, Ccsb is formed by a storage capacitor electrode that is electrically connected to the subpixel electrode 121a, 121b, a storage capacitor counter electrode that is electrically connected to a storage capacitor line CS-K, CS-L and an insulating layer (not shown) arranged between them. The storage capacitor counter electrodes of the storage capacitors Ccsa and Ccsb are independent of each other and can be supplied with mutually different storage capacitor counter voltages through the storage capacitor lines CS-K and CS-L, respectively.

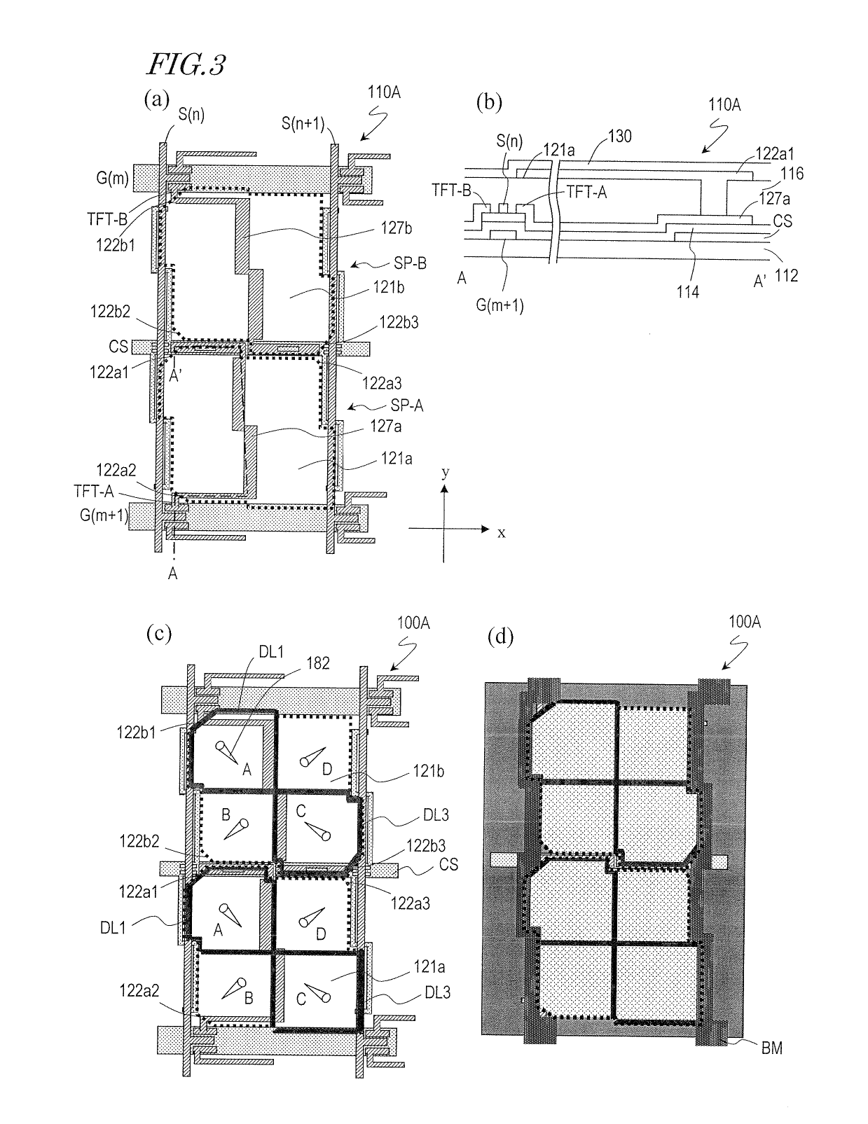

Hereinafter, the configuration of this liquid crystal display device 100A will be described in detail with reference to FIG. 3. Specifically, FIG. 3(a) is a schematic plan view illustrating the configuration of the active-matrix substrate 110A. FIG. 3(b) is a cross-sectional view thereof as viewed on the plane A-A′ shown in FIG. 3(a). FIG. 3(c) is a schematic plan view illustrating how dark lines are produced in the liquid crystal display device 100A. And FIG. 3(d) is a schematic plan view illustrating the liquid crystal display device 100A.

In FIG. 3(a), illustrated are the second subpixel SP-B of a pixel on the m^{th} row and the first subpixel SP-A of a pixel on the (m+1)^{th} row. The first and second subpixels SP-A and SP-B are defined by subpixel electrodes 121a and 121b, respectively. In these subpixel electrodes 121a and 121b, their sides running in the column direction (i.e., y direction) and in the row direction (i.e., x direction) are not straight but indented as viewed along a normal to the principal surface of the active-matrix substrate 110A.

The gate lines G and storage capacitor lines CS run in the row direction (i.e., x direction), while the source lines S run in the column direction (i.e., y direction). The source lines S intersect with the gate lines G and storage capacitor lines CS. In FIG. 3(a), G(m) and G(m+1) denote gate lines associated with the m^{th} and (m+1)^{th} rows, respectively. In the same way, S(n) and S(n+1) denote source lines associated with the n^{th} and (n+1)^{th} columns, respectively. The subpixel electrodes 121a and 121b are arranged so as to be surrounded with the gate lines G(m) and G(m+1) and the source lines S(n) and S(n+1).

The subpixel SP-A includes TFT-A, of which the source electrode is connected to the source line S(n) and the drain electrode is connected to the subpixel electrode 121a through a drain extension line 127a. Both of the source and drain electrodes of TFT-A overlap with the gate line G(m+1), of which a portion functions as the gate electrode of TFT-A. Likewise, the subpixel SP-B includes TFT-B, of which the source electrode is connected to the source line S(n) and the drain electrode is connected to the subpixel electrode 121b through a drain extension line 127b. Both of the source and drain electrodes of TFT-B overlap with the gate line G(m), of which a portion functions as the gate electrode of TFT-B.

The storage capacitor line CS is arranged between the two gate lines G(m) and G(m+1) and causes a voltage step up or step down in the liquid crystal capacitors of the subpixels SP-B and SP-A of two pixels that are adjacent to each other in the column direction (y direction). In this manner, each pixel is subdivided into two subpixels.

The storage capacitor line CS includes a CS trunk line running in the row direction (x direction) and CS branch lines branching from the CS trunk line. Specifically, the CS trunk line branches into a number of fine lines so that there is an opening at the intersection between the CS trunk line and the source line S. That is why the area of overlap between the CS trunk line and the source line S is relatively small. On the other hand, the CS branch lines run in the +y and −y directions and have an indented shape, as viewed along a normal to the principal surface of the active-matrix substrate 110A, so as to cross the source line S. The sides of the subpixel electrodes 121a and 121b running in the column direction (i.e., y direction) also have a similar indented shape corresponding to that of the CS branch lines as viewed along a normal to the principal surface of the active-matrix substrate 110A.

The drain extension line 127a is extended from the drain electrode of TFT-A so as to run not only in the row direction (x direction) toward the center of the subpixel electrode 121a in the row direction but also in the column direction (y direction) toward the CS trunk line. And through a contact hole that has been cut through the intersection between the drain extension line 127a and the CS trunk line, the drain extension line 127a is connected to the subpixel electrode 121a. In the same way, the drain extension line 127b is extended from the drain electrode of TFT-B so as to run not only in the row direction (x direction) toward the center of the subpixel electrode 121b in the row direction but also in the column direction (y direction) toward the CS trunk line. And through a contact hole that has been cut through the intersection between the drain extension line 127b and the CS trunk line, the drain extension line 127b is connected to the subpixel electrode 121b. Also, the drain extension lines 127a and 127b run in the column direction in an indented shape just like the indented sides of the subpixel electrodes 121a and 121b.

The subpixel electrode 121a has notches 122a1, 122a2 and 122a3, which are provided at three corners of the subpixel electrode 121a. Since the subpixel electrode 121a has the notch 122a1, the intersecting portion between the storage capacitor line CS and the source line S(n) does not overlap with the subpixel electrode 121a. In this manner, the storage capacitor line CS and the source line S(n) are arranged with respect to the notch 122a1 of the subpixel electrode 121a.

Most of the drain extension line 127a is covered with the subpixel electrode 121a but only a portion of the drain extension line 127a is not. More specifically, were it not for the notch 122a2 of the subpixel electrode 121a, the drain extension line 127a would be fully covered with the subpixel electrode 121a around TFT-A. In this embodiment, however, a portion of the drain extension line 127a is arranged at the notch 122a2, and therefore, not covered with the subpixel electrode 121a there. In this manner, the drain extension line 127a is associated with the notch 122a2 of the subpixel electrode 121a. Likewise, the intersecting portion between the storage capacitor line CS and the source line S(n+1) does not overlap with the subpixel electrode 121a, either. But the notch 122a3 of the subpixel electrode 121a extends the distance from the intersecting portion between the storage capacitor line CS and the source line S(n+1) to the subpixel electrode 121a.

In the same way, the subpixel electrode 121b also has notches 122b1, 122b2 and 122b3, which are provided at three corners of the subpixel electrode 121b. The drain extension line 127b is associated with the notch 122b1 of the subpixel electrode 121b and a portion of the drain extension line 127b is not covered with the subpixel electrode 121b. Likewise, the intersecting portion between the CS trunk line and the source line S(n) does not overlap with the subpixel electrode 121b, either. But the notch 122b2 extends the distance from the intersecting portion between the CS trunk line and the source line S(n) to the subpixel electrode 121b. Furthermore, the intersecting portion between the CS trunk line and the source line S(n+1) is associated with the notch 122b3 of the subpixel electrode 121b and does not overlap with the subpixel electrode 121b, either.

As can be seen from FIGS. 3(a) and 3(b), the gate line G and the storage capacitor line CS are arranged on the insulating substrate 112, which may be a glass substrate, for example. An insulating film 114, a portion of which will function as the gate insulating film of TFT-A and TFT-B, has been deposited over the gate line G and the storage capacitor line CS. And the drain extension lines 127a, 127b and the source line S are arranged on the insulating film 114. That is to say, TFT-A and TFT-B both have a bottom gate structure. The source line S and the drain extension lines 127a, 127b are covered with a protective film 116, through which a contact hole has been cut. The subpixel electrode 121 is arranged so as to fill the contact hole and to partially cover the protective film 116. And the first alignment film 130 is further provided over the subpixel electrode 121.

The gate line G and the storage capacitor line CS are formed in the same process step and are sometimes called a “gate metal” collectively. Likewise, the source line S and the drain extension lines 127a, 127b are also formed in the same process step and are sometimes called a “source metal” collectively. On the active-matrix substrate 110A, the storage capacitor of each pixel is formed by the source metal (drain extension line 127), the protective film 116, the insulating film 114 and the gate metal (storage capacitor line CS). The insulating film 114 and the protective film 116 may be nitride films, for example, and the protective film 116 is also called a “passivation film”.

Generally speaking, electrically conductive members such as line and pixel electrodes are supposed to be electrically isolated from each other except in particular connection areas. Actually, however, leakage current could be generated in an intersecting portion where multiple lines are located close to each other. A line could sometimes be disconnected, too. If the liquid crystal display device 100A included such an active-matrix substrate 110A, defect would be produced to deteriorate its display quality. That is why to avoid such a situation, defects are repaired. In the liquid crystal display device 100A of this embodiment, its active-matrix substrate 110A has such a structure that is designed to get those defect repaired easily. For example, since the subpixel electrodes 121a and 121b have notches 122a1 to 122a3 and 122b1 to 122b3 in the active-matrix substrate 110A, the defects can be repaired easily even if leakage current is generated at the intersection between the source line S and the gate line G or the storage capacitor line CS. It will be described later specifically how to repair the defects.

FIG. 3(c) illustrates the dark lines to be produced in the liquid crystal display device 100A that has been fabricated using the active-matrix substrate 110A and also shows the alignment directions of liquid crystal molecules around the respective centers of multiple liquid crystal domains. In FIG. 3(c), the liquid crystal molecules are illustrated as conical ones. And their director that points at the viewer is defined to be directed from their sharp tip to their round bottom. Such an alignment of the liquid crystal molecules is realized by the first and second alignment films 130 and 170 (see FIG. 1).

Hereinafter, the first and second alignment films 130 and 170 will be described with reference to FIG. 1 again. The first and second alignment films 130 and 170 are obtained by processing the surface of a vertical alignment film so that liquid crystal molecules have a pretilt angle of less than 90 degrees. As used herein, the “pretilt angle” is the angle defined by the major axis of a liquid crystal molecule, which is aligned in the pretilt direction, with respect to the principal surface of the first and second alignment films 130 and 170. The pretilt directions of the liquid crystal molecules are defined by the first and second alignment films 130 and 170. Examples of known methods for forming such an alignment film include subjecting the alignment film to a rubbing treatment or a photo-alignment treatment, by forming a microstructure on an undercoat film for each alignment film and transferring the shape of the microstructure onto the surface of the alignment film, or by evaporating obliquely an inorganic material such as SiO on an alignment film to define a microstructure thereon. Considering its mass productivity, however, either the rubbing treatment or the photo-alignment treatment is preferred. Among other things, the photo-alignment treatment is particularly preferred to increase the yield because that treatment is a non-contact method and generates no static electricity due to friction unlike the rubbing treatment. Also, as described in Pamphlet of PCT International Application Publication No. 2006/121220, by using a photo-alignment film including a photosensitive group, the variation in pretilt angle can be reduced to one degree or less. The photo-alignment film preferably includes at least one photosensitive group selected from the group consisting of a 4-chalcone group, a 4′-chalcone group, a coumarin group, and a cinnamoyl group to name just a few.

The first and second alignment films 130 and 170 cause neighboring liquid crystal molecules to slightly tilt with respect to a normal to the principal surface of the alignment films. Their pretilt angle may fall within the range of 85 degrees to less than 90 degrees, for example. The pretilt azimuth defined by the first alignment film 130 for the liquid crystal molecules 182 of the liquid crystal layer 180 is different from the one defined by the second alignment film 170 for the liquid crystal molecules 182. For instance, the pretilt azimuths defined by the first and second alignment films 130 and 170 for the liquid crystal molecules 182 may intersect with each other at right angles. In this embodiment, no chiral agent is added to the liquid crystal layer 180. And when a voltage is applied to the liquid crystal layer 180, the liquid crystal molecules 182 will have a twisted alignment under the alignment control force of the alignment films 130 and 170. If necessary, however, a chiral agent may be added to the liquid crystal layer 180.

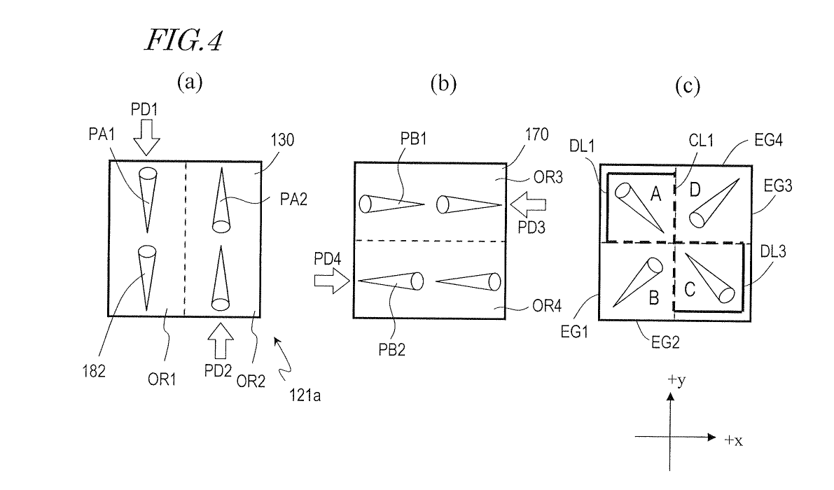

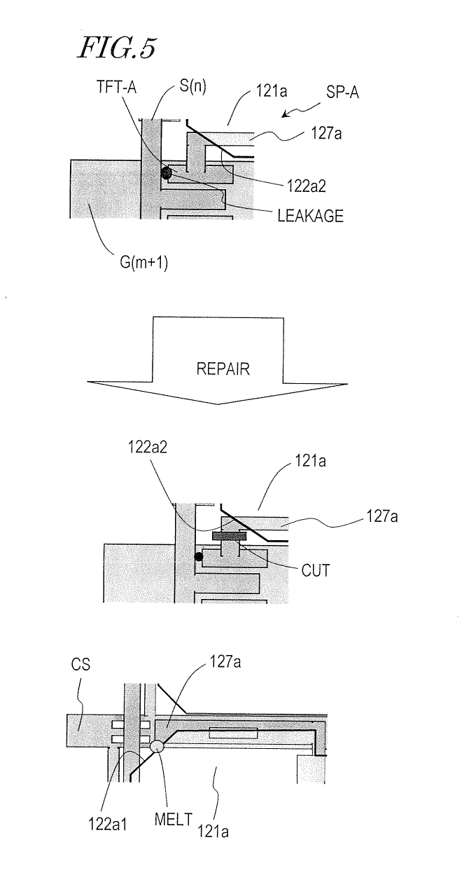

Hereinafter, the pretilt directions defined by the first and second alignment films 130 and 170 for the liquid crystal molecules 182 and the alignment directions of the liquid crystal molecules 182 at the respective centers of the liquid crystal domains will be described with reference to FIG. 4(a), in which the subpixel electrode 121a is illustrated as a rectangular one to avoid complicating the drawing excessively.

FIG. 4(a) indicates the pretilt directions PA1 and PA2 of liquid crystal molecules as defined by the first alignment film 130 of the active-matrix substrate 110A. FIG. 4(b) indicates the pretilt directions PB1 and PB2 of liquid crystal molecules as defined by the second alignment film 170 of the counter substrate 150. And FIG. 4(c) indicates the alignment directions of liquid crystal molecules at the respective centers of the liquid crystal domains A through D when a voltage is applied to the liquid crystal layer 180 and also shows domain lines DL1 and DL3, which look dark due to their disturbed alignment. It should be noted that the domain lines DL1 and DL3 are not so-called “disclination lines”.

FIGS. 4(a) to 4(c) schematically indicate the alignment directions of the liquid crystal molecules as viewed by the viewer. Also, in FIGS. 4(a) to 4(c), the circular conical liquid crystal molecules tilt so that its (substantially round) bottom points at the viewer. Also, in FIGS. 4(a) to 4(c), the liquid crystal molecules tilt just slightly with respect to a normal to the principal surface of the alignment films 130 and 170 (i.e., have relatively large tilt angles).

As shown in FIG. 4(a), the first alignment film 130 has first and second alignment regions OR1 and OR2. The liquid crystal molecules aligned by the first alignment region OR1 tilt in the +y direction with respect to a normal to the principal surface of the first alignment film 130. Meanwhile, the liquid crystal molecules aligned by the second alignment region OR2 tilt in the −y direction with respect to a normal to the principal surface of the first alignment film 130.

When formed by photo-alignment treatment, the first alignment film 130 is irradiated obliquely with an ultraviolet ray. Even though their angles are not exactly the same, the liquid crystal molecules will tilt in almost the same direction as the direction in which the ultraviolet ray is coming. By irradiating obliquely the first alignment film 130 with an ultraviolet ray in the directions indicated by the arrows, the liquid crystal molecules in the first alignment region OR1 of the first alignment film 130 will tilt in the +y direction with respect to a normal to the principal surface of the first alignment film 130 and the liquid crystal molecules in the second alignment region OR2 will tilt in the −y direction with respect to a normal to the principal surface of the first alignment film 130. An alignment film that has been subjected to such a photo-alignment treatment is sometimes called a “photo-alignment film”.

On the other hand, the second alignment film 170 has third and fourth alignment regions OR3 and OR4 as shown in FIG. 4(b). The liquid crystal molecules aligned by the third alignment region OR3 tilt in the +x direction with respect to a normal to the principal surface of the second alignment film 170 and their bottom in the −x direction faces forward. Meanwhile, the liquid crystal molecules aligned by the fourth alignment region OR4 of the second alignment film 170 tilt in the −x direction with respect to a normal to the principal surface of the second alignment film 170 and their bottom in the +x direction faces forward.

Also, as described above, if the second alignment film 170 is formed by photo-alignment treatment in which the second alignment film 170 is irradiated obliquely with an ultraviolet ray, the liquid crystal molecules will tilt in almost the same direction as the direction in which the ultraviolet ray is coming. That is why by irradiating obliquely the second alignment film 170 with an ultraviolet ray in the directions indicated by the arrows, the liquid crystal molecules in the third alignment region OR3 of the second alignment film 170 will tilt in the +x direction with respect to a normal to the principal surface of the second alignment film 170 and their bottom in the −x direction will face forward. On the other hand, the liquid crystal molecules in the fourth alignment region OR4 will tilt in the −x direction with respect to a normal to the principal surface of the second alignment film 170 and their bottom in the +x direction faces forward.

As described above, the pretilt azimuth of the liquid crystal molecules 182 as defined by the first alignment region OR1 of the first alignment film 130 is +y direction, while that, of the liquid crystal molecules 182 as defined by the second alignment region OR2 thereof is −y direction. On the other hand, the pretilt azimuth of the liquid crystal molecules 182 as defined by the third alignment region OR3 of the second alignment film 170 is −x direction, while that of the liquid crystal molecules 182 as defined by the fourth alignment region OR4 thereof is +x direction.

In the following description, the direction in which an alignment film is subjected to an alignment treatment will be referred to herein as an “alignment treatment direction”. If a directional component of the light that irradiates an alignment film being subjected to a photo-alignment treatment is projected onto the alignment film and is called “exposure direction”, then the exposure direction is the same as the alignment treatment direction. And the alignment treatment direction corresponds to an azimuthal component defined by projecting a line that runs toward an alignment region along the major axis of liquid crystal molecules onto that alignment region. The alignment treatment directions of the first, second, third and fourth alignment regions will be referred to herein as “first, second, third and fourth alignment treatment directions”, respectively.

In the first alignment film 130, the first alignment region OR1 has been subjected to an alignment treatment in a first alignment treatment direction PD1, while the second alignment region OR2 has been subjected to an alignment treatment in a second alignment treatment direction PD2, which is different from the first alignment treatment direction PD1. In this case, the first alignment treatment direction PD1 is substantially antiparallel to the second alignment treatment direction PD2. On the other hand, in the second alignment film 170, the third alignment region OR3 has been subjected to an alignment treatment in a third alignment treatment direction PD3, while the fourth alignment region OR4 has been subjected to an alignment treatment in a fourth alignment treatment direction PD4, which is different from the third alignment treatment direction PD3. In this case, the third alignment treatment direction PD3 is substantially antiparallel to the fourth alignment treatment direction PD4.

In the first alignment film 130, the boundary between the first and second alignment regions OR1 and OR2 runs in the column direction (i.e., y direction). In the second alignment film 170, on the other hand, the boundary between the third and fourth alignment regions OR3 and OR4 runs in the row direction (i.e., x direction). Also, the angle formed between the first and second alignment treatment directions and the third and fourth alignment treatment directions is approximately 90 degrees.

Also, in this case, the boundary between the first and second alignment regions OR1 and OR2 of the first alignment film 130 is substantially parallel to the alignment treatment direction of the first and second alignment regions OR1 and OR2. And the boundary between the third and fourth alignment regions OR3 and OR4 of the second alignment film 170 is substantially parallel to the alignment treatment direction of the third and fourth alignment regions OR3 and OR4. By carrying out the alignment treatment in this manner, the width of a region with a non-controllable pretilt direction, which would be produced in the vicinity of the boundary, can be reduced significantly compared to a situation where the alignment treatment is performed perpendicularly to the boundary.

As disclosed in pamphlet of PCT International Application Publication No. 2006/121220, the respective pretilt angles defined by the alignment films 130 and 170 are preferably approximately equal to each other because the display luminance characteristic can be improved in that case. Particularly, if the difference between the pretilt angles defined by the alignment films 130 and 170 is within one degree, the reference alignment directions of liquid crystal molecules located around the middle of the liquid crystal layer 180 can be controlled with good stability and the display luminance characteristic can be improved significantly. Conversely, if the difference between the pretilt angles increased, then the reference alignment directions would vary significantly from one position in the liquid crystal layer to another and there would be regions with lower transmittances than the intended one. That is to say, the transmittance would be non-uniform.

As shown in FIG. 4(c), four liquid crystal domains A, B, C and D are formed in the liquid crystal layer 180. Specifically, a portion of the liquid crystal layer 180 that is sandwiched between the first alignment region OR1 of the first alignment film 130 and the third alignment region OR3 of the second alignment film 170 becomes the liquid crystal domain A. Another portion of the liquid crystal layer 180 that is sandwiched between the first alignment region OR1 of the first alignment film 130 and the fourth alignment region OR4 of the second alignment film 170 becomes the liquid crystal domain B. Still another portion of the liquid crystal layer 180 that is sandwiched between the second alignment region OR2 of the first alignment film 130 and the fourth alignment region OR4 of the second alignment film 170 becomes the liquid crystal domain C. And yet another portion of the liquid crystal layer 180 that is sandwiched between the second alignment region OR2 of the first alignment film 130 and the third alignment region OR3 of the second alignment film 170 becomes the liquid crystal domain D.

The alignment direction of liquid crystal molecules located at the center of the liquid crystal domain A through D becomes an intermediate direction between the two pretilt directions of liquid crystal molecules defined by the first and second alignment films 130 and 170. In the following description, the alignment direction of liquid crystal molecules at the center of a liquid crystal domain will be referred to herein as a “reference alignment direction” and the azimuthal component of the reference alignment direction that points forward (i.e., from the rear side (the active-matrix substrate) toward the front side (the counter substrate)) along the major axis of liquid crystal molecules will be referred to herein as a “reference alignment azimuth”. In this case, the reference alignment azimuth represents the azimuthal component of the alignment direction of the liquid crystal molecules 182 that point from the active-matrix substrate toward the counter substrate when an electric field is generated perpendicularly between the subpixel electrodes 121a, 121b (see FIGS. 2 and 3) and the counter electrode 160 (see FIG. 1). The reference alignment azimuth is characteristic of its associated liquid crystal domain and has dominant influence on the viewing angle dependence of that liquid crystal domain. Supposing the counterclockwise direction with respect to the horizontal direction of the display screen (or the paper of the drawings) is positive (e.g., supposing the three o'clock direction defines an azimuthal angle of 0 degrees and the counterclockwise direction is positive if the display screen is compared to the face of a clock), the reference alignment azimuths of the four liquid crystal domains A through D are defined so that the difference between any two of those four directions becomes substantially an integral multiple of 90 degrees. Specifically, the reference alignment azimuths of the liquid crystal domains A, B, C and D may be 135, 45, 315 and 225 degrees, respectively. Since the reference alignment azimuths are defined symmetrically in this manner, more uniform viewing angle characteristic is realized and the display quality is improved.

As shown in FIG. 4(c), the domain line DL1 is produced parallel to edge portions EG1 and EG4 in the liquid crystal domain A. The domain line DL3 is produced parallel to edge portions EG2 and EG3 in the liquid crystal domain C. Also, as indicated by the dashed line, a disclination line CL1 is observed along the boundary between each adjacent pair of the liquid crystal domains A to D. The disclination line CL1 is a dark line of the center portion. In this case, the disclination lines CL1 and the domain lines DL1 and DL3 look continuous with each other, thus producing dark lines in “8” shape as shown in FIG. 4(c).

It should be noted that the liquid crystal molecules 182 defined in the pretilt directions by the first and second alignment films 130 and 170 as shown in FIGS. 4(a) and 4(b) do not change substantially responsive to an applied voltage. On the other hand, if a voltage applied is greater than a predetermined value, the liquid crystal molecules 182 at the center of each liquid crystal domain will tilt with respect to a normal to the principal surface of the first and second alignment films 130 and 170 as shown in FIG. 4(c). However, if the applied voltage is lower than a predetermined value, then the liquid crystal molecules 182 at the center of each liquid crystal domain will be substantially parallel to a normal to the principal surface of the first and second alignment films 130 and 170. In this manner, four liquid crystal domains are formed in the liquid crystal layer 180 according to the combination of the two alignment regions OR1, OR2 of the first alignment film 130 and the two alignment regions OR3, OR4 of the second alignment film 180, thereby widening the viewing angle. Those four liquid crystal domains are disclosed in pamphlet of PCT International Application Publication No. 2006/132369, for example, the disclosure of which is hereby incorporated by reference. It should be noted that the reference alignment directions and dark lines shown in FIG. 4(c) are the same as the ones shown in FIG. 3(c).

Now look at FIG. 3(c) again. As viewed along a normal to the principal surface of the active-matrix substrate 110A, the subpixel electrodes 121a and 121b have asymmetric shapes. Also, supposing the remaining area of each of the liquid crystal domains A through D, except the areas of its portions overlapping with the dark lines and the lines, is called a “display contributing area” in each of the subpixel electrodes 121a and 121b, the display contributing areas of the liquid crystal domains A through D are approximately equal to each other. As a result, the viewing angle characteristic can be more uniform. Specifically, in the liquid crystal display device 100A, by the shape of the subpixel electrodes 121a, 121b and respective portions of the drain extension lines 127a and 127b that run in the column direction in such an indented shape, the display contributing areas of those liquid crystal domains A through D are adjusted.

FIG. 3(d) illustrates a black matrix BM that is provided for the counter substrate 150 of the liquid crystal display device 100A. The black matrix BM is arranged so as to cover the source lines S, the CS branch lines, TFT-A and TFT-B, and has an indented shape when viewed along a normal to the principal surface of the liquid crystal display device 100A. The black matrix BM runs in the column direction, not in the row direction.

At least most of the domain lines DL1 and DL3 produced in the edge portions of the subpixel electrodes 121a and 121b is covered with the black matrix BM, the gate lines G, the source lines S and the storage capacitor lines CS, whereas the disclination lines produced around the respective centers of the subpixel electrodes 121a and 121b are not covered at all. In this manner, the dark lines do not always have to be hidden. This is because with a structure that hides those dark lines adopted, if the dark lines moved, the transmittance would decrease significantly.

Hereinafter, it will be described with reference to FIGS. 1 to 3 how to fabricate such a liquid crystal display device 100A.

First off, it will be described how to make the active-matrix substrate 110A. First of all, the insulating substrate 112 shown in FIG. 3(b) is provided. The insulating substrate 112 may be a glass substrate, for example. Next, gate lines G and storage capacitor lines CS are formed on the insulating substrate 112 in a single process step. That is why the gate lines G and the storage capacitor lines CS are made of the same material.

Next, an insulating film 114 is deposited over the gate lines G and the storage capacitor lines CS. Portions of the insulating film 114 will eventually be the gate insulating film of TFT-A and TFT-B. Subsequently, source lines S and drain extension lines 127 are formed in a single process step on the insulating film 114. Therefore, the source lines S and the drain extension lines 127 are made of the same material.

Thereafter, a passivation film 116, which is also called an “interlayer dielectric film”, is deposited over the source metal. Contact holes are selectively cut through the passivation film 116. Next, subpixel electrodes 121 are formed on the passivation film 116. And then a first alignment film 130 is deposited over the subpixel electrodes 121. The first alignment film 130 has been subjected to an alignment treatment as shown in FIG. 4(a).

As described above, multiple lines have been formed on the active-matrix substrate 110A. Each of those lines may be formed in the following manner. First, a conductive layer is deposited by sputtering and then is coated with photoresist. Next, the photoresist layer is exposed to light and developed. Such a process step of patterning a photoresist layer into a predetermined shape is called a “photolithographic process”. Using the photoresist layer that has been subjected to such a photolithographic process, the conductive layer is etched into a predetermined pattern. The etching process may be carried out as either dry etching or wet etching. After that, the photoresist layer is stripped. By patterning the conductive layer in this manner, a line can be formed. The line may be a stack of multiple metal layers as well.

In this active-matrix substrate 110A, the subpixel electrodes 121a and 121b are arranged over the source metal with the passivation film 116 interposed between them. That is why when viewed along a normal to the principal surface of the active-matrix substrate 110A, the distance between the source metal and the subpixel electrodes 121a and 121b can be shortened or the subpixel electrodes 121a and 121b can be arranged so as to overlap with the source metal.

In the meantime, a transparent insulating substrate 152 is prepared separately from the active-matrix substrate 110A and a counter electrode 160 and a second alignment film 170 are formed on the insulating substrate 152. The second alignment film 170 has been subjected to an alignment treatment as shown in FIG. 4(b).

Thereafter, a liquid crystal material is dripped on the first alignment film 130 of the active-matrix substrate 110A and then the active-matrix substrate 110A and the counter substrate 150 are bonded together to form a liquid crystal layer 180 between them. The liquid crystal display device 100A may be completed in this manner. Alternatively, the liquid crystal display device 100A may also be obtained by bonding the active-matrix substrate 110A and the counter substrate 150 together first and then injecting a liquid crystal material into the gap between those two substrates so that a liquid crystal layer 180 is formed between them. Still alternatively, if the insulating substrates 112 and 152 have been used to make a motherboard on which a number of liquid crystal display devices 100A have been fabricated together, a single liquid crystal display device 100A may also be obtained by dicing the motherboard.

The active-matrix substrate 110A is fabricated as described above. In the active-matrix substrate 110A thus obtained, however, leakage current could be generated between its lines or some of its lines could be disconnected. If such an active-matrix substrate 110A is used to make a liquid crystal display device 100A, a point defect or a line defect will occur in the device 100A and will degrade its display quality. For that reason, either the active-matrix substrate 110A or the liquid crystal display device 100A is usually tested for any defects. If any defect has been spotted in the active-matrix substrate 110A or the liquid crystal display device 100A as a result of this testing process, it has to be determined what has caused that defect and the defect is repaired to minimize or eliminate such deterioration in display quality.

Main causes for such defects are disconnection and leakage current. Disconnection is believed to happen in the following manner. Specifically, if any foreign matter entered a photoresist film that has just been applied during a photolithographic process, some of the photoresist layer that should remain in the etching process would be lost through development due to the presence of such foreign matter. Consequently, a conductive layer that should remain connected would be disconnected in the etching process. If the liquid crystal display device operates in a normally black mode, the disconnection will produce a black line on the screen.

Such disconnection may be detected by any of the following methods or their combination: 1) seeing if there is any abnormality by comparing several surrounding pixels to each other; 2) inputting an electrical signal to a terminal to detect either a current value or a resistance value; 3) detecting a defect either by inputting an electrical signal to a terminal and bringing a liquid crystal module close to pixels or by secondary electron method with the spot in question irradiated with a laser beam; and 4) detecting a defect with pixels lit when an LCD panel or a module with built-in circuits is completed.

On the other hand, leakage current is believed to be generated in the following manner. Specifically, if metallic dust (or particles) produced during a sputtering process or metallic particles floating in a chamber during a dry etching process entered an insulating layer as huge foreign particles, leakage current generated by such foreign particles could not be detected immediately but would easily be sensed when stacked metal layers are etched. Leakage current is generated particularly easily where multiple lines intersect with each other or where a pixel electrode overlaps with a line. And once leakage current has been generated, a point defect or a line defect will be produced. If the liquid crystal display device operates in a normally black mode, the leakage current generated will produce a bright line on the screen. The leakage current can be detected in the same way as disconnection.

Hereinafter, it will be described with reference to FIGS. 5 through 10 what are causes for defects and how to repair the defects.

As shown in FIG. 5, if leakage current has been generated between the drain electrode of TFT-A and either the gate line G(m+1) or the source line S(n), a gate signal voltage or a source signal voltage is applied to the subpixel electrode 121a when the subpixel in question is not selected. In this case, if the voltage applied to the liquid crystal capacitor Clca (see FIG. 2) is higher than what is supposed to be, then the subpixel SP-A will be a bright spot. In such a situation, a portion of the drain extension line 127a associated with the notch 122a2 of the subpixel electrode 121a is irradiated with a laser beam and cut off. Also, respective overlapping portions of the subpixel electrode 121a, the drain extension line 127a and the CS trunk line are also irradiated with a laser beam and melted. As a result, the subpixel electrode 121a, the drain extension line 127a and the CS trunk line are connected together. Such a technique for connecting multiple conductive members together by melting their overlapping portions with a laser beam will be referred to herein as a “laser melt”. Generally speaking, a CS signal voltage applied to the storage capacitor line CS is close to a counter voltage applied to the counter electrode. That is why if the CS signal voltage is applied to the subpixel electrode 121a as a result of the laser melt, then the subpixel SP-A will display black. It should be noted that if a pixel with a defect displayed white, then the display quality would be debased significantly because white is easily sensible for a viewer. If such a defective pixel displayed black, however, the decline in display quality should be minimized.

As described above, a laser beam is used for both laser melting and cutting. If respective portions of two or more metal layers (or lines) that are adjacent to each other with an insulating layer interposed between them are irradiated with a laser beam, then one of the metal layer that has been directly irradiated with the laser beam will be partially melted and the molten metal will go through the insulating layer to reach another metal layer, thereby getting the laser melt done. Meanwhile, if an isolated line surrounded with no metal layers is irradiated with a laser beam, then the line will be cut off. It should be noted that the laser beam could irradiate the active-matrix substrate through either the front side or rear side thereof and even after the LCD panel has been completed. Usually, however, an active-matrix substrate is irradiated with a laser beam through its front side. On the other hand, an LCD panel is normally irradiated with a laser beam through the transparent substrate of its active-matrix substrate.

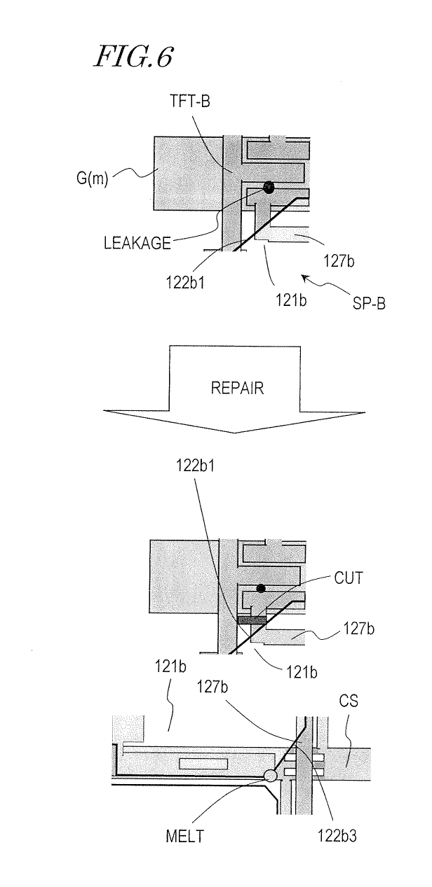

On the other hand, as shown in FIG. 6, if leakage current has been generated between the drain electrode of TFT-B and either the gate line G(m) or the source line S(n), gate signal voltage or a source signal voltage is applied to the subpixel electrode 121b when the subpixel in question is not selected. In this case, if the voltage applied to the liquid crystal capacitor Clcb (see FIG. 2) is higher than what is supposed to be, then the subpixel SP-B will be a bright spot. In such a situation, a portion of the drain extension line 127b associated with the notch 122b1 of the subpixel electrode 121b is irradiated with a laser beam and cut off. Also, respective overlapping portions of the subpixel electrode 121b, the drain extension line 127b and the CS trunk line are also irradiated with a laser beam and melted. As a result, the subpixel electrode 121b, the drain extension line 127b and the CS trunk line are connected together. As described above, a CS signal voltage applied to the storage capacitor line CS is close to a counter voltage applied to the counter electrode. That is why if the CS signal voltage is applied to the subpixel electrode 121b as a result of the laser melt, then the subpixel SP-B will display black. Consequently, the decline in display quality can be minimized.

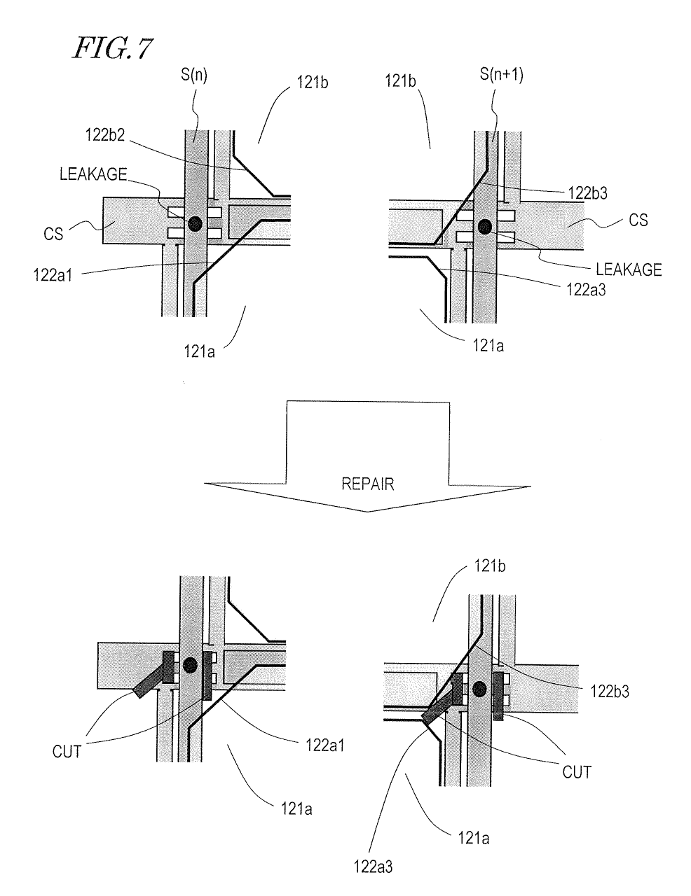

As shown in FIG. 7, if leakage current were generated between a source line S(n) or S(n+1) and a fine line of the CS trunk line, then the potentials of the source signal and the CS signal would shift, and the display quality would be debased. In that case, several fine lines, including the one with the leakage current, should be irradiated with a laser beam and cut off, thereby isolating the leaking portions from the storage capacitor line CS. In this example, the CS branch lines would be isolated from the CS trunk line. By irradiating portions of the storage capacitor line CS with a laser beam and cutting them off so that the leaking portions are isolated from the storage capacitor line CS in this manner, a defect caused by the leakage current between the source line S and the CS trunk line can be rectified. As the subpixel electrodes 121a and 121b do not overlap with the intersecting portion between the CS trunk line and the source line S because they have notches 122a1 and 122b3, the leaking portions can be isolated from the CS trunk line easily without cutting the subpixel electrodes 121a and 121b.

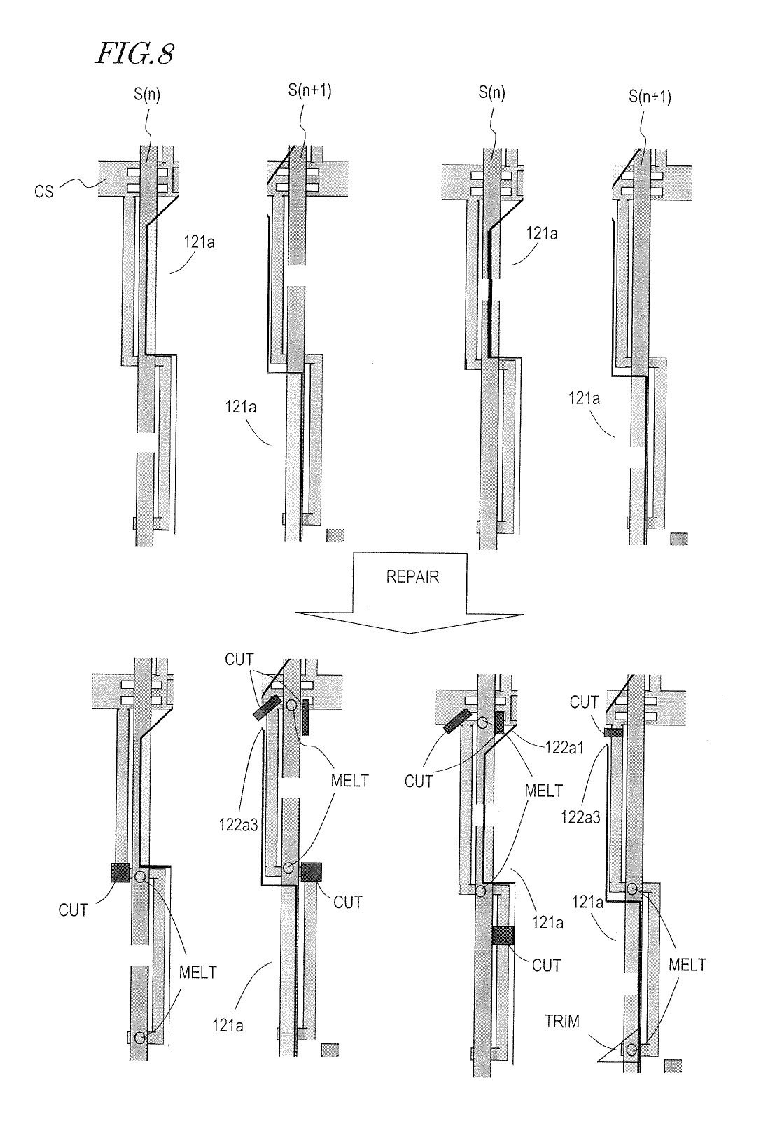

As shown in FIG. 8, if the source line S(n) or S(n+1) were disconnected, no source signals would be supplied to the source electrode of other pixels and a line defect would be produced. In that case, among the CS branch line and the CS trunk line, at least the CS branch line would be irradiated with a laser beam, cut off and isolated from the CS trunk line (which will be referred to herein as “CS isolated line”). Also, two portions of the source line S that interpose the disconnected portion and that overlap with the CS isolated line would also be irradiated with a laser beam and melted, thereby connecting the CS isolated line and the source line S together. As a result, the disconnected source line S would be connected with the CS isolated line. And the source signal could be supplied appropriately using the CS isolated line as a bypass. On the other hand, if one of two portions of the source line S, which interpose its disconnected portion between them and in which the source line S and the CS isolated line overlap with each other, overlaps with the subpixel electrode 121, then a portion of the subpixel electrode 121 that surrounds the overlapping portion between the source line S and the CS isolated line is irradiated with a laser beam and removed so as to prevent leakage current from flowing to the subpixel electrode 121. Thereafter, the CS isolated line and the source line S are connected together, thereby using the CS isolated line as a bypass for the source line S. It should be noted that to remove a part of the subpixel electrode 121 in this manner is also called “trimming”. When such trimming is done, the laser beam is focused on ITO that is the material of the pixel electrode and irradiates that ITO through the film surface, thereby subliming and removing that material.

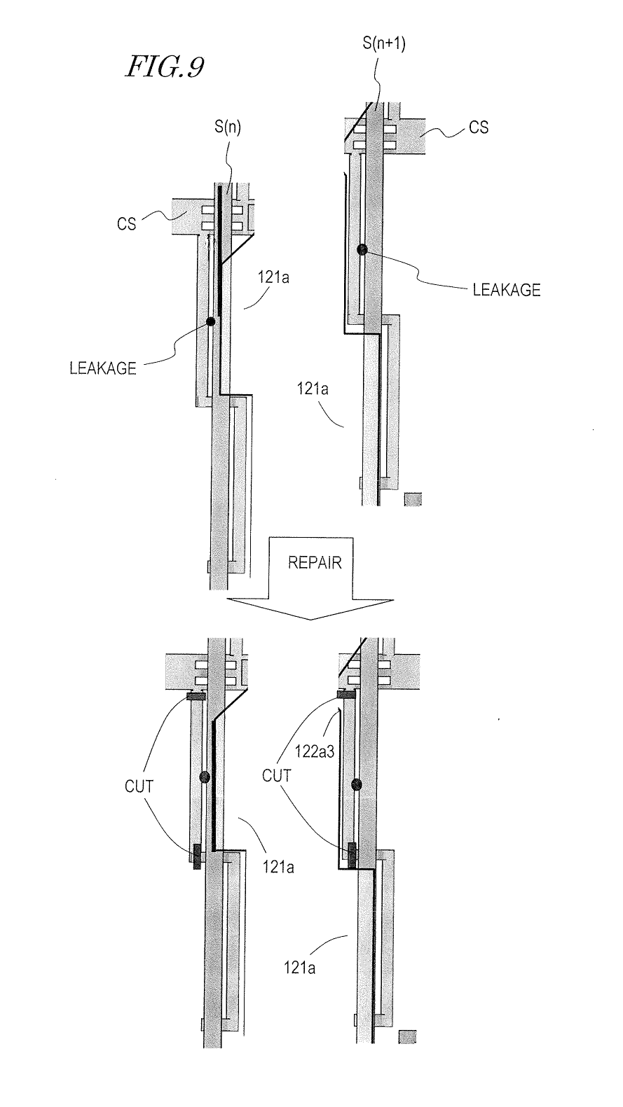

As shown in FIG. 9, if leakage current were generated between a source line S(n) or S(n+1) and a CS branch line, then the potentials of the source signal and the CS signal would shift, and the display quality would be debased.

In that case, two portions of the CS branch line, which interpose the leaking portion of the source line S(n) or S(n+1), should be irradiated with a laser beam and cut off, thereby isolating the leaking portions from the CS trunk line. As a result, desired CS signal voltage and source signal voltage could be applied to the CS trunk line and the source line S, respectively.

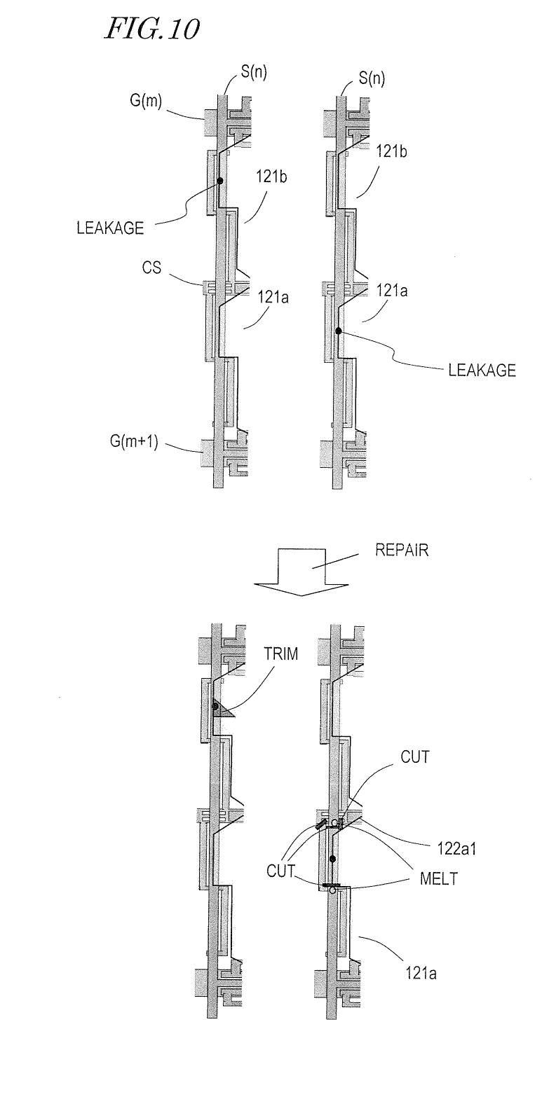

On the other hand, if leakage current were generated between the subpixel electrode 121b and the source line S(n) as shown in FIG. 10, the source signal would also be supplied to the subpixel electrode 121b even when the subpixel is not selected. As a result, the display quality would be debased. In that case, a portion of the subpixel electrode 121b that surrounds its leaking portion could be irradiated with a laser beam, thereby trimming the leaking portion of the subpixel electrode 121b.

Furthermore, if leakage current were generated between the subpixel electrode 121a and the source line S(n), two portions of the source line S that interpose the leaking portion between them could be irradiated with a laser beam and cut off. And among the CS branch line and the CS trunk line, at least the CS branch line would be irradiated with a laser beam, cut off and isolated from the CS trunk line to form a CS isolated line. Also, two portions, which interpose the above two portions of the source line S(n) and in which the CS isolated line and the source line S(n) overlap with each other, could be irradiated with a laser beam and melted, thereby connecting the CS isolated line and the source line S(n) together. As a result, the source signal can be supplied just as intended through the CS isolated line and deterioration in display quality can be minimized.

As described above, as for the subpixel SP-A, the notch 122a1 of the subpixel electrode 121a is provided for the storage capacitor line CS and the source line S, and therefore, the defect can be repaired easily as shown in FIGS. 5, 7, 8 and 10. Meanwhile, the notch 122a2 of the subpixel electrode 121a is provided for the drain extension line 127a, and therefore, the defect can be repaired easily as shown in FIG. 5.

On the other hand, as for the subpixel SP-B, the notch 122b1 of the subpixel electrode 121b is provided for the drain extension line 127b, and therefore, the defect can be repaired easily as shown in FIG. 6. Meanwhile, the notch 122b3 of the subpixel electrode 121b is provided for the storage capacitor line CS and the source line S, and therefore, the defect can be repaired easily as shown in FIGS. 6 and 7.

By providing the notches 122a1 to 122a3 and 122b1 to 122b3 for the subpixel electrodes 121a and 121b as described above, the defects can be repaired easily. Nevertheless, compared to a situation where the subpixel electrodes have no notches, the area of a pixel region will decrease. Also, as described above, if the azimuthal component of the alignment direction of liquid crystal molecules aligned by an oblique electric field that has been generated around an edge portion of a pixel electrode has an antiparallel component to the reference alignment azimuths of their associated liquid crystal domains, then the alignment of the liquid crystal molecules will be disturbed and the optical transmittance will decrease. Hereinafter, it will be described with reference to FIGS. 3, 4 and 11 how in the liquid crystal display device 100A of this embodiment, the oblique electric field generated around the notches 122a1 to 122a3 and 122b1 to 122b3 of the pixel electrodes 121a and 121b will affect the azimuthal component of the alignment direction of the liquid crystal molecules 182 and the reference alignment azimuths of their associated liquid crystal domains.

FIG. 11 schematically illustrates the notch 122 of the pixel electrode 121 and the liquid crystal molecules 182. In FIG. 11, illustration of the first alignment film 130 shown in FIG. 1 is omitted. The alignment direction of the liquid crystal molecules 182 near the first alignment film 130 is basically determined by the first alignment film 130. However, the liquid crystal molecules 182 in the vicinity of the notch 122 of the pixel electrode 121 are also affected by an oblique electric field generated by the notch 122 of the pixel electrode 121 and the counter electrode 160 (see FIG. 1). And at the notch 122, the alignment of the liquid crystal molecules 182 in the liquid crystal layer 180 is determined by the shape of the notch 122.

Now look at FIGS. 3 and 4 again. In the liquid crystal domain B of the subpixel SP-A, the oblique electric field generated by the notch 122a2 of the subpixel electrode 121a and the counter electrode 160 upon the application of a voltage applies an alignment control force to the liquid crystal molecules 182, located in a region of the liquid crystal layer 180 associated with the notch 122a2, in the same direction as the liquid crystal molecules located at the center of that liquid crystal domain B, thereby inducing alignment of the liquid crystal molecules 182 located at the notch 122a2 of the subpixel electrode 121a. And the azimuthal component of the alignment direction of those liquid crystal molecules 182, of which the director points from the active-matrix substrate toward the counter substrate, becomes substantially parallel to the reference alignment azimuths of the liquid crystal domains B. As can be seen, if the azimuthal component of the liquid crystal molecules 182 located in a region of the liquid crystal layer 180 associated with the notch 122a2 of the subpixel electrode 121a defies an angle of 90 degrees or less with respect to the reference alignment azimuth of their associated liquid crystal domain B (i.e., if the azimuthal component of the liquid crystal molecules 182 located at the notch 122a2 of the subpixel electrode 121a does not have an antiparallel component to the reference alignment azimuth of the liquid crystal domain B), their alignment is never disturbed and no dark lines are produced.

On the other hand, in the liquid crystal domain A of the subpixel SP-A, an oblique electric field is generated by the notch 122a1 of the subpixel electrode 121a and the counter electrode 160 upon the application of a voltage. This oblique electric field induces alignment of the liquid crystal molecules 182, located in a region of the liquid crystal layer 180 associated with the notch 122a1 of the subpixel electrode 121a. And the azimuthal component of the alignment direction of those liquid crystal molecules, of which the director points from the active-matrix substrate 110A toward the counter substrate 150, becomes substantially antiparallel to the reference alignment azimuth of the liquid crystal domain A. As can be seen, if the azimuthal component of the liquid crystal molecules 182 located at the notch 122a1 of the subpixel electrode 121a defies an angle of greater than 90 degrees with respect to the reference alignment azimuth of their associated liquid crystal domain (i.e., if the azimuthal component of the liquid crystal molecules 182 located at the notch 122a1 of the subpixel electrode 121a has an antiparallel component to the reference alignment azimuth of their associated liquid crystal domain A), the alignment of the liquid crystal molecules 182 is disturbed around the notch 122a1 of the subpixel electrode 121a. In the same way, in the liquid crystal domain A of the subpixel SP-B, the alignment of the liquid crystal molecules 182 is disturbed around the notch 122b1 of the subpixel electrode 121b. And in the liquid crystal display device C of the subpixel SP-B, the alignment of the liquid crystal molecules 182 is disturbed around the notch 122b3 of the subpixel electrode 121b.

As described above, in the liquid crystal display device 100A of this embodiment, no dark lines are produced around the notch 122a2 of the subpixel electrode 121a. That is why a portion of the liquid crystal domain B associated with the notch 122a2 does not have to be shielded from incoming light and the decrease in optical transmittance can be minimized. Also, since the notch 122a2 of the subpixel electrode 121a is provided for the drain extension line 127a as shown in FIG. 5, the defect can be repaired easily.

It should be noted that the subpixel electrode 121a has not only the notch 122a2 but also another notch 122a3 as well. The oblique electric field generated by the notch 122a3 of the subpixel electrode 121a and the counter electrode 160 induces alignment of the liquid crystal molecules 182, located in a region of the liquid crystal layer 180 associated with the notch 122a3 of the subpixel electrode 121a. And the azimuthal component of the alignment direction of those liquid crystal molecules 182, of which the director points from the active-matrix substrate toward the counter substrate, becomes substantially parallel to the reference alignment azimuths of the liquid crystal domains D. Likewise, the subpixel electrode 121b also has another notch 122b2. The oblique electric field generated by the notch 122b2 of the subpixel electrode 121b and the counter electrode 160 induces alignment of the liquid crystal molecules 182, located in a region of the liquid crystal layer 180 associated with the notch 122b2 of the subpixel electrode 121b. And the azimuthal component of the alignment direction of those liquid crystal molecules 182, of which the director points from the active-matrix substrate toward the counter substrate, becomes substantially parallel to the reference alignment azimuths of the liquid crystal domains B. Consequently, the notches 122a2, 122a3 and 122b2 apply an alignment control force to their neighboring liquid crystal molecules in the same direction as the liquid crystal molecules located at the respective centers of the liquid crystal domains B and D when a voltage is applied. As a result, no dark lines are produced around the notches 122a2, 122a3 and 122b2 of the subpixel electrodes 121a and 121b. Those notches 122a2, 122a3 and 122b2 cross the x- and y-axes at an angle of 45 degrees, for example. Each notch needs to have a size of at least 5 μm. Usually, each line needs to have a width of at least 4 μm.

If the alignment control force applied by the notches 122a2, 122a3 and 122b2 of the subpixel electrodes 121a and 121b to the liquid crystal molecules 182 is insufficient, then the second alignment film 170 may have a projection or the counter electrode 160 may have a slit (opening) to increase the alignment control force to the liquid crystal molecules 182. If a projection is provided for the second alignment film 170, the projection may be arranged at the rib of the counter electrode 160 of the counter substrate 150. The projection of the second alignment film 170 or the slit of the counter electrode 160 is arranged so that the azimuthal component of the liquid crystal molecules 182 does not have an antiparallel component to the reference alignment azimuth of their associated liquid crystal domain when a voltage is applied thereto.

If some pressure is temporarily applied from over the counter substrate to the liquid crystal display device 100A in which dark lines are produced, then the liquid crystal layer 180 (see FIG. 1) would have a non-uniform thickness and the liquid crystal molecules 182 would have their alignment disturbed. As a result, the dark lines would shift from their original locations before the pressure is applied. If the dark lines shifted, the area ratio between the liquid crystal domains would vary and the viewing angle characteristic would decline. Once the pressure is removed, the dark lines will gradually return to their original locations with time. However, it usually takes a relatively long time for the liquid crystal molecules to recover from their disturbed alignment and for the dark lines to return to their original locations.

As described above, in the liquid crystal display device 100A, the oblique electric field generated makes the azimuthal component of the alignment direction of the liquid crystal molecules 182, which are located in regions of the liquid crystal layer 180 that are associated with the notches 122a2, 122a3 and 122b2 of the subpixel electrodes 121a and 121b and of which the director points from the active-matrix substrate toward the counter substrate, substantially parallel to the reference alignment azimuths of the liquid crystal domains B and D. That is why even if the alignment of the liquid crystal molecules 182 has once been disturbed, alignment control force will also be applied to the liquid crystal molecules 182 located around those notches 122a2, 122a3 and 122b2 in the same direction as the liquid crystal molecules 182 located at the respective centers of their associated liquid crystal domains B and D. For that reason, the liquid crystal molecules can recover from their disturbed alignment quickly and it will take a shorter time to eliminate such a shift of dark lines. In this manner, the notches 122a2, 122a3 and 122b2 can help the liquid crystal molecules recover from their disturbed alignment.

The liquid crystal display device 100A of this embodiment has not only the notches 122a2, 122a3 and 122b2 but also other notches 122a1, 122b1 and 122b3 as well. And the oblique electric field generated around these notches 122a1, 122b1 and 122b3 makes the azimuthal component of the alignment direction of the liquid crystal molecules antiparallel to the reference alignment azimuths of their associated liquid crystal domains A and C. In the following description, those notches 122a1, 122b1 and 122b3 for generating such an oblique electric field that induces alignment of liquid crystal molecules so that their azimuthal component has an antiparallel component to that of the reference alignment azimuths of their associated liquid crystal domains will be referred to herein as “other notches”.

As can be seen from the foregoing description, these notches 122a1, 122b1 and 122b3 of the subpixel electrodes 121a and 121b disturb the alignment of their neighboring liquid crystal molecules 182 unlike the notches 122a1, 122b1 and 122b3. In the active-matrix substrate 110A of the liquid crystal display device 100A of this embodiment, however, the notches 122a1, 122b1 and 122b3 are at least partially covered with the source line S, the storage capacitor line CS, or the gate line G unlike the notch 122a2. That is why the region with such disturbed alignment does not actually affect the optical transmittance so much.

The sides of the subpixel electrodes 121a and 121b that run in the row direction (x direction) and in the column direction (y direction), respectively, have an indented shape, which corresponds to the “8” shape of the dark lines produced, as viewed along a normal to the principal surface of the liquid crystal display device 100A. More specifically, the subpixel electrodes 121a and 121b are arranged so that their portions with dark lines protrude outward compared to the rest with no dark lines.

In the liquid crystal display device 100A described above, the domain lines are supposed to be produced in the liquid crystal domains A and C. However, the present invention is in no way limited to it.

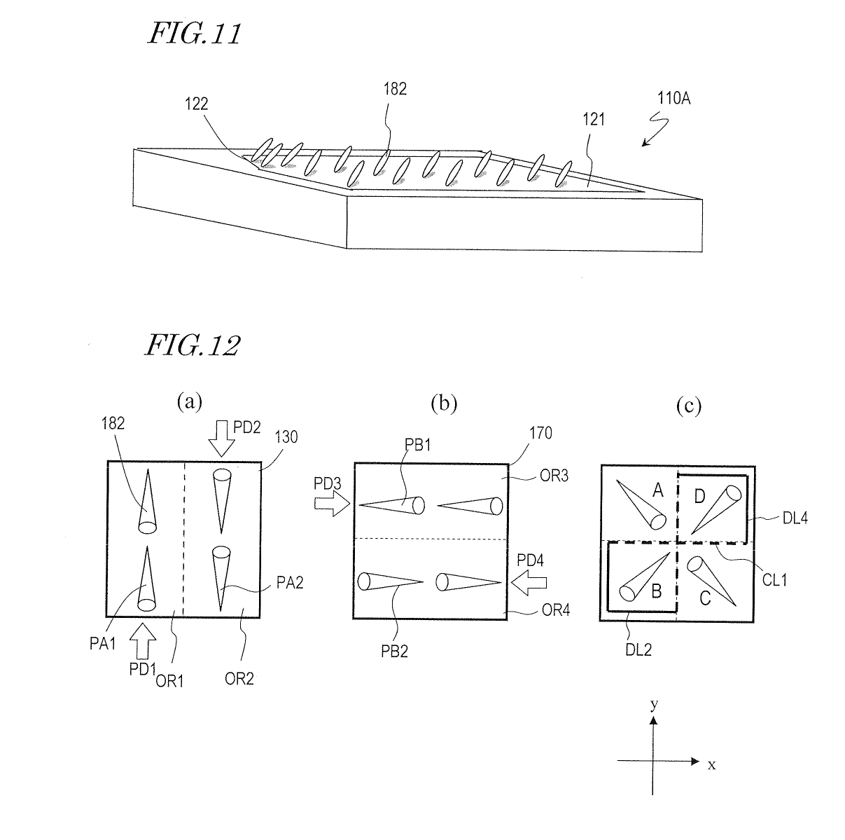

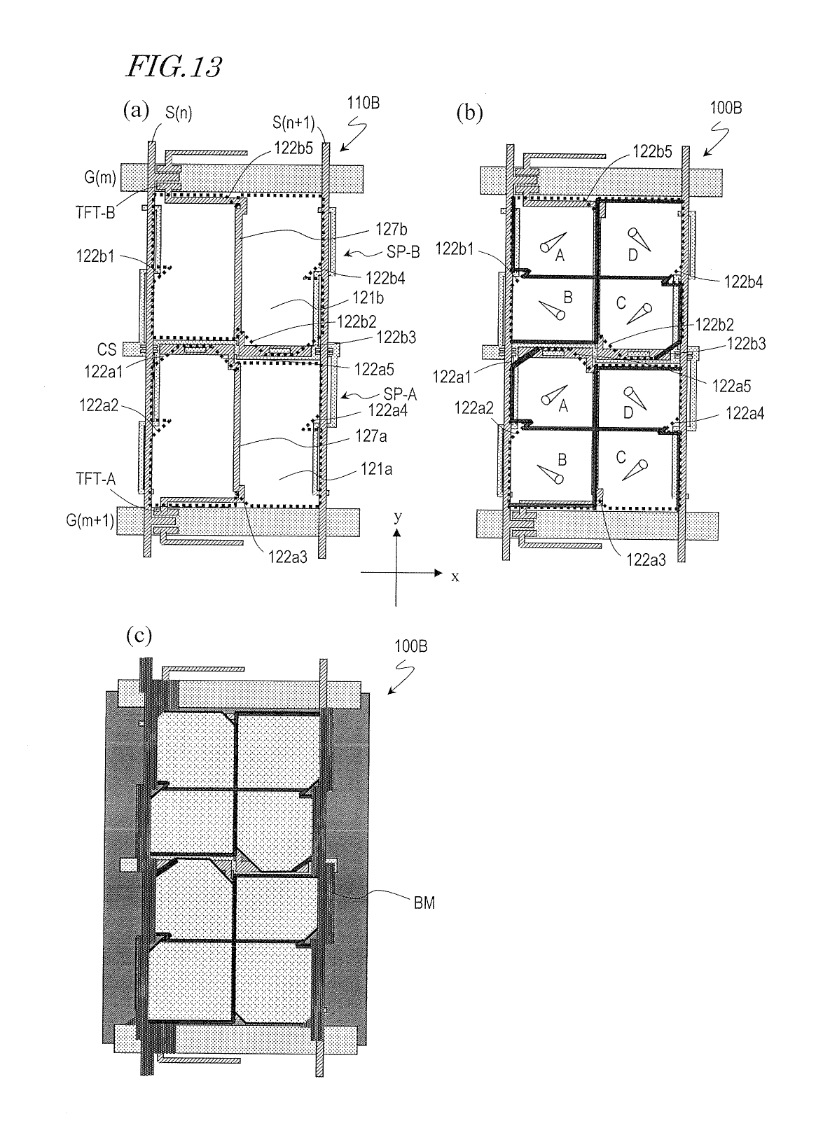

FIGS. 12(a) and 12(b) are schematic representations illustrating liquid crystal molecules that are aligned by the first and second alignment films 130 and 170, respectively, in a modified example of this embodiment, and FIG. 12(c) is a schematic representation illustrating liquid crystal molecules around the respective centers of the liquid crystal domains.

As shown in FIG. 12, the first and second alignment treatment directions PD1 and PD2 of the first and second alignment regions OR1 and OR2 of the first alignment film 130 are +y and −y directions, respectively. On the other hand, the third and fourth alignment treatment directions PD3 and PD4 of the third and fourth alignment regions OR3 and OR4 of the second alignment film 170 are +x and −x directions, respectively. In that case, a continuous domain line DL2 will be produced horizontally and vertically in the liquid crystal domain B and a continuous domain line DL4 will be produced horizontally and vertically in the liquid crystal domain D. In this manner, the domain lines DL2 and DL4 may be produced in the liquid crystal domains B and D.

### Embodiment 2

Hereinafter, a second embodiment of a liquid crystal display device according to the present invention will be described.

FIG. 13(a) is a schematic plan view illustrating the configuration of an active-matrix substrate 110B for the liquid crystal display device 100B of the second embodiment. FIG. 13(b) is a schematic plan view illustrating how dark lines are produced in the liquid crystal display device 100B of this embodiment. And FIG. 13(c) is a schematic plan view illustrating the liquid crystal display device 100B.

The liquid crystal display device 100B of this embodiment has substantially the same structure as the liquid crystal display device 100A described above, and the overlapping description thereof will be omitted herein. The liquid crystal display device 100B is different from this liquid crystal display device 100A in that the dark lines are produced in an inverted swastika shape.

In FIG. 13(a), illustrated are the second subpixel SP-B of a pixel on the m^{th} row and the first subpixel SP-A of a pixel on the (m+1)^{th} row. The first and second subpixels SP-A and SP-B are defined by subpixel electrodes 121a and 121b, respectively.

The storage capacitor line CS includes a CS trunk line running in the row direction (x direction) and CS branch lines branching from the CS trunk line. Specifically, the CS trunk line and the source line S intersect with each other and the CS trunk line branches into a number of fine lines so that there is an opening at the intersection between the CS trunk line and the source line S. That is why the area of overlap between the CS trunk line and the source line S is relatively small and leakage current is less likely to be generated between the CS trunk line and the source line S. On the other hand, the CS branch lines run in the +y and −y directions with respect to the CS trunk line.

Also, each of the CS branch lines includes two intersecting portions that intersect with the source line S and two parallel portions that are connected to the intersecting portions and that run substantially parallel to the source line S. One of the two parallel portions of each CS branch line is arranged in the −x direction with respect to the source line S, while the other parallel portion of the CS branch line is arranged in the +x direction with respect to the source line S. Thus, the CS branch line has an indented shape as viewed along a normal to the principal surface of the active-matrix substrate 110B.

The drain extension line 127a is extended from the drain electrode of TFT-A through the CS trunk line by way of the center of the subpixel electrode 121a in the row direction. Through a contact hole that has been cut through the intersection between the drain extension line 127a and the CS trunk line, the drain extension line 127a is connected to the subpixel electrode 121a. In the same way, the drain extension line 127b is extended from the drain electrode of TFT-B through the CS trunk line by way of the center of the subpixel electrode 121b in the row direction. Through a contact hole that has been cut through the intersection between the drain extension line 127b and the CS trunk line, the drain extension line 127b is connected to the subpixel electrode 121b.

The subpixel electrode 121a has notches 122a1, 122a2, 122a3, 122a4 and 122a5. Each of the notches 122a2, 122a3, 122a4 and 122a5 is arranged on just one side of the subpixel electrode 121a that runs in either the row direction or the column direction and is located at the intersection between an edge of the subpixel electrode 121a and the boundary of two adjacent liquid crystal domains. On the other hand, only the notch 122a1 is arranged at a corner of the subpixel electrode 121a and at the intersection between two sides thereof running in the column and row directions, respectively. Likewise, the subpixel electrode 121b also has notches 122b1, 122b2, 122b3, 122b4 and 122b5. Each of the notches 122b1, 122b2, 122b4 and 122b5 is arranged on just one side of the subpixel electrode 121b that runs in either the row direction or the column direction and is located at the intersection between an edge of the subpixel electrode 121b and the boundary of two adjacent liquid crystal domains. On the other hand, only the notch 122b3 is arranged at a corner of the subpixel electrode 121 and at the intersection between two sides thereof running in the column and row directions, respectively.

Most of the drain extension line 127a is covered with the subpixel electrode 121a but only a portion of the drain extension line 127a is not covered with the subpixel electrode 121a at the notches 122a3 and 122a5. That is to say, the notches 122a3 and 122a5 of the subpixel electrode 121a are provided for the drain extension line 127a. In the same way, most of the drain extension line 127b is covered with the subpixel electrode 121b but only a portion of the drain extension line 127b is not covered with the subpixel electrode 121b at the notches 122b2 and 122b5. That is to say, the notches 122b2 and 122b5 of the subpixel electrode 121b are provided for the drain extension line 127b.

On the other hand, the notches 122a2, 122a4, 122b1 and 122b4 of the subpixel electrodes 121a and 121b are provided for CS branch lines. Specifically, the notch 122a1 of the subpixel electrode 121a is arranged at the intersection between the CS trunk line and the source line S(n), while the notch 122a1 of the subpixel electrode 121a is arranged at the intersection between the CS trunk line and the source line S(n).

FIG. 13(b) indicates the alignment directions of liquid crystal molecules around the respective centers of the liquid crystal domains along with the dark lines produced in the liquid crystal display device 100B that has been fabricated using such an active-matrix substrate 110B.

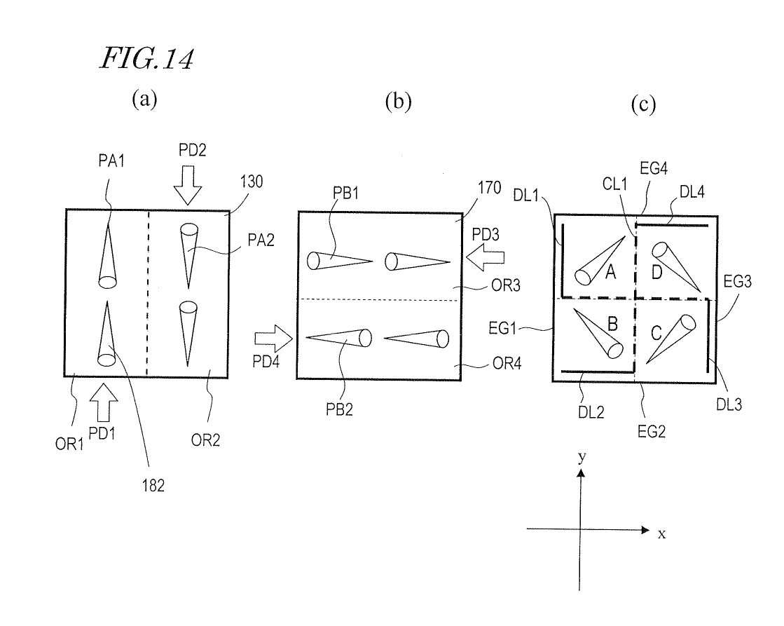

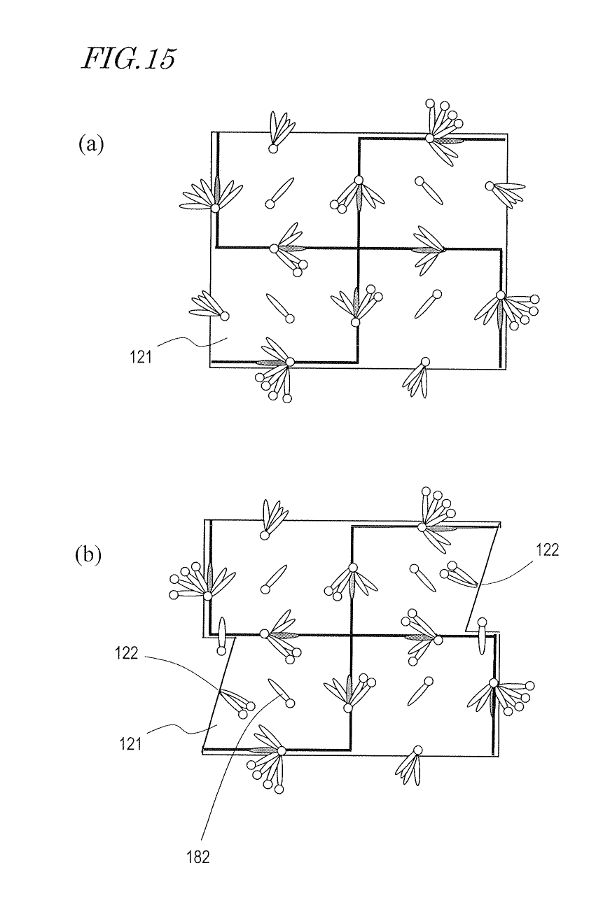

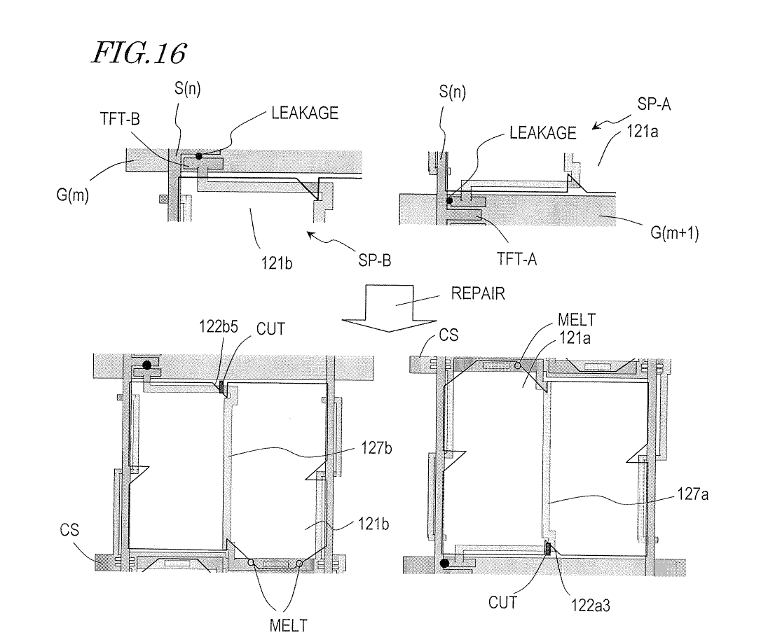

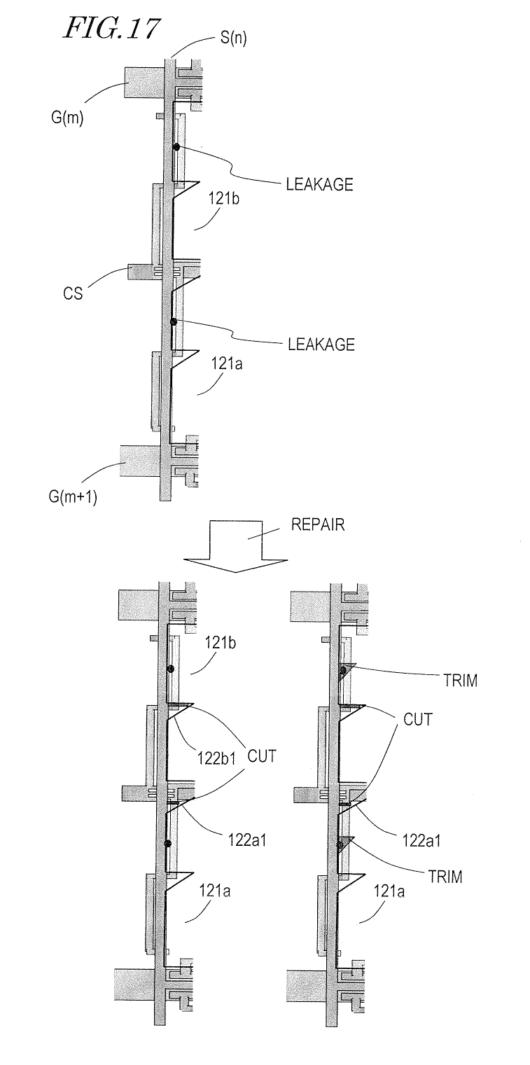

Hereinafter, the first and second alignment films 130 and 170 and the alignment directions of the liquid crystal molecules will be described with reference to FIGS. 14 and 15.

FIG. 14(a) is a schematic representation illustrating liquid crystal molecules aligned by the first alignment film 130 in the liquid crystal display device 100B. FIG. 14(b) is a schematic representation illustrating liquid crystal molecules aligned by the second alignment film 170. And FIG. 14(c) is a schematic representation illustrating liquid crystal molecules located around the respective centers of the liquid crystal domains.

As shown in FIG. 14(a), the first alignment film 130 has first and second alignment regions OR1 and OR2. The liquid crystal molecules aligned by the first alignment region OR1 tilt in the −y direction with respect to a normal to the principal surface of the first alignment film 130. Meanwhile, the liquid crystal molecules aligned by the second alignment region OR2 of the first alignment film 130 tilt in the +y direction with respect to a normal to the principal surface of the first alignment film 130.

On the other hand, the second alignment film 170 has third and fourth alignment regions OR3 and OR4 as shown in FIG. 14(b). The liquid crystal molecules aligned by the third alignment region OR3 tilt in the +x direction with respect to a normal to the principal surface of the second alignment film 170 and their bottom in the −x direction faces forward. Meanwhile, the liquid crystal molecules aligned by the fourth alignment region OR4 of the second alignment film 170 tilt in the −x direction with respect to a normal to the principal surface of the second alignment film 170 and their bottom in the +x direction faces forward.

In the first alignment film 130, the first alignment region OR1 has been subjected to an alignment treatment in a first alignment treatment direction PD1, while the second alignment region OR2 has been subjected to an alignment treatment in a second alignment treatment direction PD2, which is different from the first alignment treatment direction PD1. In this case, the first alignment treatment direction PD1 is substantially antiparallel to the second alignment treatment direction PD2. On the other hand, in the second alignment film 170, the third alignment region OR3 has been subjected to an alignment treatment in a third alignment treatment direction PD3, while the fourth alignment region OR4 has been subjected to an alignment treatment in a fourth alignment treatment direction PD4, which is different from the third alignment treatment direction PD3. In this case, the third alignment treatment direction PD3 is substantially antiparallel to the fourth alignment treatment direction PD4.

As shown in FIG. 14(c), domain lines DL1, DL2, DL3 and DL4 are produced in the liquid crystal domains A, B, C and D parallel to the edge portions EG1, EG2, EG3 and EG4, respectively. In this case, the domain lines DL1, DL2, DL3 and DL4 and the disclination lines CL1 are continuous with each other, thus producing dark lines in an inverted swastika shape. The azimuthal angles of the liquid crystal domains A, B, C and D may be 225, 315, 45 and 135 degrees, respectively. Since the reference alignment azimuths are defined symmetrically in this manner, more uniform viewing angle characteristic is realized and the display quality is improved.

FIG. 15(a) indicates the alignment directions of liquid crystal molecules in a situation where the subpixel electrode 121 has no notches, while FIG. 15(b) indicates the alignment directions of liquid crystal molecules in a situation where the subpixel electrode 121 has notches 122. In FIG. 15(b), only two notches 122 are shown to avoid complicating the drawing excessively. In FIG. 15, the liquid crystal molecules are illustrated as elliptical ones and the front end of the liquid crystal molecules is illustrated as a circle.

As can be seen easily by comparing FIGS. 15(a) and 15(b) to each other, the liquid crystal molecules 182 located in the vicinity of each notch 122 are aligned substantially perpendicularly to the edges of the notch 122 under the oblique electric field. To those liquid crystal molecules 182, an alignment control force is applied in the same direction as the liquid crystal molecules 182 at the center of liquid crystal domain upon the application of a voltage. That is why even if the dark lines have shifted, it will take a shorter amount of time to move the dark lines back to their original positions using that alignment control force.

Now, look at FIG. 13(b) again. The notches 122a2 to 122a5, 122b1, 122b2, 122b4 and 122b5 of the subpixel electrodes 121a and 121b are arranged so that the azimuthal component of the liquid crystal molecules 182 becomes substantially parallel to the reference alignment azimuths of their associated liquid crystal domains A through D under the oblique electric field. That is why these notches 122a2 to 122a5, 122b1, 122b2, 122b4 and 122b5 will help the liquid crystal molecules recover from their disturbed alignment. Also, as the notches 122a1 and 122b3 of the subpixel electrodes 121a and 121b are arranged at the intersections between the storage capacitor line CS and the source line S, the leakage current generated at the intersections between the storage capacitor line CS and the source line S can be repaired easily. Furthermore, the CS branch line is arranged so as to overlap with portions of the subpixel electrodes 121a and 121b that form the liquid crystal domains A and C and to cross the source line S.

FIG. 13(c) illustrates a black matrix BM that is provided for the counter substrate. The black matrix BM is arranged so as to cover the source lines S, the CS branch lines, TFT-A and TFT-B, and runs in an indented shape in the column direction when viewed along a normal to the principal surface. The black matrix BM is arranged so as to cover the domain lines DL1 and DL3 to be produced in the column direction (i.e., y direction).

Now the display contributing areas of the liquid crystal domains A and B, i.e., the areas of respective portions of the subpixel electrodes 121a and 121b that are associated with the liquid crystal domains A and B and that are not covered with the black matrix BM, will be compared to each other. To the viewer's eye, a portion of the black matrix BM associated with the liquid crystal domain A protrudes into the liquid crystal domain A so as to cover not only the domain line DL1 produced in the liquid crystal domain A but also the CS branch line. In the liquid crystal domain B, however, a domain line DL2 is produced and not covered with the black matrix BM. That is why the display contributing areas of the liquid crystal domains A and B are substantially equal to each other. For a similar reason, the display contributing areas of the liquid crystal domains C and D are also almost equal to each other. Consequently, the display contributing areas of the liquid crystal domains A through D are all approximately equal to each other. As the black matrix BM has such an indented shape as viewed along a normal to the principal surface of the liquid crystal display device 100B as described above, the display characteristics of the respective liquid crystal domains can be more uniform.

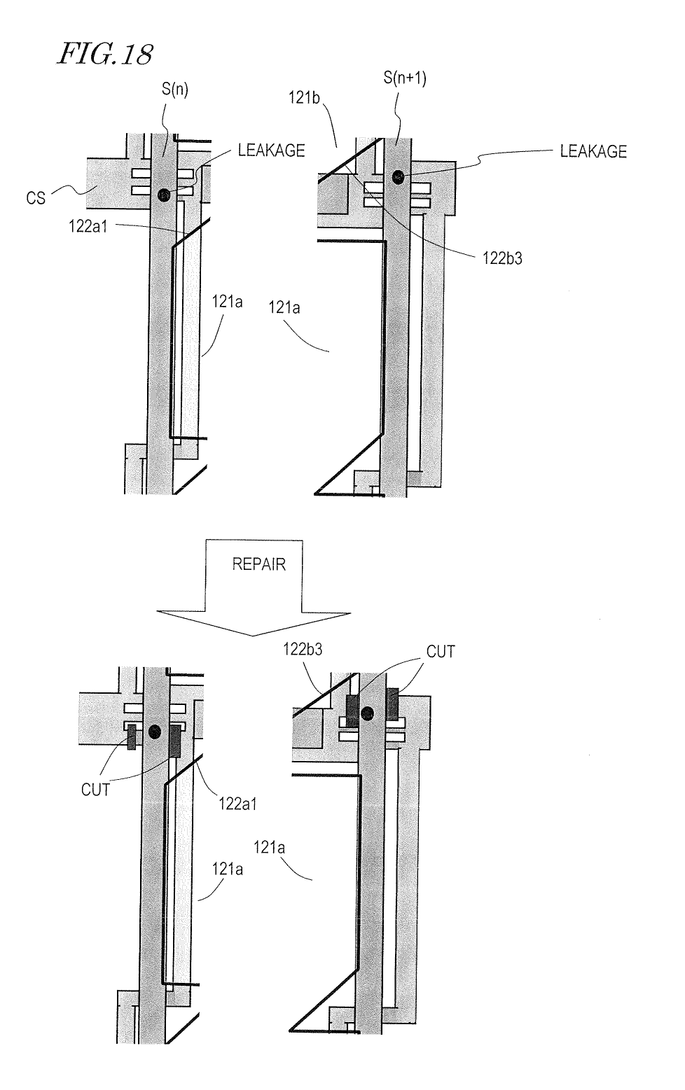

Hereinafter, it will be described with reference to FIGS. 16 through 20 what are causes for defects and how to repair the defects.

As shown in FIG. 16, if leakage current has been generated between the drain electrode of TFT-A or TFT-B and either the gate line G(m) or the source line S(n), a gate signal voltage or a source signal voltage is applied to the subpixel electrode 121a or 121b when the subpixel in question is not selected. In this case, if the voltage applied to the liquid crystal capacitor Clca or Clcb (see FIG. 2) is higher than what is supposed to be, then the subpixel SP-A or SP-B will be a bright spot. In such a situation, a portion of the drain extension line 127a or 127b associated with the notch 122a3 or 122b5 of the subpixel electrode 121a or 121b is cut off. Also, respective overlapping portions of the subpixel electrode 121a or 121b, the drain extension line 127a or 127b and the CS trunk line are also irradiated with a laser beam and melted, thereby connecting together the subpixel electrode 121a or 121b, the drain extension line 127a or 127b and the CS trunk line. As described above, a CS signal voltage applied to the storage capacitor line CS is close to a counter voltage applied to the counter electrode. That is why the subpixel SP-A or SP-B will display black. Consequently, the decline in display quality can be minimized.

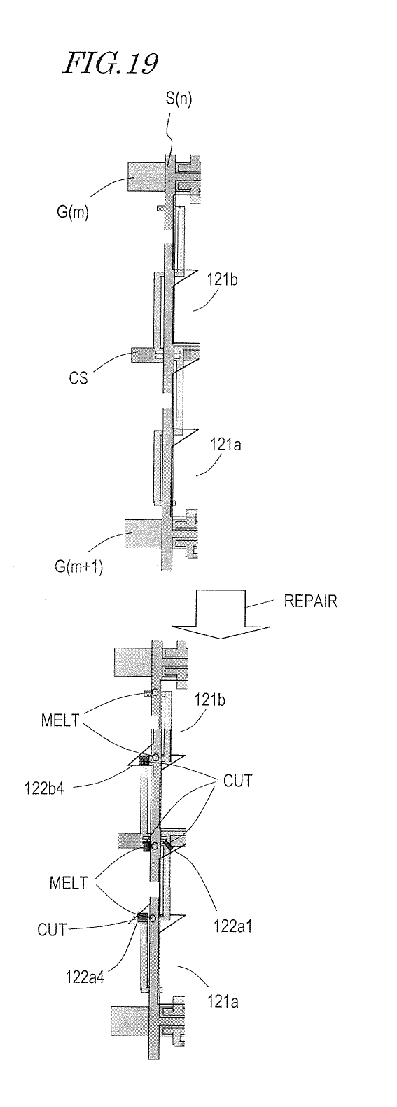

As shown in FIG. 17, if leakage current were generated between the source line S(n) and a CS branch line, then the potentials of the source signal and the CS signal would shift, and an appropriate voltage could not be applied anymore and the display quality would be debased. In that case, a portion between the leaking portion of the CS branch line and the CS trunk line is irradiated with a laser beam and cut off, thereby isolating the leaking portion from the CS trunk line. As a result, a desired CS signal voltage and a desired source signal voltage are applied to the CS trunk line and the source line S(n), respectively.

Or if leakage current were generated between the storage capacitor line CS, the source line S(n), and the subpixel electrode 121a, 121b, then a portion between the leaking portion of the CS branch line and the CS trunk line is irradiated with a laser beam and cut off, thereby isolating the leaking portion from the CS trunk line. Optionally, trimming may also be done to isolate the leaking portion of the subpixel electrode from the rest of the subpixel electrode. As a result, a desired CS signal voltage and a desired source signal voltage are applied to the CS trunk line and the source line S(n), respectively. When such trimming is done, the laser beam is focused on ITO that is the material of the pixel electrode and irradiates that ITO through the front side of the active-matrix substrate, thereby subliming and removing that material.

As shown in FIG. 18, if leakage current were generated between a fine line of the CS trunk line and a source line S(n) or S(n+1), then the potentials of the source signal and the CS signal would shift, and an appropriate voltage could not be applied anymore and the display quality would be debased. In that case, a portion of the storage capacitor line CS could be irradiated with a laser beam and cut off, thereby isolating the leaking portion from the storage capacitor line CS. Specifically, several fine lines of the CS trunk line, including the one with the leakage current, could be irradiated with a laser beam and cut off, thereby isolating the leaking portions from the CS trunk line. In this case, the CS trunk line can still be kept connected using the other fine lines that have not been cut off. On top of that, the notches 122a1 and 122b3 of the subpixel electrodes 121a and 121b are provided for the intersecting portions between the CS trunk line and the source line S. Consequently, the fine lines of the CS trunk line can be easily cut off without cutting the subpixel electrode 121a or 121b.

As shown in FIG. 19, the CS branch line includes an intersecting portion that intersects with the source line S(n) and a parallel portion that runs substantially parallel to the source line S(n). If the source line S(n) were disconnected, at least the CS branch line, among the CS branch line and the CS trunk line, would be irradiated with a laser beam, cut off and isolated from the CS trunk line, thereby forming a CS isolated line. Also, two portions of the source line S(n) that interpose the disconnected portion between them and that overlap with the CS isolated line would also be irradiated with a laser beam and melted, thereby connecting the CS isolated line and the source line S(n) together. As a result, the source signal could be supplied appropriately using the CS isolated line as a bypass.

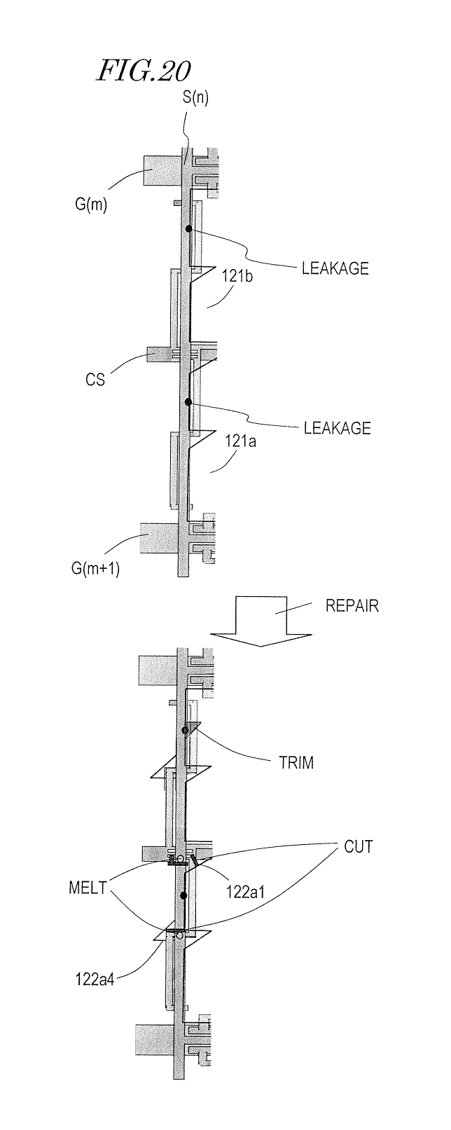

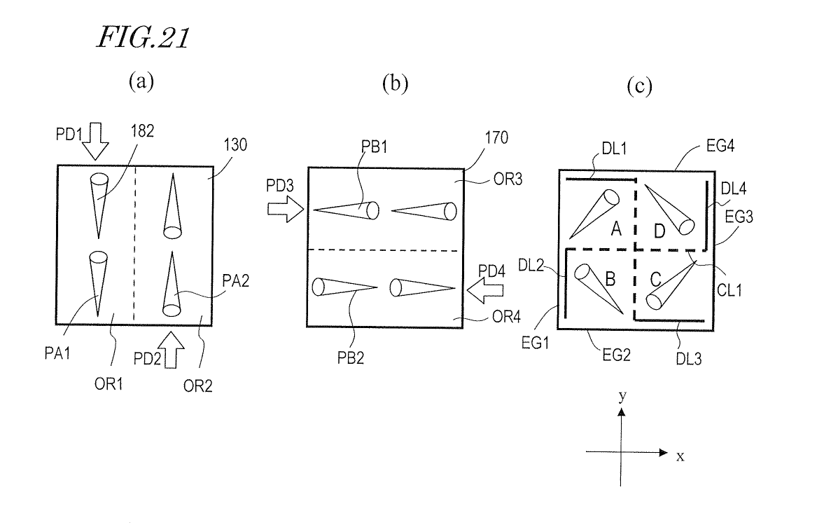

If leakage current were generated between the subpixel electrode 121a, 121b and the source line S(n) as shown in FIG. 20, the source signal voltage would also be applied to the subpixel electrode 121a, 121b even when the subpixel is not selected. As a result, the display quality would be debased. In that case, two portions of the source line S(n) that interpose the leaking portion between them could be irradiated with a laser beam and cut off. And among the CS branch line and the CS trunk line, at least the CS branch line would be irradiated with a laser beam, cut off and isolated from the CS trunk line to form a CS isolated line. Also, two portions, which interpose the above two portions of the source line S(n) and in which the CS isolated line and the source line S(n) overlap with each other, could be irradiated with a laser beam and melted, thereby connecting the CS isolated line and the source line S(n) together. By isolating the leaking portion from the source line S(n) and using the CS isolated line as a bypass; the source signal can be supplied just as intended and deterioration in display quality can be minimized. Alternatively, a portion of the subpixel electrode 121a, 121b surrounding the leaking portion may be irradiated with a laser beam to isolate the leaking portion of the subpixel electrode 121a, 121b from the rest.

As described above, as for the subpixel SP-A, the notch 122a3 of the subpixel electrode 121a is provided for the drain extension line 127a, and therefore, the defect can be repaired easily as shown in FIG. 16. Meanwhile, the notch 122a5 of the subpixel electrode 121a is provided for the drain extension line 127a, and therefore, the defect can also be repaired easily. Also, the notch 122a1 of the subpixel electrode 121a is provided for the CS trunk line and the CS branch line, and therefore, the defect can be repaired easily as shown in FIGS. 17, 18, 19 and 20. Furthermore, the notch 122a4 of the subpixel electrode 121a is provided for the CS branch line, and therefore, the defect can also be repaired easily as shown in FIGS. 19 and 20. And the notch 122a2 of the subpixel electrode 121a is provided for the CS branch line, and therefore, the defect can also be repaired easily.

As for the subpixel SP-B, on the other hand, the notch 122b5 of the subpixel electrode 121b is provided for the drain extension line 127b, and therefore, the defect can be repaired easily as shown in FIG. 16. Meanwhile, the notch 122b2 of the subpixel electrode 121b is provided for the drain extension line 127b, and therefore, the defect can also be repaired easily. Also, the notch 122b1 of the subpixel electrode 121b is provided for the CS branch line, and therefore, the defect can be repaired easily as shown in FIG. 17. Furthermore, the notch 122b3 of the subpixel electrode 121b is provided for the CS branch line and the CS trunk line, and therefore, the defect can also be repaired easily as shown in FIG. 18. And the notch 122b4 of the subpixel electrode 121b is provided for the CS branch line, and therefore, the defect can also be repaired easily as shown in FIG. 19.

Hereinafter, it will be described with reference to FIGS. 13 to 15 how in the liquid crystal display device 100B of this embodiment, the oblique electric field generated around the notches 122a1 to 122a5 and 122b1 to 122b5 of the pixel electrodes 121a and 121b will affect the azimuthal component of the alignment direction of the liquid crystal molecules 182 and the reference alignment azimuths of their associated liquid crystal domains.

In the liquid crystal domains A, B, C and D of the subpixel SP-A, the oblique electric field generated by the notches 122a5, 122a2, 122a3 and 122a4 of the subpixel electrode 121a and the counter electrode 160 upon the application of a voltage induces alignment of the liquid crystal molecules 182, located in a region of the liquid crystal layer 180 associated with those notches 122a5, 122a2, 122a3 and 122a4 of the subpixel electrode 121a. And the azimuthal component of the alignment direction of those liquid crystal molecules 182, of which the director points from the active-matrix substrate toward the counter substrate, becomes substantially parallel to the reference alignment azimuths of the liquid crystal domains A, B, C and D. Consequently, no dark lines are produced.

On the other hand, in the liquid crystal domains A, B, C and D of the subpixel SP-B, the oblique electric field generated by the notches 122b5, 122b1, 122b2 and 122b4 of the subpixel electrode 121b and the counter electrode 160 upon the application of a voltage induces alignment of the liquid crystal molecules 182, located in a region of the liquid crystal layer 180 associated with those notches 122b5, 122b1, 122b2 and 122b4 of the subpixel electrode 121b. And the azimuthal component of the alignment direction of those liquid crystal molecules 182, of which the director points from the active-matrix substrate toward the counter substrate, becomes substantially parallel to the reference alignment azimuths of the liquid crystal domains A, B, C and D. Consequently, no dark lines are produced.

In the embodiments described above, the dark lines are supposed to be produced in the inverted swastika shape. However, the present invention is not limited to it and the dark lines may also be produced in a swastika shape. As shown in FIG. 21, the first and second alignment treatment directions PD1 and PD2 of the first and second alignment regions OR1 and OR2 of the first alignment film 130 may be −y and +y directions, respectively. On the other hand, the third and fourth alignment treatment directions PD3 and PD4 of the third and fourth alignment regions OR3 and OR4 of the second alignment film 170 may be +x and −x directions, respectively. In that case, domain lines DL1, DL2, DL3 and DL4 will be produced parallel to the edge portions EG4, EG1, EG2 and EG3 in the liquid crystal domains A, B, C and D, respectively. These domain lines DL1, DL2, DL3 and DL4 and the disclination line CL1 are continuous with each other, and therefore, the dark lines, including those domain lines DL1, DL2, DL3 and DL4 and the disclination line CL1, are produced in a swastika shape.

### Embodiment 3

Hereinafter, a third embodiment of a liquid crystal display device according to the present invention will be described.

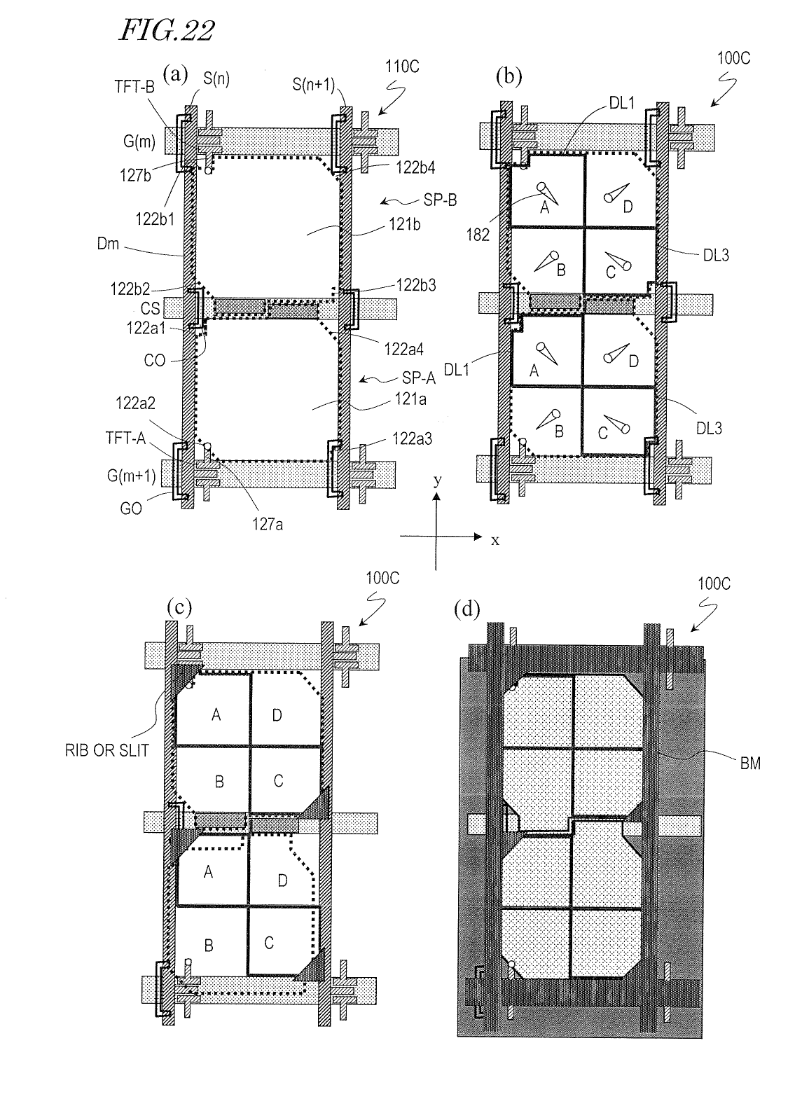

FIG. 22(a) is a schematic plan view illustrating the configuration of the active-matrix substrate 110C of a liquid crystal display device 100C as a third embodiment of the present invention. FIG. 22(b) is a schematic plan view illustrating how dark lines are produced in the liquid crystal display device 100C of this embodiment. And FIGS. 22(c) and 22(d) are schematic plan views of the liquid crystal display device 100C. Specifically, FIG. 22(c) indicates where dark lines are produced and where ribs or slits (openings) are arranged in the liquid crystal display device 100C, while FIG. 22(d) illustrates the pattern of the black matrix BM.

The liquid crystal display device 100C of this embodiment has a similar structure to the liquid crystal display devices 100A and 100B described above, and the overlapping description thereof will be omitted herein. In this liquid crystal display device 100C, the dark lines are produced in the “8” shape as in the liquid crystal display device 100A but unlike the liquid crystal display device 100B.

In FIG. 22(a), illustrated are the second subpixel SP-B of a pixel on the m^{th} row and the first subpixel SP-A of a pixel on the (m+1)^{th} row. The first and second subpixels SP-A and SP-B are defined by subpixel electrodes 121a and 121b, respectively.

A storage capacitor line CS runs in the row direction (i.e., in the x direction). On the other hand, an additional line Dm runs in the column direction (i.e., in the y direction) so as to cross the storage capacitor line CS at right angles, but is not connected to the storage capacitor line CS. But the additional line Dm is arranged so as to overlap with the source line S. It should be noted that the additional line Dm is formed in the same process step, and made of the same material, as the storage capacitor line CS. Also, the additional line Dm is formed in the same process step as the gate line G and the storage capacitor line CS and forms part of the gate metal.

A gate overlap line GO is arranged between the subpixel electrodes 121a and 121b of two pixels that are adjacent to each other in the column direction, and intersects with the storage capacitor line CS and overlaps with the source line S at two points.

On the other hand, a CS overlap line CO is arranged between the subpixel electrodes 121a and 121b of the same pixel so as to face TFT-A and TFT-B of the same pixel with respect to the source line S. Also, the CS overlap line CO intersects with the gate line G and overlaps with the source line S at two points. The gate overlap line GO and the CS overlap line CO are formed in the same process step as the subpixel electrodes 121a and 121b and may be made of a transparent conductive material, for example. Each of the subpixel electrodes 121a and 121b partially overlaps with the storage capacitor line CS, thus forming storage capacitors Ccsa and Ccsb.

The subpixel electrode 121a has notches 122a1 to 122a4, while the subpixel electrode 121b has notches 122b1 to 122b4. These notches 122a1 to 122a4 and 122b1 to 122b4 are arranged at the respective corners of the subpixel electrodes 121a and 121b. And each of these notches 122a1 to 122a4 and 122b1 to 122b4 is located between two sides of its associated subpixel electrode 121a or 121b that run in the column and row directions, respectively. Specifically, the notches 122a2, 122a4, 122b2 and 122b4 of the subpixel electrodes 121a and 121b intersect with the x- and y-axes. On the other hand, the other notches 122a1, 122a3, 122b1 and 122b3 of the subpixel electrodes 121a and 121b have a rectangular shape, of which the sides run along the x- and y-axes.

Drain extension lines 127a and 127b are provided the notches 122a2 and 122b1 of the pixel electrodes 121a and 121b, respectively. And respective parts of the drain extension lines 127a and 127b are not covered but exposed through the subpixel electrodes 121a and 121b by those notches 122a2 and 122b1. The CS overlap line CO is provided for the notches 122a1 and 122b2. And the gate overlap line GO is provided for the notches 122a3 and 122b4.

In this active-matrix substrate 110C, the notches 122a2, 122a3, 122b1 and 122b4 of the subpixel electrodes 121a and 121b extend the distances from the intersecting portions between the gate lines G and the source line S to the subpixel electrodes 121a, 121b. Likewise, the notches 122a1, 122a4, 122b2 and 122b3 of the subpixel electrodes 121a and 121b extend the distances from the intersecting portions between the storage capacitor lines CS and the source line S to the subpixel electrodes 121a, 121b. As a result, even if leakage current were generated at those intersections between the source line S and the gate line G or the storage capacitor line CS, the defect could be repaired easily.

In this active-matrix substrate 110C, the drain extension lines 127a and 127b that are connected to the subpixel electrodes 121a and 121b overlap with the storage capacitor line CS, thereby forming storage capacitors there. Each of these storage capacitors is formed by the pixel electrode 121, the passivation film 116, the insulating film 114 and the gate metal (i.e., the storage capacitor line CS). That is why the drain extension lines 127a and 127b do not cross the subpixel electrodes 121a and 121b. The drain extension lines 127a and 127b of the active-matrix substrate 110C are shorter than their counterparts of the active-matrix substrate 110A or 110B.

FIG. 22(b) indicates the alignment directions of liquid crystal molecules around the respective centers of the liquid crystal domains. The reference alignment azimuths of the liquid crystal domains A, B, C and D may be 135, 45, 315 and 225 degrees, respectively. As a result, more uniform viewing angle characteristic is realized. Also, the display contributing areas of the respective liquid crystal domains are equal to each other.

In this liquid crystal display device 100C, the subpixel electrodes 121a and 121b are not designed so as to protrude outward and cover the domain lines. Instead, in this liquid crystal display device 100C, the gate line G, the storage capacitor line CS and the source line S are arranged so as to cover the domain lines DL1 and DL3.

As shown in FIG. 22(c), ribs or slits are provided for the counter electrode 160 so as to face the notches 122a1, 122a3, 122b1 and 122b3 of the subpixel electrodes 121a and 121b. If ribs are provided for the counter electrode 160, the liquid crystal molecules 182 in the vicinity of the ribs are aligned perpendicularly to the surface of the ribs. That is why if the ribs are arranged on the counter electrode 160 so that a normal to the surface of the ribs is substantially parallel to the reference alignment direction of their associated liquid crystal domain, then the azimuthal component of the liquid crystal molecules 182 becomes almost parallel to the reference alignment azimuth of their associated liquid crystal domain. As a result, the decrease in optical transmittance can be minimized.

On the other hand, if slits are provided for the counter electrode 160, the liquid crystal molecules 182 are aligned substantially perpendicularly to the alignment films 130 and 170 by the notches 122a1, 122a3, 122b1 and 122b3 of the subpixel electrodes 121a and 121b and the slits of the counter electrode 160, which prevent the liquid crystal molecules from having their alignment direction disturbed.

FIG. 22(d) illustrates a black matrix BM that is provided for the counter substrate 160. The black matrix BM is arranged so as to cover the gate line G that runs straight in the row direction and the source line S that runs straight in the column direction. In this liquid crystal display device 100C, the black matrix BM is provided for the notches 122a1, 122a3, 122b1 and 122b3 of the subpixel electrodes 121a and 121b. Also, if ribs or slits are provided for the counter electrode 160, the black matrix BM is arranged to overlap with those ribs or slits. Furthermore, the black matrix BM is arranged to make display contributing areas more uniform between the respective liquid crystal domains.

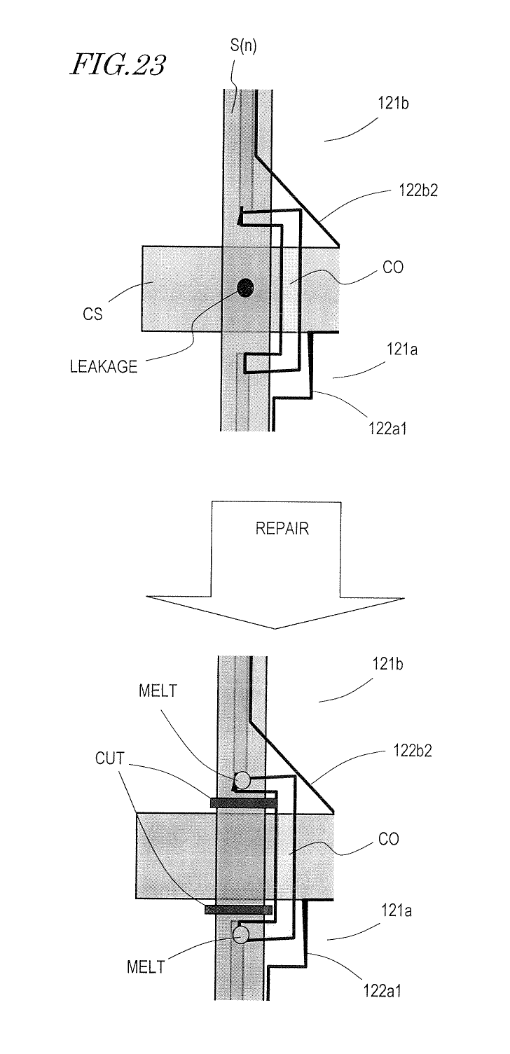

Hereinafter, it will be described with reference to FIGS. 23 through 28 what are causes for defects and how to repair the defects.

As shown in FIG. 23, if leakage current were generated between the storage capacitor line CS and the source line S(n), then the potentials of the CS signal and the source signal would shift, and an appropriate voltage could not be applied anymore and the display quality would be debased. In that case, two potions which interpose between two portions of the source line S(n) overlapping with the CS overlap line CO, and the region of the source line S(n) overlapping with the storage capacitor line CS, should be irradiated with a laser beam and cut off. Meanwhile, two portions of the CS overlap line CO, which overlap with the source line S(n), should be irradiated with a laser beam and melted, thereby connecting the source line S(n) and the CS overlap line CO together. As a result, the leaking portion is isolated from the source line S(n) and a source signal is supplied through the CS overlap line CO.

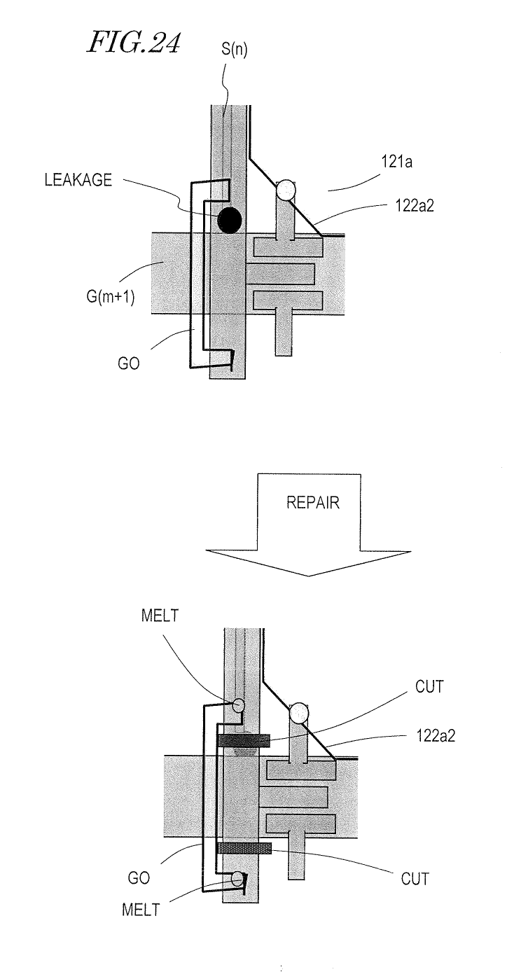

As shown in FIG. 24, if leakage current were generated between the gate line G(m+1) and the source line S(n), then the potentials of the gate signal and the source signal would shift, and the display quality would be debased. In that case, two potions which interpose between two portions of the source line S(n) overlapping with the gate overlap line GO, and the region of the source line S(n) overlapping with the gate line G(m+1), should be irradiated with a laser beam and cut off. Meanwhile, two portions of the gate overlap line GO, which overlap with the source line S(n), should be irradiated with a laser beam and melted, thereby connecting the source line S(n) and the gate overlap line GO together. As a result, the leaking portion is isolated from the source line S(n) and a source signal is supplied through the gate overlap line GO.

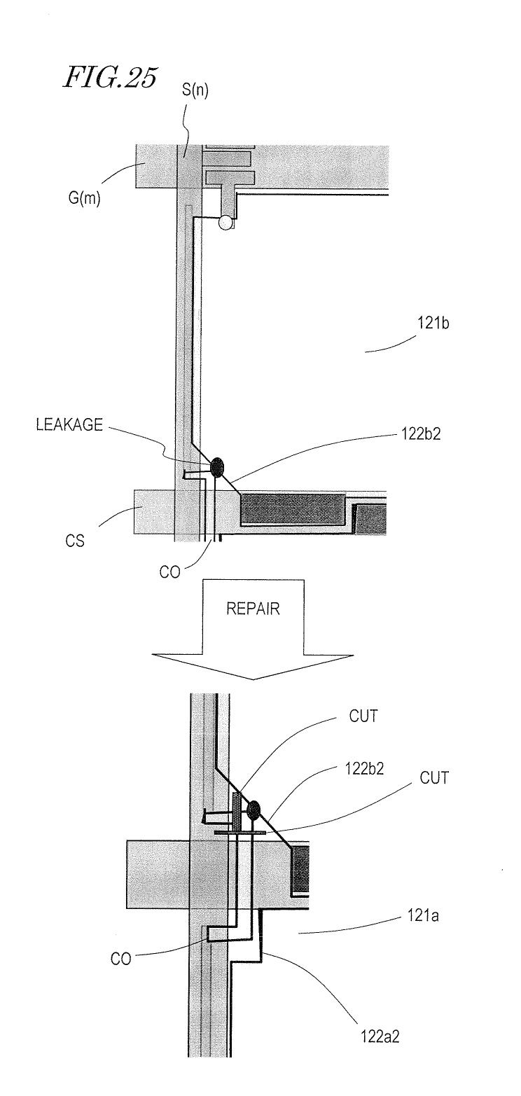

As shown in FIG. 25, if leakage current were generated between the subpixel electrode 121b and the CS overlap line CO, then the display contributing area of the liquid crystal domains associated with the subpixel electrode 121b would vary so much that the display quality would be debased. In that case, the CS overlap line CO should be irradiated with a laser beam and cut off. Likewise, if leakage current were generated between the subpixel electrode 121a and the CS overlap line CO, then the CS overlap line CO should also be irradiated with a laser beam and cut off. Furthermore, if leakage current were generated between the subpixel electrodes 121a, 121b and the gate overlap line GO, then the gate overlap line GO should also be irradiated with a laser beam and cut off.

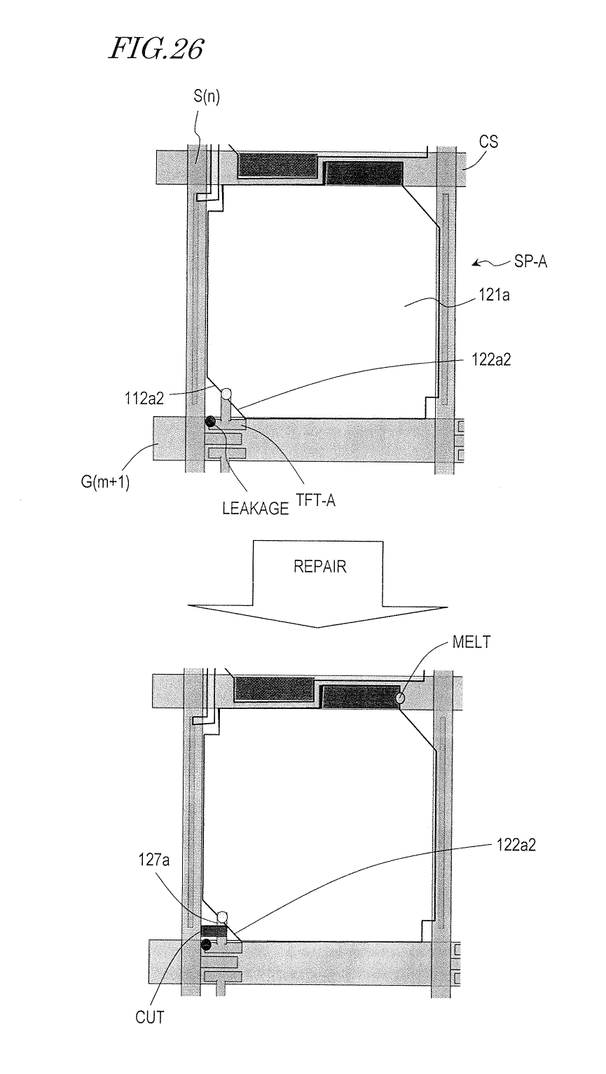

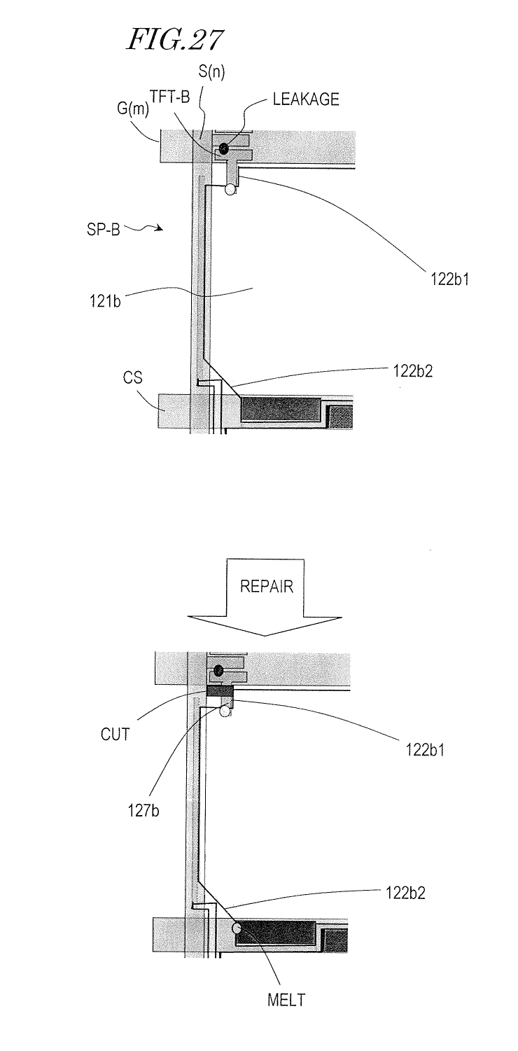

As shown in FIG. 26, if leakage current were generated between the drain electrode of TFT-A and the source line S(n), then a gate signal or a source signal would be supplied to the subpixel electrode 121a and the display quality would be debased. In that case, portions of the drain extension line 127a associated with the notch 122a2 of the subpixel electrode 121a should be irradiated with a laser beam and cut off. Although the gate electrode of TFT-A is arranged so as to overlap with the gate line G, the notch 122a2 of the subpixel electrode 121a is provided for the drain extension line 127a. That is why a portion of the drain extension line 127a that is not overlapped with the subpixel electrode 121a could be cut off easily.

Also, a portion of the storage capacitor line CS that overlaps with the subpixel electrode 121a is irradiated with a laser beam and melted, thereby connecting the subpixel electrode 121a and the storage capacitor line CS together. As a result, the subpixel electrode 121a is connected to the storage capacitor line CS and its potential decreases, and the subpixel SP-A will display black. It should be noted that if a pixel with a defect displayed white, then the display quality would be debased significantly because white is easily sensible for a viewer. If such a defective pixel displayed black, however, the decline in display quality should be minimized.

As shown in FIG. 27, if leakage current were generated between the drain electrode of TFT-B and the gate line G(m), then a gate signal or a source signal would be supplied to the subpixel electrode 121b and the display quality would be debased. In that case, portions of the drain extension line 127b associated with the notch 122b1 of the subpixel electrode 121b should be irradiated with a laser beam and cut off. Although the gate electrode of TFT-B is arranged so as to overlap with the gate line G, the notch 122b1 of the subpixel electrode 121b is provided for the drain extension line 127b. That is why a portion of the drain extension line 127b that is not overlapped with the subpixel electrode 121b could be cut off easily.

Also, a portion of the storage capacitor line CS that overlaps with the subpixel electrode 121b is irradiated with a laser beam and melted, thereby connecting the subpixel electrode 121b and the storage capacitor line CS together. As a result, the subpixel electrode 121b is connected to the storage capacitor line CS and its potential decreases, and the subpixel SP-B will display black. It should be noted that if a pixel with a defect displayed white, then the display quality would be debased significantly because white is easily sensible for a viewer. If such a defective pixel displayed black, however, the decline in display quality should be minimized.

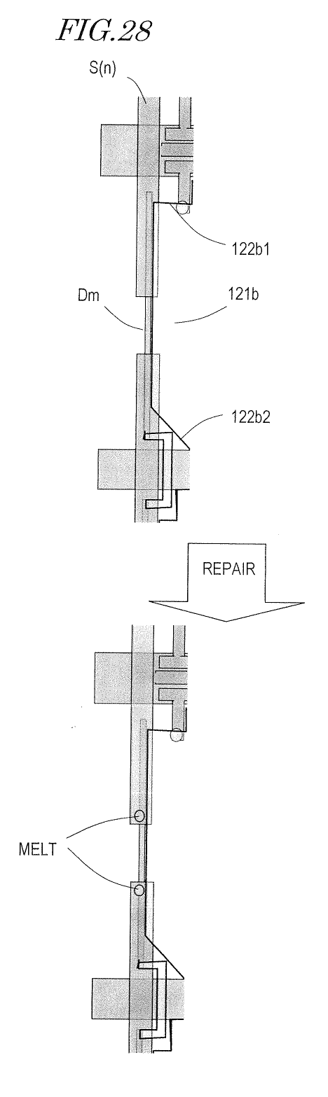

As shown in FIG. 28, the additional line Dm runs in the column direction (i.e., in the y direction) so as to overlap with the source line S(n). If the source line S(n) were disconnected, then two portions of the storage capacitor line CS, which interpose the disconnected portion between them, should be irradiated with a laser beam and melted. At those molten portions, the source line S(n) would be connected to the additional line Dm, and therefore, the disconnected source line S(n) would be connected through the additional line Dm. In this manner, the source signal could be supplied appropriately by using the additional line as a bypass.

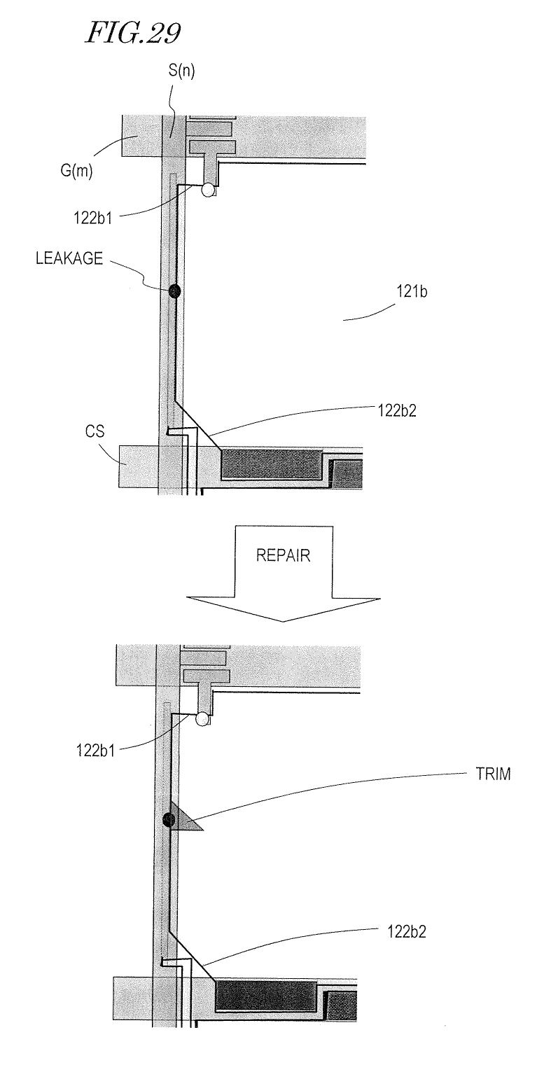

If leakage current were generated between the subpixel electrode 121b and the source line S(n) as shown in FIG. 29, the source signal would also be supplied to the subpixel electrode 121b even when the subpixel is not selected. As a result, the display quality would be debased. In that case, a portion of the subpixel electrode 121b that surrounds its leaking portion could be irradiated with a laser beam, thereby isolating the leaking portion of the subpixel electrode 121b from the rest. Although not shown, if leakage current were generated between the subpixel electrode 121a and the source line S(n), a portion of the subpixel electrode 121a that surrounds its leaking portion could be irradiated with a laser beam so that the leaking portion of the subpixel electrode 121a would be isolated from the rest.

As described above, the notch 122b2 of the subpixel electrode 121b is provided for the CS overlap line CO and the storage capacitor line CS and the defect can be repaired easily as shown in FIGS. 23 and 25. Likewise, the notch 122a1 of the subpixel electrode 121a is provided for the CS overlap line CO and the defect can be repaired easily. Also, the notch 122a3 of the subpixel electrode 121a is provided for the gate overlap line GO and the defect can be repaired easily. Furthermore, the notch 122b4 of the subpixel electrode 121b is provided for the gate overlap line GO and the defect can be repaired easily.

Also, the notch 122a2 of the subpixel electrode 121a is provided for the drain extension line 127a and the defect can be repaired easily as shown in FIG. 26. Furthermore, the notch 122b1 of the subpixel electrode 121b is provided for the drain extension line 127b and the defect can be repaired easily.

Hereinafter, it will be described with reference to FIG. 22 how in the liquid crystal display device 100C of this embodiment, the oblique electric field generated around the notches 122a1 to 122a4 and 122b1 to 122b4 of the pixel electrodes 121a and 121b will affect the azimuthal component of the alignment direction of the liquid crystal molecules 182 and the reference alignment azimuths of their associated liquid crystal domains.

In the liquid crystal domains B and D of the subpixel SP-A, the oblique electric field generated by the notches 122a2 and 122a4 of the subpixel electrode 121a and the counter electrode 160 upon the application of a voltage induces alignment of the liquid crystal molecules 182, located in regions of the liquid crystal layer 180 associated with the notches 122a2 and 122a4 of the subpixel electrode 121a. And the azimuthal component of the alignment direction of those liquid crystal molecules 182, of which the director points from the active-matrix substrate toward the counter substrate, becomes substantially parallel to the reference alignment azimuths of the liquid crystal domains B and D. As a result, no dark lines are produced. In the same way, in the liquid crystal domains B and D of the subpixel SP-B, the oblique electric field generated by the notches 122b2 and 122b4 of the subpixel electrode 121b and the counter electrode 160 upon the application of a voltage induces alignment of the liquid crystal molecules 182, located in regions of the liquid crystal layer 180 associated with the notches 122b2 and 122b4 of the subpixel electrode 121b. And the azimuthal component of the alignment direction of those liquid crystal molecules 182, of which the director points from the active-matrix substrate toward the counter substrate, becomes substantially parallel to the reference alignment azimuths of the liquid crystal domains B and D. As a result, no dark lines are produced, either.

### Embodiment 4

Hereinafter, a fourth embodiment of a liquid crystal display device according to the present invention will be described.

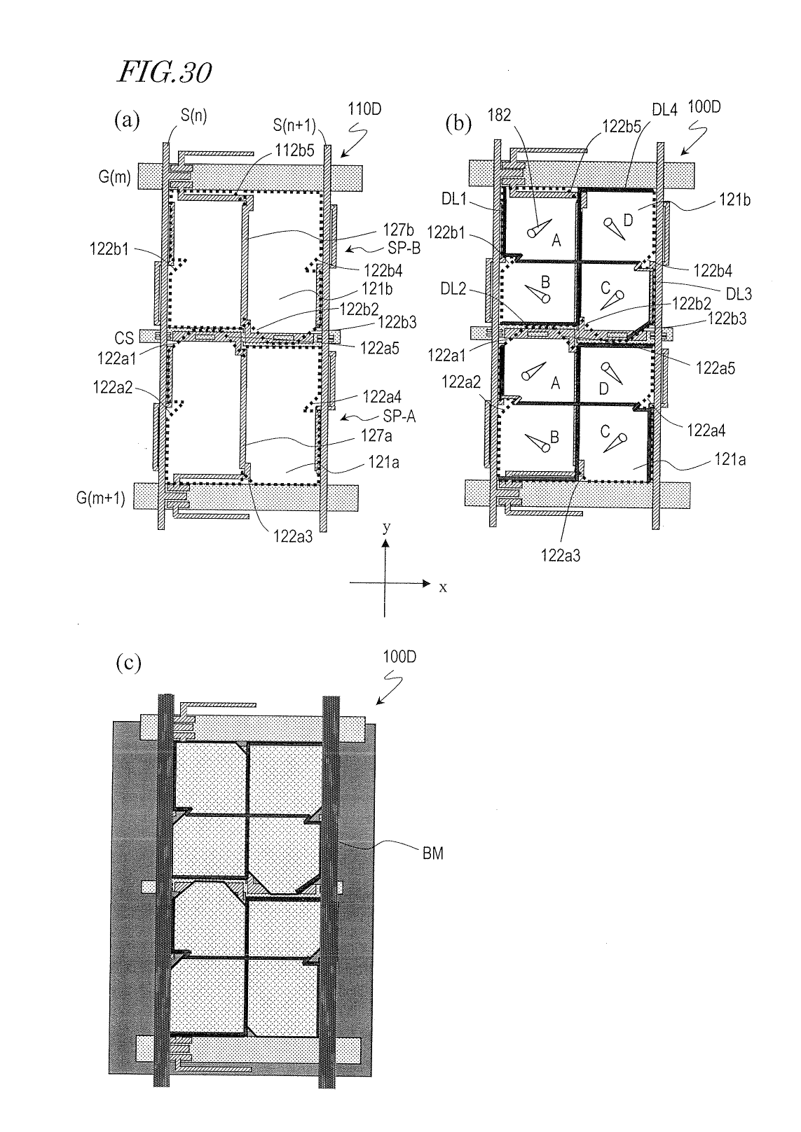

FIG. 30(a) is a schematic plan view illustrating the configuration of the active-matrix substrate 110D of a liquid crystal display device 100D as a fourth embodiment of the present invention. FIG. 30(b) is a schematic plan view illustrating how dark lines are produced in the liquid crystal display device 100D of this embodiment. And FIG. 30(c) is a schematic plan view of the liquid crystal display device 100D.

The liquid crystal display device 100D of this embodiment has a similar structure to the liquid crystal display devices 100A, 100B and 100C described above, and the overlapping description thereof will be omitted herein. In this liquid crystal display device 100D, the dark lines are produced in an inverted swastika shape as in the liquid crystal display device 100B but unlike the liquid crystal display devices 100A and 100C.

In FIG. 30(a), illustrated are the second subpixel SP-B of a pixel on the m^{th} row and the first subpixel SP-A of a pixel on the (m+1)^{th} row. The first and second subpixels SP-A and SP-B are defined by subpixel electrodes 121a and 121b, respectively.

The source line S includes a source trunk line that runs in the column direction (i.e., in the y direction) and a source redundant line that is connected to the source trunk line. The source redundant line includes two parallel portions that are substantially parallel to the source trunk line and two intersecting portions that intersect with the source trunk line. One of the two parallel portions is arranged in the −x direction with respect to the source trunk line, while the other parallel portion is arranged in the +x direction with respect to the source trunk line. Notches of each pixel electrode are provided for the source redundant line. On the other hand, the storage capacitor line CS runs in the row direction (i.e., x direction) and is subdivided into multiple fine lines so that there are openings where the storage capacitor line CS intersects with the source trunk line.

The drain extension line 127a is extended from the drain electrode of TFT-A through the storage capacitor line CS by way of the center of the subpixel electrode 121a in the row direction. Through a contact hole that has been cut through the intersection between the drain extension line 127a and the storage capacitor line CS, the drain extension line 127a is connected to the subpixel electrode 121a. In the same way, the drain extension line 127b is extended from the drain electrode of TFT-B through the storage capacitor line CS by way of the center of the subpixel electrode 121b in the row direction. Through a contact hole that has been cut through the intersection between the drain extension line 127b and the storage capacitor line CS, the drain extension line 127b is connected to the subpixel electrode 121b. Respective portions of the drain extension lines 127a and 127b that overlap with the storage capacitor line CS form storage capacitors Ccsa and Ccsb, respectively. Also, the subpixel electrodes 121a, 121b, the drain extension lines 127a, 127b and the storage capacitor line CS have mutually overlapping portions.

The subpixel electrode 121a has notches 122a1 through 122a5. Specifically, the notches 122a2 and 122a4 of the subpixel electrode 121a are provided for the source redundant line. The notches 122a3 and 122a5 are provided for the drain extension line 127a. Likewise, the subpixel electrode 121b has notches 122b1 through 122b5. Specifically, the notches 122b1 and 122b4 are provided for the source redundant line. The notches 122b2 and 122b5 are provided for the drain extension line 127b. Also, the distances from the intersecting portion between the source line S and the storage capacitor line CS to the subpixel electrodes 121a and 121b are increased by the notches 122a1 and 122b3 of the subpixel electrodes 121a and 121b.

Each of the notches 122a2 to 122a5, 122b1, 122b2, 122b4 and 122b5 of the subpixel electrodes 121a and 121b is provided for only one side that runs in either the row direction or the column direction, and has an edge that intersects substantially at right angles with the alignment direction of liquid crystal molecules at the center of its associated liquid crystal domain. On the other hand, each of the other notches 122a1 and 122b3 of the subpixel electrodes 121a and 121b is provided for two sides that run in the row and column directions, respectively.

FIG. 30(b) indicates the alignment directions of liquid crystal molecules around the center of the respective liquid crystal domains in the liquid crystal display device 100D and also shows the dark lines produced in the liquid crystal display device 100D. In this liquid crystal display device 100D, the dark lines are produced in an inverted swastika shape. The first and second alignment films 130 and 170 have been subjected to alignment treatment as already described with reference to FIGS. 4(a) and 4(b) and the overlapping description thereof will be omitted herein. The liquid crystal domains A, B, C and D have their reference alignment azimuths defined to be 225, 315, 45 and 135 degrees, respectively, thereby making the viewing angle characteristic more uniform. Also, the respective liquid crystal domains have substantially equal display contributing areas.

The notches 122a2 to 122a5, 122b1, 122b2, 122b4 and 122b5 of the subpixel electrodes 121a and 121b are arranged so that the azimuthal component of the liquid crystal molecules 182 becomes substantially parallel to the reference alignment azimuths of their associated liquid crystal domains under the oblique electric field. That is why these notches 122a2 to 122a5, 122b1, 122b2, 122b4 and 122b5 will help the liquid crystal molecules recover from their disturbed alignment. The parallel portions of the source redundant line are arranged so as to cover the domain lines DL1 to DL4 produced around the edges of the subpixel electrodes 121a and 121b and to overlap with the subpixel electrodes 121a and 121b.

FIG. 30(c) illustrates a black matrix BM provided for the counter substrate. The black matrix BM is arranged so as to cover the source trunk line and the source redundant line of the source line S. The black matrix BM runs linearly in the column direction, but not in the row direction.

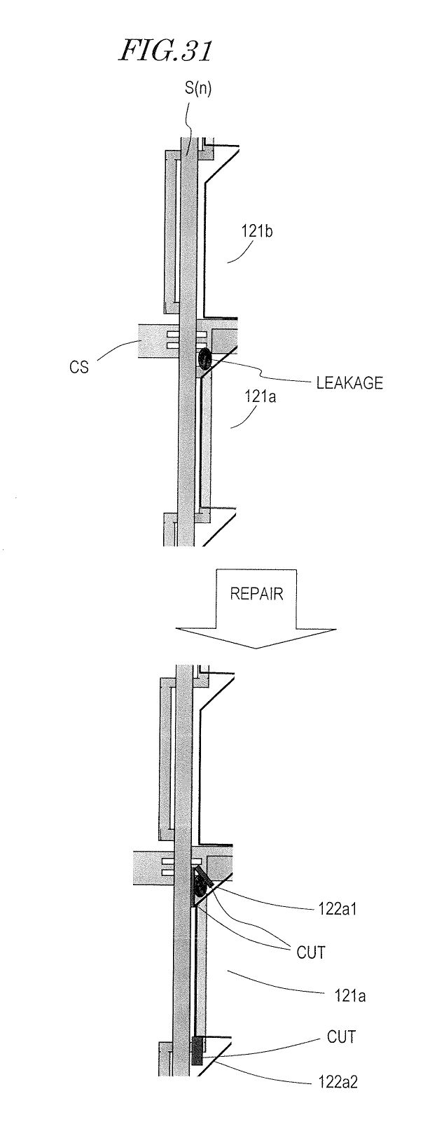

Hereinafter, it will be described with reference to FIGS. 31 through 35 what are causes for defects and how to repair the defects.

As shown in FIG. 31, if leakage current were generated between the storage capacitor line CS and the source redundant line, then the potentials of the CS signal and the source signal would shift, and an appropriate voltage could not be applied anymore and the display quality would be debased. In that case, the source redundant line should be irradiated with a laser beam and cut off, thereby isolating the leaking portion from the source trunk line. Specifically, two portions of the source redundant line, which interpose the leaking portion between them, should be cut off, thereby isolating the leaking portion of the source redundant line from the source trunk line. As a result, the leaking portion is isolated from the source trunk line and a desired source signal voltage is applied to the source trunk line. Also, by isolating a leaking portion from the storage capacitor line CS in the same way, a desired CS signal voltage is applied to the storage capacitor line CS.

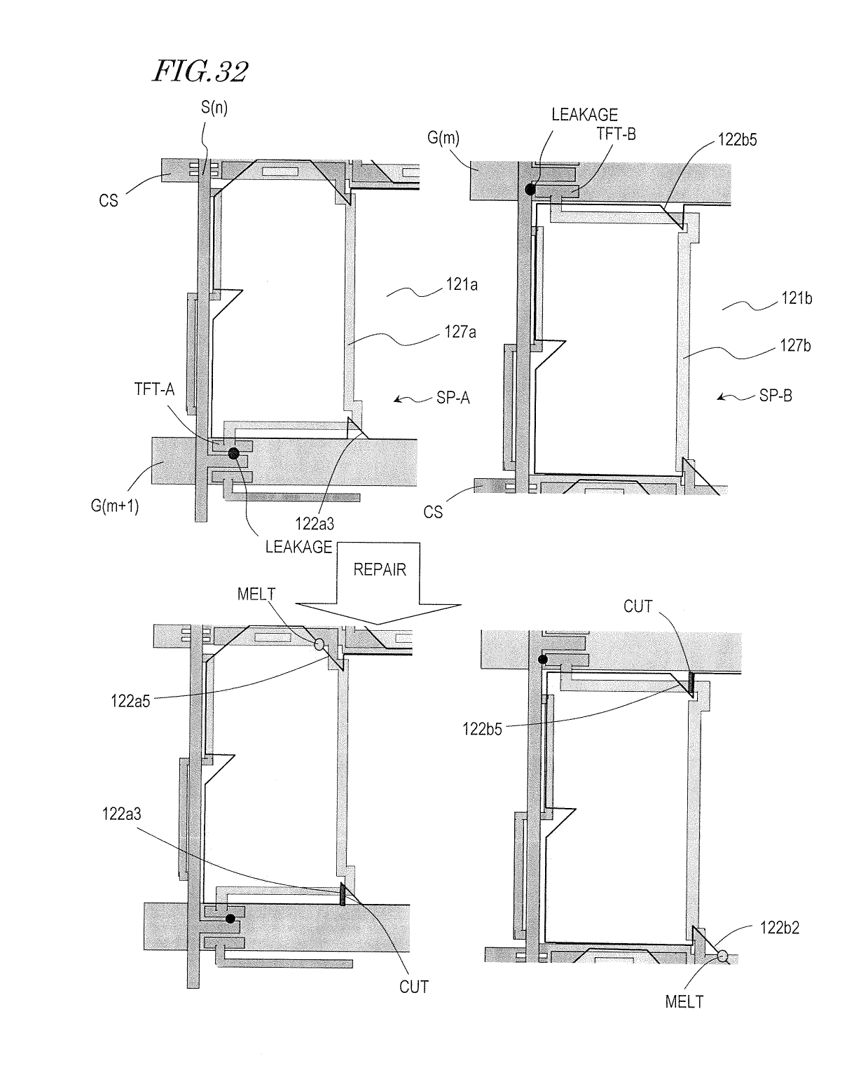

As shown in FIG. 32, if leakage current were generated between the drain electrode of TFT-A or TFT-B and either the gate line G(m) or the source line S(n), a gate signal or a source signal would be applied to the subpixel electrode 121a or 121b when the subpixel in question is not selected. In this case, a portion of the drain extension line 127a or 127b associated with the notch 122a3 or 122b5 of the subpixel electrode 121a or 121b could be cut off. Those notches 122a3 and 122b5 of the subpixel electrodes 121a and 121b are provided for the drain extension lines 127, and therefore, portions of the drain extension lines 127 associated with those notches 122a3 and 122b5 can be cut off easily.

Also, respective overlapping portions of the subpixel electrode 121a or 121b, the drain extension line 127a or 127b and the storage capacitor line CS could also be irradiated with a laser beam and melted, thereby connecting together the subpixel electrode 121a or 121b, the drain extension line 127a or 127b and the storage capacitor line CS. As a result, the subpixel electrode 121a or 121h would be connected to the storage capacitor line CS and the potential at the subpixel electrode 121a or 121b would be close to the potential at the counter electrode. That is why the subpixel SP-A or SP-B would display black. It should be noted that if a pixel with a defect displayed white, then the display quality would be debased significantly because white is easily sensible for a viewer. If such a defective pixel displayed black, however, the decline in display quality should be minimized.

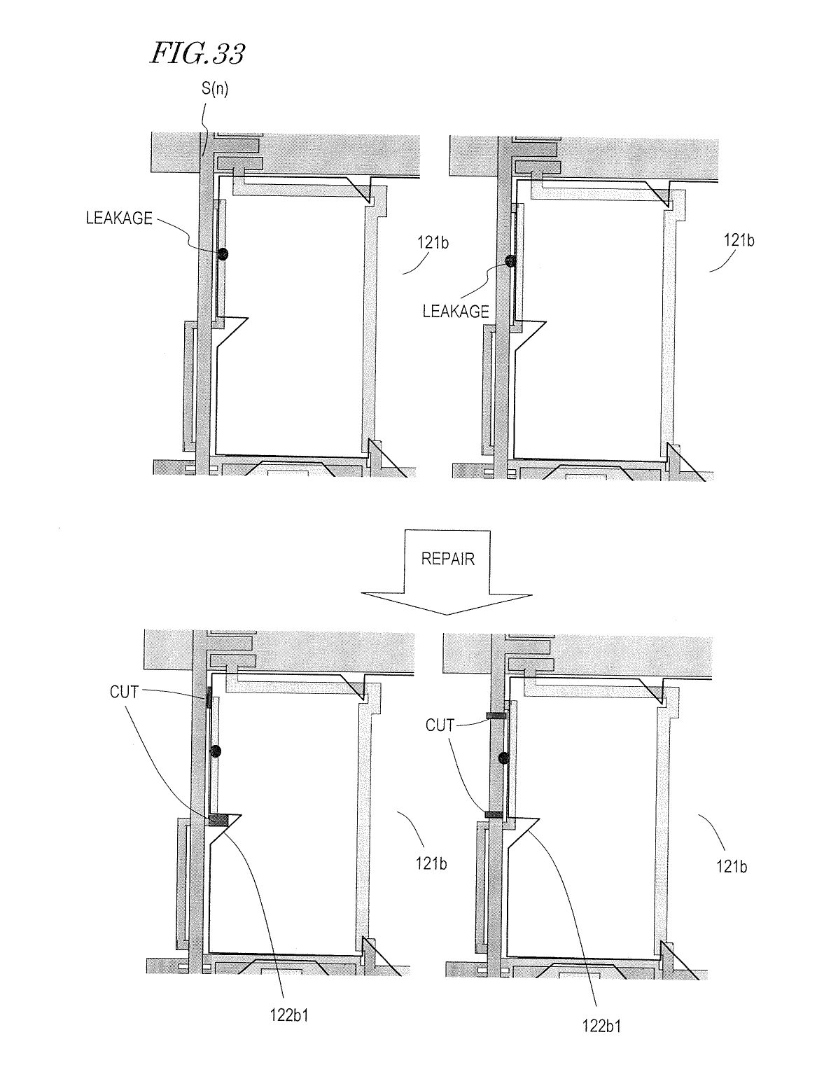

As shown in FIG. 33, if leakage current were generated between the subpixel electrode 121b and either the source trunk line or the source redundant line, a source signal would be applied to the subpixel electrode 121b when the subpixel in question is not selected and the display quality would be debased. In that case, a portion of the source line S(n), which is either the source trunk line or the source redundant line with the leakage current, could be cut off with a laser beam, thereby isolating one of the source trunk and redundant lines from the other. Also, if leakage current were generated between the subpixel electrode 121a and either the source trunk line or the source redundant line at the same time, a portion of the source line S, which is either the source trunk line or the source redundant line with the leakage current, could be cut off with a laser beam, thereby isolating one of the source trunk and redundant lines from the other. In this manner, the leaking portion of the source line S(n) could be isolated easily.

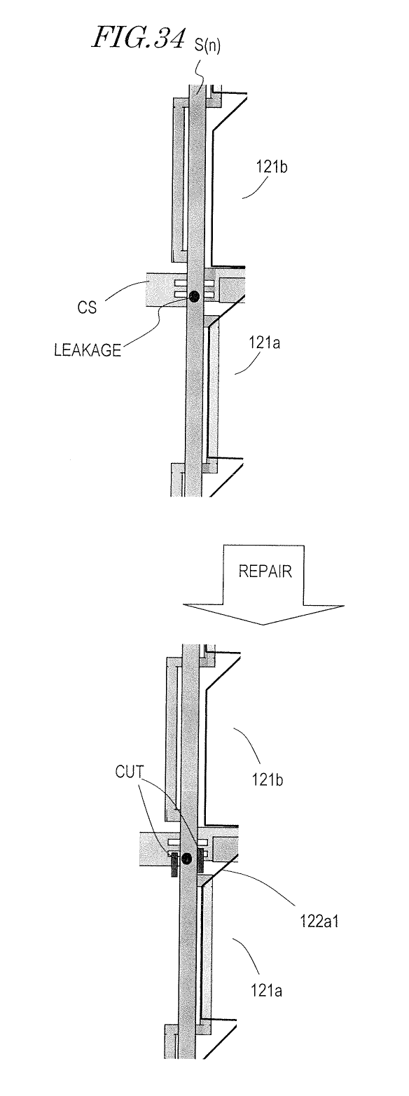

As shown in FIG. 34, if leakage current were generated between the storage capacitor line CS and the source line S(n), then the potentials of the source signal and the CS signal would shift, and an appropriate voltage could not be applied anymore and the display quality would be debased. In that case, a portion of the storage capacitor line CS could be irradiated with a laser beam and cut off, thereby isolating the leaking portion from the storage capacitor line CS. Specifically, several fine lines of the storage capacitor line, including the one with the leakage current, could be irradiated with a laser beam and cut off, thereby isolating the leaking portions from the storage capacitor line CS. As a result, the leaking portion of the storage capacitor line CS could be isolated and the storage capacitor line CS could still be kept connected using the other fine lines that have not been cut off. On top of that, the notches 122a1 and 122b3 of the subpixel electrodes 121a and 121b would increase the distance from the intersecting portions between the storage capacitor line CS and the source line S to the subpixel electrodes 121a and 121b. Consequently, the fine lines of the storage capacitor line CS could be easily cut off without cutting the subpixel electrode 121a or 121b.

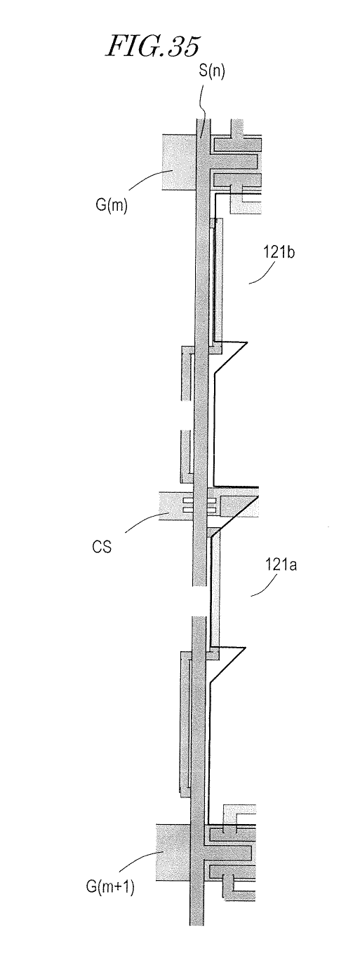

As shown in FIG. 35, the source line S(n) includes not only the source trunk line but also the source redundant line that is connected to the source trunk line. As the source line S(n) has such a redundant structure, a desired source signal voltage could still be supplied without repair, even if either the source redundant line or the source trunk line were disconnected.

As described above, in the subpixel SP-A, the notch 122a1 of the subpixel electrode 121a is provided for the storage capacitor line CS and the source redundant line, and therefore, the defect can be repaired easily as shown in FIGS. 31 and 34. The notch 122a2 of the subpixel electrode 121a is provided for the source redundant line, and therefore, the defect can be repaired easily as shown in FIG. 31. Likewise, the notch 122a4 of the subpixel electrode 121a is provided for the source redundant line, and therefore, the defect can be repaired easily. Furthermore, the notch 122a3 of the subpixel electrode 121a is provided for the drain extension line 127a, and therefore, the defect can be repaired easily as shown in FIG. 32. And the notch 122a5 of the subpixel electrode 121a is provided for the drain extension line 127a, and therefore, the defect can be repaired easily as shown in FIG. 32.

As for the subpixel SP-B, on the other hand, the notch 122b5 of the subpixel electrode 121b is provided for the drain extension line 127b, and therefore, the defect can be repaired easily as shown in FIG. 32. The notch 122b2 of the subpixel electrode 121b is provided for the drain extension line 127b, and therefore, the defect can be repaired easily as shown in FIG. 32. Likewise, the notch 122b1 of the subpixel electrode 121b is provided for the source redundant line, and therefore, the defect can be repaired easily as shown in FIG. 33. Furthermore, the notch 122b4 of the subpixel electrode 121b is provided for the source redundant line, and therefore, the defect can be repaired easily. And the notch 122b3 of the subpixel electrode 121b is provided for the storage capacitor line CS and the source redundant line, and therefore, the defect can be repaired easily.

Hereinafter, it will be described with reference to FIG. 30 how in the liquid crystal display device 100D of this embodiment, the oblique electric field generated around the notches 122a1 to 122a5 and 122b1 to 122b5 of the pixel electrodes 121a and 121b will affect the azimuthal component of the alignment direction of the liquid crystal molecules 182 and the reference alignment azimuths of their associated liquid crystal domains.

In the liquid crystal domains A, B, C and D of the subpixel SP-A, the oblique electric field generated by the notches 122a5, 122a2, 122a3 and 122a4 of the subpixel electrode 121a and the counter electrode 160 upon the application of a voltage induces alignment of the liquid crystal molecules 182, located in a region of the liquid crystal layer 180 associated with those notches 122a5, 122a2, 122a3 and 122a4 of the subpixel electrode 121a. And the azimuthal component of the alignment direction of those liquid crystal molecules 182, of which the director points from the active-matrix substrate toward the counter substrate, becomes substantially parallel to the reference alignment azimuths of the liquid crystal domains A, B, C and D. Consequently, no dark lines are produced.

In the liquid crystal domains A, B, C and D of the subpixel SP-B, the oblique electric field generated by the notches 122b5, 122b1, 122b2 and 122b4 of the subpixel electrode 121b and the counter electrode 160 upon the application of a voltage induces alignment of the liquid crystal molecules 182, located in a region of the liquid crystal layer 180 associated with those notches 122b5, 122b1, 122b2 and 122b4 of the subpixel electrode 121b. And the azimuthal component of the alignment direction of those liquid crystal molecules 182, of which the director points from the active-matrix substrate toward the counter substrate, becomes substantially parallel to the reference alignment azimuths of the liquid crystal domains A, B, C and D. Consequently, no dark lines are produced.

In the active-matrix substrates 110A, 110B, 110C and 110D described above, the subpixel electrodes 121a and 121b are arranged so as to overlap with the source metal. However, they are not limited to it.

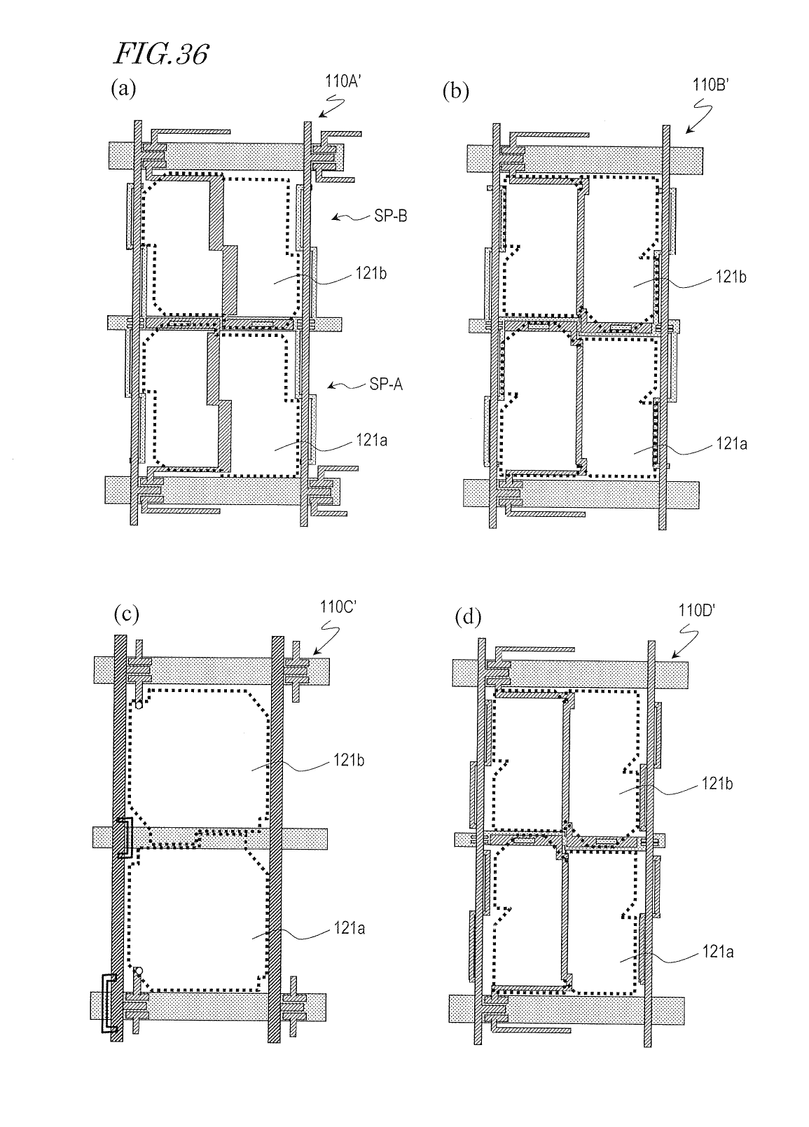

FIGS. 36(a), 36(b), 36(c) and 36(d) are schematic plan views illustrating arrangements for alternative active-matrix substrates 110A′, 110B′, 110C′ and 110D′, respectively. These alternative active-matrix substrates 110A′, 110B′, 110C′ and 110D′ are different from the active-matrix substrates 110A, 110B, 110C and 110D in that the subpixel electrodes 121a and 121b do not overlap with the source lines S. In the active-matrix substrate 110C described above, the storage capacitor is formed by the pixel electrode 121, the passivation film 116, the insulating film 114 and the gate metal (i.e., the storage capacitor line CS). In this active-matrix substrate 110C′, on the other hand, the storage capacitor is formed by the pixel electrode 121, the insulating film 114, and the storage capacitor line CS.

Also, in the above description, each of the CS overlap line CO and the gate overlap line GO overlaps with the source line S at two points. However, the present invention is in no way limited to it. Each of the CS overlap line CO and the gate overlap line GO may overlap with the source line S at three or more points as well.

### Embodiment 5

Hereinafter, a fifth embodiment of a liquid crystal display device according to the present invention will be described.

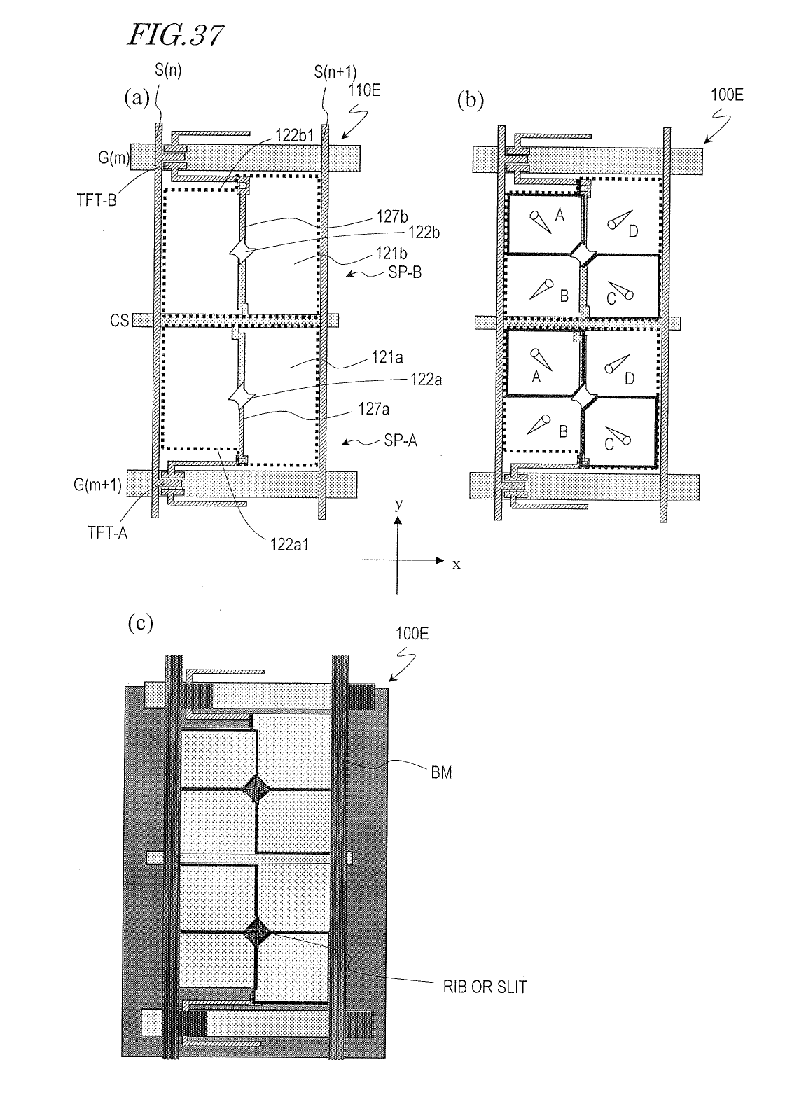

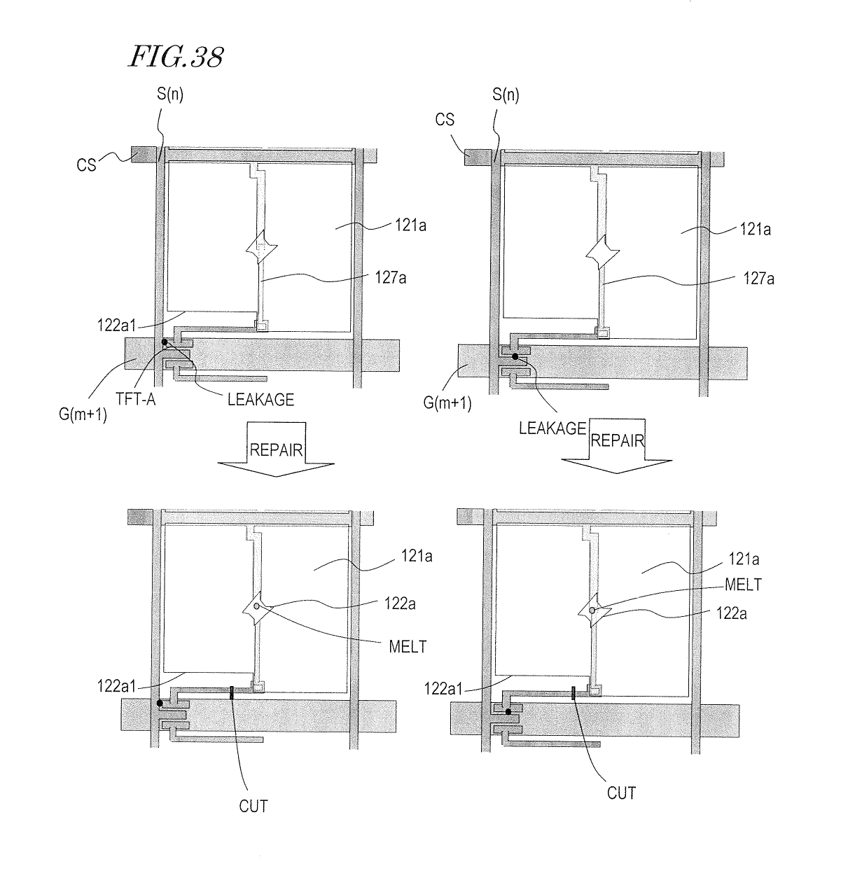

FIG. 37(a) is a schematic plan view illustrating the configuration of the active-matrix substrate 110E of a liquid crystal display device 100E as a fifth embodiment of the present invention. FIG. 37(b) is a schematic plan view illustrating how dark lines are produced in the liquid crystal display device 100E of this embodiment. And FIG. 37(c) is a schematic plan view of the liquid crystal display device 100E.

The liquid crystal display device 100E of this embodiment has a similar structure to the liquid crystal display devices 100A, 100B, 100C and 100D described above, and the overlapping description thereof will be omitted herein. In the active-matrix substrate 110E of this embodiment, the subpixel electrodes 121a and 121b do not overlap with the source lines S as in the active-matrix substrates 110A′, 110B′, 110C′ and 110D′ but unlike the active-matrix substrates 110A, 110B, 110C and 110D. In this liquid crystal display device 100E, the dark lines are produced in the “8” shape as in the liquid crystal display devices 100A and 100C but unlike the liquid crystal display devices 100B and 100D.

In FIG. 37(a), illustrated are the second subpixel SP-B of a pixel on the m^{th} row and the first subpixel SP-A of a pixel on the (m+1)^{th} row. The first and second subpixels SP-A and SP-B are respectively defined by subpixel electrodes 121a and 121b, which have openings 122a and 122b, respectively. Each of these openings 122a and 122b is provided for four liquid crystal domains A to D and arranged at the center of those liquid crystal domains A to D. The shapes of the subpixel electrodes 121a and 121b are symmetric to each other with respect to the CS trunk line.

Each of the drain extension lines 127a and 127b is extended in the row direction from the drain electrode of its associated TFT-A or TFT-B and then runs in the column direction. Also, as the subpixel electrodes 121a and 121b have notches 122a1 and 122b1, respectively, those portions of the drain extension lines 127a and 127b extended in the row direction are not covered with the subpixel electrodes 121a and 121b, respectively.

The storage capacitor line CS includes a CS trunk line running in the row direction (i.e., in the x direction) and CS branch lines connected to the CS trunk line. The CS branch lines overlap with the subpixel electrodes 121a and 121b and reach the openings 122a and 122b of the subpixel electrodes 121a and 121b. Also, the CS branch lines overlap with the drain extension lines 127a and 127b, thereby forming storage capacitors Ccsa and Ccsb.

Portions of the openings 122a and 122b of the subpixel electrodes 121a and 121b, which are associated with the liquid crystal domains A and C, are arranged so that the azimuthal components of their associated liquid crystal molecules 182 become substantially parallel to the reference alignment azimuths of the liquid crystal domains A and C under the oblique electric field. As a result, for the same reason as what has already been described with reference to FIG. 11, it is possible to reduce the production of dark lines and help recover the disturbed alignment of the liquid crystal molecules.

FIG. 37(b) indicates the alignment directions of liquid crystal molecules around the respective centers of the liquid crystal domains and also illustrates the dark lines produced. The reference alignment azimuths of the liquid crystal domains A, B, C and D may be 135, 45, 315 and 225 degrees, respectively.

As shown in FIG. 37(c), a black matrix BM provided for the counter substrate covers the source lines S and TFT-A and TFT-B. In this liquid crystal display device 100E, the black matrix BM also masks the openings 122a and 122b of the subpixel electrodes 121a and 121b.

Also, as shown in FIG. 37(c), the counter electrode 160 may be provided with ribs or slits (openings) for the openings 122a and 122b of the subpixel electrodes 121a and 121b. If the counter electrode 160 is provided with ribs for the openings 122a and 122b of the pixel electrodes 121a and 121b, then the ribs are preferably arranged so that a normal to the surface of the ribs becomes substantially parallel to the reference alignment direction of their associated liquid crystal domains. Then, the azimuthal components of the liquid crystal molecules 182 will become substantially parallel to the reference alignment azimuths of their associated liquid crystal domains and the decrease in optical transmittance can be minimized.

On the other hand, if the counter electrode 160 is provided with slits for the openings 122a and 122b of the pixel electrodes 121a and 121b, then the liquid crystal molecules 182 would be aligned substantially perpendicularly to the alignment films 130 and 170 by those slits and openings 122a and 122b combined. As a result, it is possible to prevent their alignment from being disturbed around the openings 122a and 122b.

Hereinafter, it will be described with reference to FIG. 38 what are causes for defects and how to repair the defects.

As shown in FIG. 38, if leakage current were generated between the drain electrode of TFT-A and either the source line S(n) or the gate line G(m+1), a source signal or a gate signal would be applied to the subpixel electrode 121a when the subpixel in question is not selected, then the display quality would be debased. In that case, a portion of the drain extension line 127a associated with the notch 122a1 of the subpixel electrode 121a could be irradiated with a laser beam and cut off. With the notch 122a1 cut through the subpixel electrode 121a, a portion of the drain extension line 127a does not overlap with the subpixel electrode 121a, and therefore, the drain extension line 127a can be cut off easily. Also, an overlapping portion between the drain extension line 127a and the CS branch line could also be irradiated with a laser beam and melted, thereby connecting the drain extension line 127a that is connected to the subpixel electrode 121a to the CS branch line. As a result, the drain extension line 127a connected to the subpixel electrode 121a would be connected to the storage capacitor line CS and a CS signal voltage would be applied to the subpixel electrode 121a. That is why the subpixel would display black. It should be noted that if a pixel with a defect displayed white, then the display quality would be debased significantly because white is easily sensible for a viewer. If such a defective pixel displayed black, however, the decline in display quality should be minimized.

As described above, by connecting the subpixel electrode to the storage capacitor line CS by the laser melt technique, the potential at the subpixel electrode would be closer to the potential at the counter electrode and the subpixel would display black. If a pixel with a defect displayed white, then the display quality would be debased significantly because white is easily sensible for a viewer. If such a defective pixel displayed black, however, the decline in display quality should be minimized.

As described above, in the subpixel SP-A, the opening 122a of the subpixel electrode 121a is provided for the CS branch line and the drain extension line 127a. As a result, the defect can be repaired easily as shown in FIG. 38. Likewise, as for the subpixel SP-B, the opening 122b of the subpixel electrode 121b is provided for the CS branch line and the drain extension line 127b. As a result, the defect can also be rectified easily.

Hereinafter, it will be described with reference to FIG. 37 how in the liquid crystal display device 100E of this embodiment, the oblique electric field generated around the openings 122a and 122b of the pixel electrodes 121a and 121b will affect the azimuthal component of the alignment direction of the liquid crystal molecules 182 and the reference alignment azimuths of their associated liquid crystal domains.

In the liquid crystal domains A and C of the subpixel SP-A, the oblique electric field generated by the opening 122a of the subpixel electrode 121a and the counter electrode 160 upon the application of a voltage induces alignment of the liquid crystal molecules 182, located in a region of the liquid crystal layer 180 associated with that opening 122a of the subpixel electrode 121a. And the azimuthal component of the alignment direction of those liquid crystal molecules 182, of which the director points from the active-matrix substrate toward the counter substrate, becomes substantially parallel to the reference alignment azimuths of the liquid crystal domains A and C. Consequently, no dark lines are produced. In the same way, in the liquid crystal domains A and C of the subpixel SP-B, the oblique electric field generated by the opening 122b of the subpixel electrode 121b and the counter electrode 160 upon the application of a voltage induces alignment of the liquid crystal molecules 182, located in a region of the liquid crystal layer 180 associated with that opening 122b of the subpixel electrode 121b. And the azimuthal component of the alignment direction of those liquid crystal molecules, of which the director points from the active-matrix substrate toward the counter substrate, becomes substantially parallel to the reference alignment azimuths of the liquid crystal domains A and C. Consequently, no dark lines are produced.

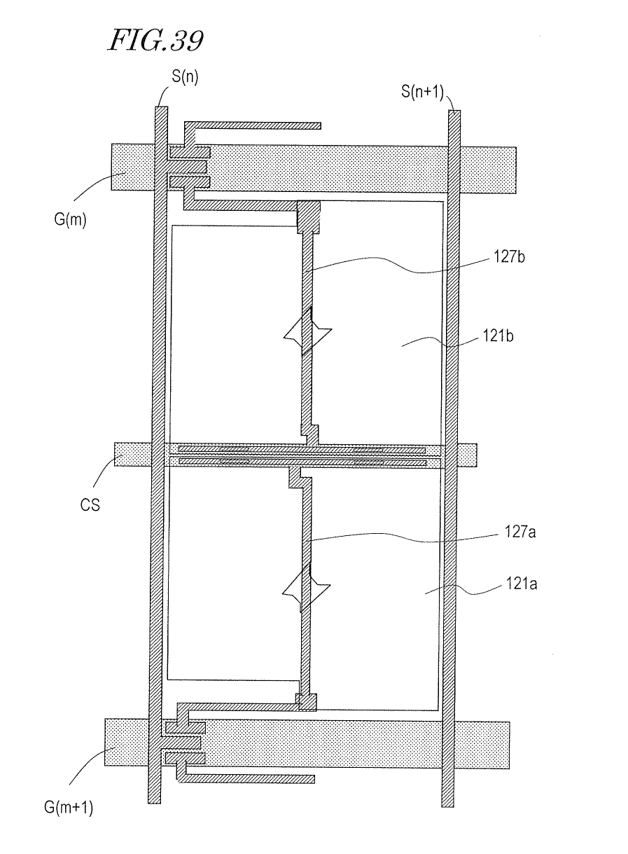

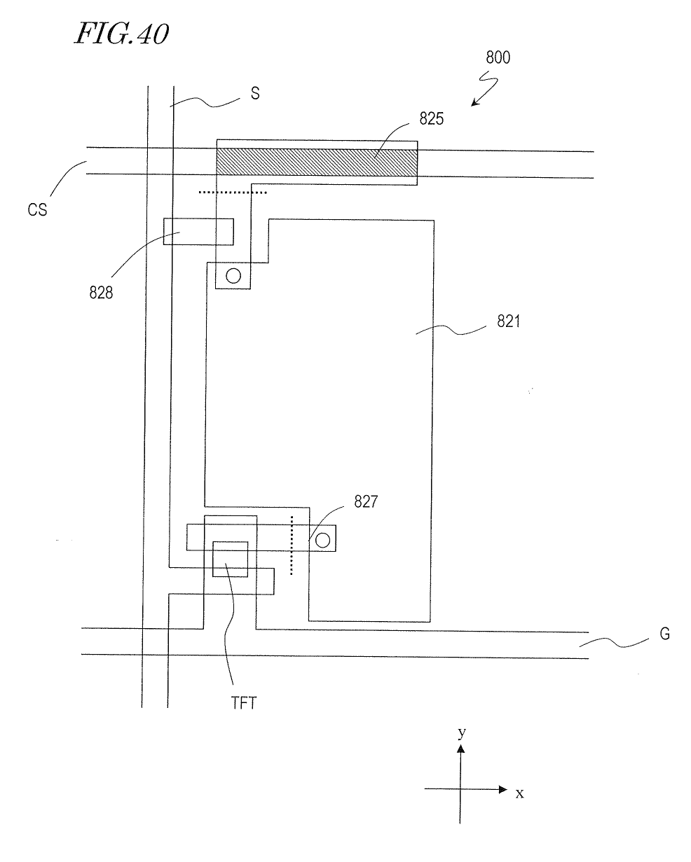

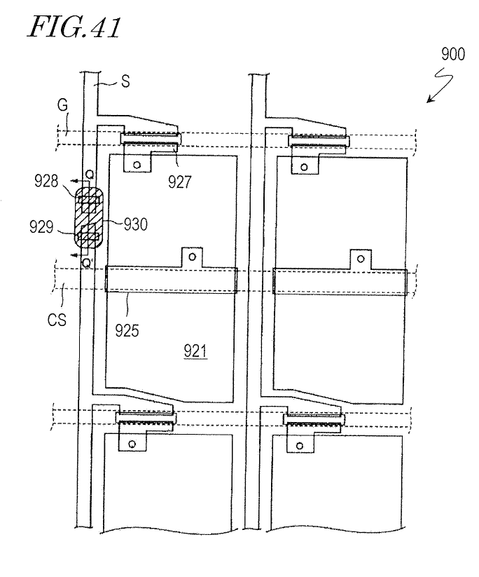

In the liquid crystal display device 100E that has been described with reference to FIGS. 37 and 38, the subpixel electrodes 121a and 121b are arranged so as not to overlap with the source lines S. However, the subpixel electrodes 121a and 121b may also be arranged to overlap with the source lines S. In that case, the drain extension lines 127a and 127b may extend through the storage capacitor line CS to form a storage capacitor there as shown in FIG. 39.

Also, in the foregoing description, the photo-alignment treatment is supposed to be performed so that the first alignment film 130 of the active-matrix substrate 110 is irradiated with light that has come from a direction that is tilted with respect to the vertical direction (i.e., column direction) and that the second alignment film 170 of the counter substrate 150 is irradiated with light that has come from a direction that is tilted with respect to the horizontal direction (i.e., row direction). However, the present invention is in no way limited to it. The first alignment film 130 of the active-matrix substrate 110 may also be irradiated with light that has come from a direction that is tilted with respect to the horizontal direction (i.e., row direction) and the second alignment film 170 of the counter substrate 150 may also be irradiated with light that has come from a direction that is tilted with respect to the vertical direction (i.e., column direction) as well.

Also, in the above description, the number of alignment division are supposed to be four. However, the present invention is not limited to it. According to the present invention, the number of the alignment division may be any other number than four but it is preferred that the number be at least equal to two.

Furthermore, in the embodiments described above, the pixel division and the alignment division are supposed. But the present invention is limited to it. Either or even both of the pixel division and the alignment division could be omitted.

Furthermore, in the embodiments described above, the liquid crystal display device of the present invention is supposed to be a TFT LCD. However, the present invention is not limited to it and the present invention may also be implemented as an LCD that adopts any other addressing method.

Also, in the foregoing description, each pixel is supposed to be split into two subpixels and provided with two subpixel electrodes. However, the present invention is in no way limited to it. No pixel may be divided at all. Furthermore, the alignment division is supposed to be adopted in the embodiments described above but does not have to be adopted. Furthermore, in the embodiments described above, the liquid crystal display device is supposed to have a vertical alignment liquid crystal layer that is sandwiched between two alignment films that define the pretilt directions. However, the present invention is limited to it. The present invention may also be implemented as any other type of LCD.

The disclosure of Japanese Patent Application No. 2008-116067, from which the present application claims priority, is hereby incorporated by reference.

### INDUSTRIAL APPLICABILITY

The present invention provides a liquid crystal display device with high optical transmittance. Also, according to the present invention, even if any defect has occurred in the liquid crystal display device, that defect can be repaired easily.

### REFERENCE SIGNS LIST

100 liquid crystal display device
110 active-matrix substrate
121 pixel electrode
122 notch, opening
127 drain extension line
130 first alignment film
150 counter substrate
160 counter electrode
170 second alignment film
180 liquid crystal layer

1. A liquid crystal display device comprising:
an active-matrix substrate including multiple lines, a pixel electrode and a first alignment film;
a counter substrate including a counter electrode and a second alignment film; and
a vertical alignment liquid crystal layer, which is arranged between the active-matrix substrate and the counter substrate,
wherein the first alignment film at least partially has an alignment region that defines liquid crystal molecules of the liquid crystal layer in a first pretilt azimuth, and
wherein the second alignment film at least partially has an alignment region that defines the liquid crystal molecules of the liquid crystal layer in another pretilt azimuth that is different from the first pretilt azimuth, and
wherein the pixel electrode has at least one notch or opening, which is provided for a portion of at least one of the multiple lines, and
wherein if the azimuthal component of the alignment direction of liquid crystal molecules, which are located approximately at the middle of the thickness of the liquid crystal layer in an area where the respective alignment regions of the first and second alignment films overlap with each other to a viewer's eye and of which the director points from the active-matrix substrate toward the counter substrate, is called a reference alignment azimuth, an oblique electric field, which is generated by the counter electrode and the at least one notch or opening of the pixel electrode upon the application of a voltage, causes the azimuthal component of the alignment direction of the liquid crystal molecules, of which the director points from the active-matrix substrate toward the counter substrate in a region of the liquid crystal layer associated with at least a portion of the at least one notch or opening of the pixel electrode, to intersect with the reference alignment azimuth at an angle of 90 degrees or less.

2. The liquid crystal display device of claim 1, wherein an oblique electric field, which is generated by the counter electrode and the at least one notch or opening of the pixel electrode upon the application of a voltage, makes the azimuthal component of the alignment direction of the liquid crystal molecules, of which the director points from the active-matrix substrate toward the counter substrate in a region of the liquid crystal layer associated with at least a portion of the at least one notch or opening of the pixel electrode, substantially parallel to the reference alignment azimuth.

3. The liquid crystal display device of claim 1, wherein the first alignment film has first and second alignment regions that define the liquid crystal molecules of the liquid crystal layer in the first and second pretilt azimuths, respectively, and
wherein the second alignment film has third and fourth alignment regions that define the liquid crystal molecules of the liquid crystal layer in third and fourth pretilt azimuths, respectively, and wherein the liquid crystal layer has multiple liquid crystal domains.

4. The liquid crystal display device of claim 3, wherein the liquid crystal domains include first, second, third and fourth liquid crystal domains.

5. The liquid crystal display device of claim 3, wherein each of the first and second pretilt azimuths intersects with the third and fourth pretilt azimuths substantially at right angles.

6. The liquid crystal display device of claim 3, wherein when a voltage is applied thereto, a dark line is produced, to the viewer's eye, at the boundary between at least two adjacent ones of the multiple liquid crystal domains.

7. The liquid crystal display device of claim 6, wherein respective parts of the pixel electrode that are associated with the multiple liquid crystal domains and that overlap with neither the lines nor the dark line have approximately equal areas.

8. The liquid crystal display device of claim 1, wherein as viewed along a normal to the principal surface of the active-matrix substrate, the pixel electrode has an asymmetric shape.

9. The liquid crystal display device of claim 1, wherein the at least one notch of the pixel electrode is located at a corner of the pixel electrode.

10. The liquid crystal display device of claim 1, wherein the at least one notch of the pixel electrode is located in at least one intersection where the boundary between two adjacent ones of the liquid crystal domains intersects with an edge of the pixel electrode.

11. The liquid crystal display device of claim 6, wherein the pixel electrode has the opening, and
wherein the dark line is produced, to the viewer's eye, at least partially over at least a portion of the opening.

12. The liquid crystal display device of claim 1, wherein the lines include a gate line and a source line.

13. The liquid crystal display device of claim 12, wherein the lines further include a drain extension line and a storage capacitor line.

14. The liquid crystal display device of claim 1, wherein the liquid crystal layer has multiple liquid crystal domains, and
wherein the lines include a drain extension line, which overlaps with at least a part of the boundary between two adjacent ones of the liquid crystal domains.

15. The liquid crystal display device of claim 1, wherein at least one of the first and second alignment films has been irradiated with light.

16. The liquid crystal display device of claim 1, wherein at least one of the first and second alignment films has been subjected to a rubbing treatment.

17. The liquid crystal display device of claim 1, wherein the second alignment film has a projection, which is associated with the at least one notch or opening of the pixel electrode.

18. The liquid crystal display device of claim 1, wherein the counter electrode has a slit, which is associated with the at least one notch or opening of the pixel electrode.

19. The liquid crystal display device of claim 1, wherein the pixel electrode includes first and second subpixel electrodes.

20. The liquid crystal display device of claim 1, wherein the pixel electrode has one more notch, and
wherein an oblique electric field, which is generated by the counter electrode and the one more notch of the pixel electrode upon the application of a voltage, causes the azimuthal component of the alignment direction of the liquid crystal molecules, of which the director points from the active-matrix substrate toward the counter substrate in a region of the liquid crystal layer associated with the one more notch of the pixel electrode, to intersect with the reference alignment azimuth at an angle of greater than 90 degrees.

21. The liquid crystal display device of claim 20, wherein the one more notch of the pixel electrode is provided for a portion of at least one of the lines.

22. The liquid crystal display device of claim 21, wherein the one more notch of the pixel electrode overlaps at least partially with another one of the lines.
